(19) United States
(12) Patent Application Publication
(10) Pub. No.: US 2025/0274581 A1
(43) Pub. Date: Aug. 28, 2025

(54) METHOD, APPARATUS, AND RECORDING MEDIUM FOR ENCODING/DECODING IMAGE BY USING GEOMETRIC PARTITIONING

(71) Applicant: ELECTRONICS AND TELECOMMUNICATIONS RESEARCH INSTITUTE, Daejeon (KR)

(72) Inventors: Woong LIM, Daejeon (KR); Dong-Hyun KIM, Daejeon (KR); Hyoung-Jin KWON, Daejeon (KR); Youn-Hee KIM, Daejeon (KR); Jong-Ho KIM, Daejeon (KR); Ji-Hoon DO, Daejeon (KR); Joo-Young LEE, Daejeon (KR); Se-Yoon JEONG, Daejeon (KR); Jin-Soo CHOI, Daejeon (KR); Tae-Jin LEE, Daejeon (KR)

(21) Appl. No.: 18/689,047

(22) PCT Filed: Sep. 2, 2022
(86) PCT No.: PCT/KR2022/013225

§ 371 Date: Aug. 14, 2024

(30) Foreign Application Priority Data
Sep. 2, 2021 (KR) 10-2021-0117178
Apr. 5, 2022 (KR) 10-2022-0042476
Sep. 2, 2022 (KR) 10-2022-0111477

(51) Int. Cl. H04N 19/11; H04N 19/105; H04N 19/119; H04N 19/139; H04N 19/159; H04N 19/176; H04N 19/51; H04N 19/593

(52) U.S. Cl. CPC H04N 19/11; H04N 19/105; H04N 19/119; H04N 19/139; H04N 19/159; H04N 19/176; H04N 19/51; H04N 19/593

(57) ABSTRACT

Disclosed herein are a method, an apparatus and a storage medium for image encoding/decoding using geometric partitioning. Through geometric partitioning, a target block is partitioned into a first partitioned region and a second partitioned region. Intra-prediction is used for at least one of the first partitioned region and the second partitioned region. An intra-prediction mode of intra-prediction used for the partitioned region may be limited by a partition boundary or the like of a geometric partitioning mode. Through prediction for the first partitioned region and prediction for the second partitioned region, a prediction block for the target block is generated.

### CROSS-REFERENCE TO RELATED APPLICATIONS

This application is a National Phase Entry Application of PCT Application No. PCT/KR2022/013225 filed on Sep. 2, 2022, which claims priority to Korean Patent Application No. 10-2021-0117178 filed on Sep. 2, 2021, Korean Patent Application No. 10-2022-0042476 filed on Apr. 5, 2022, and Korean Patent Application No. 10-2022-0111477 filed on Sep. 2, 2022, in Korean Intellectual Property Office, the entire contents of which are hereby incorporated by reference in its entirety.

### TECHNICAL FIELD

The present disclosure relates generally to a method, an apparatus and a storage medium for image encoding/decoding. More particularly, the present disclosure relates to a method, an apparatus and a storage medium for image encoding/decoding using geometric partitioning.

### BACKGROUND ART

With the continuous development of the information and communication industries, broadcasting services supporting High-Definition (HD) resolution have been popularized all over the world. Through this popularization, a large number of users have become accustomed to high-resolution and high-definition images and/or video.

To satisfy users' demand for high definition, many institutions have accelerated the development of next-generation imaging devices. Users' interest in UHD TVs, having resolution that is more than four times as high as that of Full HD (FHD) TVs, as well as High-Definition TVs (HDTV) and FHD TVs, has increased. As interest therein has increased, image encoding/decoding technology for images having higher resolution and higher definition is currently required.
As image compression technology, there are various technologies, such as inter-prediction technology, intra-prediction technology, transform, quantization technology and entropy coding technology.
Inter-prediction technology is technology for predicting the value of a pixel included in a current picture using a picture previous to and/or a picture subsequent to the current picture.
Intra-prediction technology is technology for predicting the value of a pixel included in a current picture using information about pixels in the current picture. Transform and quantization technology may be technology for compressing the energy of a residual signal.
The entropy coding technology is technology for assigning a short codeword to a frequently occurring value and assigning a long codeword to a less frequently occurring value.

By utilizing this image compression technology, data about images may be effectively compressed, transmitted, and stored.

### DISCLOSURE

### Technical Problem

An embodiment is intended to provide an apparatus, a method, and a storage medium for image encoding/decoding using intra-prediction based on geometric partitioning.

An embodiment is intended to provide a method, an apparatus, and a bitstream storage medium, which perform geometric partitioning on a target block to which intra-prediction is applied.

An embodiment is intended to provide a method, an apparatus, and a bitstream storage medium, which specify partitioned regions by applying geometric partitioning to a target block and perform encoding/decoding on the target block by using intra-prediction for each of the partitioned regions.

### Technical Solution

In accordance with an aspect, there is provided an image decoding method, including configuring Geometric Partitioning Mode (GPM) information for a target block; and performing GPM prediction for the target block using the GPM information.

A first subblock and a second subblock for the target block may be determined.

Intra-prediction may be applied to at least one of the first subblock and the second subblock.

An identical intra-prediction mode may be applied to at least one of the first subblock and the second subblock.

A reference region for the target block may be partitioned into a first reference region and a second reference region based on intersection points between an extended line of a partition boundary and a reference pixel line.

The first reference region may be a region including first reference samples referenced by the first subblock.

The second reference region may be a region including second reference samples referenced by the second subblock.

An intra-prediction mode of at least one of the first subblock and the second subblock may be fixed at a specific intra-prediction mode.

The specific intra-prediction mode may be a planar mode or a DC mode.

A first Most Probable Mode (MPM) list for the first subblock and a second MPM list for the second subblock may be independently constructed.

In accordance with another aspect, there is provided an image encoding method, including configuring Geometric Partitioning Mode (GPM) information for a target block; and performing GPM prediction for the target block using the GPM information.

A first subblock and a second subblock for the target block may be determined.

Intra-prediction may be applied to at least one of the first subblock and the second subblock.

An identical intra-prediction mode may be applied to at least one of the first subblock and the second subblock.

A reference region for the target block may be partitioned into a first reference region and a second reference region based on intersection points between an extended line of a partition boundary and a reference pixel line.

The first reference region may be a region including first reference samples referenced by the first subblock.

The second reference region may be a region including second reference samples referenced by the second subblock.

An intra-prediction mode of at least one of the first subblock and the second subblock may be fixed at a specific intra-prediction mode.

The specific intra-prediction mode may be a planar mode or a DC mode.

A first Most Probable Mode (MPM) list for the first subblock and a second MPM list for the second subblock may be independently constructed.

In accordance with a further aspect, there is provided a computer-readable storage medium for storing a bitstream for image decoding, wherein the bitstream includes Geometric Partitioning Mode (GPM) information, and GPM prediction for the target block is performed using the GPM information.

A first subblock and a second subblock for the target block may be determined.

Intra-prediction may be applied to at least one of the first subblock and the second subblock.

An identical intra-prediction mode may be applied to at least one of the first subblock and the second subblock.

A reference region for the target block may be partitioned into a first reference region and a second reference region based on intersection points between an extended line of a partition boundary and a reference pixel line.

The first reference region may be a region including first reference samples referenced by the first subblock.

The second reference region may be a region including second reference samples referenced by the second subblock.

An intra-prediction mode of at least one of the first subblock and the second subblock may be fixed at a specific intra-prediction mode.

A first Most Probable Mode (MPM) list for the first subblock and a second MPM list for the second subblock may be independently constructed.

### Advantageous Effects

There are provided an apparatus, a method, and a storage medium for image encoding/decoding using intra-prediction based on geometric partitioning.

An embodiment may provide a method, an apparatus, and a bitstream storage medium, which perform geometric partitioning on a target block to which intra-prediction is applied.

An embodiment may provide a method, an apparatus, and a bitstream storage medium, which specify partitioned regions by applying geometric partitioning to a target block and perform encoding/decoding on the target block by using intra-prediction for each of the partitioned regions.

### DESCRIPTION OF DRAWINGS

FIG. 1 is a block diagram illustrating the configuration of an embodiment of an encoding apparatus to which the present disclosure is applied;

FIG. 2 is a block diagram illustrating the configuration of an embodiment of a decoding apparatus to which the present disclosure is applied;

FIG. 3 is a diagram schematically illustrating the partition structure of an image when the image is encoded and decoded;

FIG. 4 is a diagram illustrating the form of a Prediction Unit (PU) that a Coding Unit (CU) can include;

FIG. 5 is a diagram illustrating the form of a Transform Unit (TU) that can be included in a CU;

FIG. 6 illustrates splitting of a block according to an example;

FIG. 7 is a diagram for explaining an embodiment of an intra-prediction procedure;

FIG. 8 is a diagram illustrating reference samples used in an intra-prediction procedure;

FIG. 9 is a diagram for explaining an embodiment of an inter-prediction procedure;

FIG. 10 illustrates spatial candidates according to an embodiment;

FIG. 11 illustrates the order of addition of motion information of spatial candidates to a merge list according to an embodiment;

FIG. 12 illustrates a transform and quantization process according to an example;

FIG. 13 illustrates diagonal scanning according to an example;

FIG. 14 illustrates horizontal scanning according to an example;

FIG. 15 illustrates vertical scanning according to an example;

FIG. 16 is a configuration diagram of an encoding apparatus according to an embodiment;

FIG. 17 is a configuration diagram of a decoding apparatus according to an embodiment;

FIG. 18 is a flowchart illustrating a target block prediction method and a bitstream generation method according to an embodiment;

FIG. 19 is a flowchart illustrating a target block prediction method using a bitstream according to an embodiment;

FIG. 20 illustrates the angle and distance of geometric partitioning according to an example;

FIG. 21 illustrates the angle and distance of geometric partitioning according to another example;

FIG. 22 illustrates the angles and distances of geometric partitioning according to an example;

FIG. 23 illustrates a first partitioning mode set according to an example;

FIG. 24 illustrates a second partitioning mode set according to an example;

FIG. 25 is a flowchart of an encoding method based on geometric partitioning according to an embodiment;

FIG. 26 is a flowchart of a decoding method based on geometric partitioning according to an embodiment;

FIG. 27 illustrates inter-prediction for a template region according to an example;

FIG. 28 illustrates intra-prediction for a template region according to an example;

FIG. 29 illustrates prediction for a template region using inter-prediction and intra-prediction according to an example;

FIG. 30 illustrates intra-prediction for one of multiple partial template regions according to an example;

FIG. 31 illustrates inter-prediction for one of multiple partial template regions according to an example;

FIG. 32 illustrates a target template for a target block according to an example;

FIG. 33 illustrates a target template in which one or more horizontal lines are emptied according to an example;

FIG. 34 illustrates a target template in which one or more horizontal lines and vertical lines are emptied according to an example;

FIG. 35 illustrates a target template for a target block adjacent to a CTU boundary according to an example;

FIG. 36 illustrates a target template for a target block adjacent to a CTU boundary according to an example;

FIG. 37 illustrates a regular merge list according to an example;

FIG. 38 illustrates a merge list for GSM according to an example;

FIG. 39 illustrates a GPM syntax element table according to an example;

FIG. 40 illustrates GPM blending matrixes according to an example;

FIG. 41 illustrates GPM prediction using intra-predictions according to an example;

FIG. 42 illustrates GPM prediction using inter-predictions according to an example;

FIG. 43 illustrates GPM prediction using intra-prediction and inter-prediction according to an example;

FIG. 44 illustrates a target block and a reference region of the target block according to an example;

FIG. 45 illustrates a method for refining a prediction signal by applying template matching to a partitioned region in which inter-prediction is used according to an example;

FIG. 46 illustrates a method for refining a prediction signal using a motion vector difference according to an example;

FIG. 47 illustrates reference pixels for partitioned regions according to an example;

FIG. 48 illustrates a target block to which GPM using two intra-prediction modes is applied according to an example;

FIG. 49 illustrates a target block to which GPM using fixed intra-prediction modes is applied according to an example;

FIG. 50 illustrates a target block to which GPM using fixed intra-prediction modes is applied according to an example;

FIG. 51 illustrates a target block to which GPM using an intra-prediction mode and a non-intra-prediction mode is applied according to an example;

FIG. 52 illustrates N bands according to an example;

FIG. 53 illustrates a target block to which GPM using one intra-prediction mode is applied according to an example; and

FIG. 54 illustrates a target block to which GPM using an index for a reference sample is applied according to an example.

### MODE FOR INVENTION

The present invention may be variously changed, and may have various embodiments, and specific embodiments will be described in detail below with reference to the attached drawings. However, it should be understood that those embodiments are not intended to limit the present invention to specific disclosure forms, and that they include all changes, equivalents or modifications included in the spirit and scope of the present invention.

Detailed descriptions of the following exemplary embodiments will be made with reference to the attached drawings illustrating specific embodiments. These embodiments are described so that those having ordinary knowledge in the technical field to which the present disclosure pertains can easily practice the embodiments. It should be noted that the various embodiments are different from each other, but do not need to be mutually exclusive of each other. For example, specific shapes, structures, and characteristics described here may be implemented as other embodiments without departing from the spirit and scope of the embodiments in relation to an embodiment. Further, it should be understood that the locations or arrangement of individual components in each disclosed embodiment can be changed without departing from the spirit and scope of the embodiments. Therefore, the accompanying detailed description is not intended to restrict the scope of the disclosure, and the scope of the exemplary embodiments is limited only by the accompanying claims, along with equivalents thereof, as long as they are appropriately described.

In the drawings, similar reference numerals are used to designate the same or similar functions in various aspects. The shapes, sizes, etc. of components in the drawings may be exaggerated to make the description clear.

Terms such as “first” and “second” may be used to describe various components, but the components are not restricted by the terms. The terms are used only to distinguish one component from another component. For example, a first component may be named a second component without departing from the scope of the present specification. Likewise, a second component may be named a first component. The terms “and/or” may include combinations of a plurality of related described items or any of a plurality of related described items.

It will be understood that when a component is referred to as being “connected” or “coupled” to another component, the two components may be directly connected or coupled to each other, or intervening components may be present between the two components. On the other hand, it will be understood that when a component is referred to as being “directly connected or coupled”, no intervening components are present between the two components.

Also, components described in the embodiments are independently shown in order to indicate different characteristic functions, but this does not mean that each of the components is formed of a separate piece of hardware or software. That is, the components are arranged and included separately for convenience of description. For example, at least two of the components may be integrated into a single component. Conversely, one component may be divided into multiple components. An embodiment into which the components are integrated or an embodiment in which some components are separated is included in the scope of the present specification as long as it does not depart from the essence of the present specification.

The terms used in the embodiment are merely used to describe specific embodiments and are not intended to limit the present invention. A singular expression includes a plural expression unless a description to the contrary is specifically pointed out in context. In the embodiments, it should be understood that the terms such as “include” or “have” are merely intended to indicate that features, numbers, steps, operations, components, parts, or combinations thereof are present, and are not intended to exclude the possibility that one or more other features, numbers, steps, operations, components, parts, or combinations thereof will be present or added. That is, in the embodiments, an expression describing that a component “comprises” a specific component means that additional components may be included within the scope of the practice of the present invention or the technical spirit of the present invention, but does not preclude the presence of components other than the specific component.

In the embodiments, a term “at least one” may mean one of one or more numbers, such as 1, 2, 3, and 4. In the embodiments, a term “a plurality of” may mean one of two or more numbers, such as 2, 3 and 4.

Some components of the embodiments are not essential components for performing essential functions, but may be optional components for improving only performance. The embodiments may be implemented using only essential components for implementing the essence of the embodiments. For example, a structure including only essential components, excluding optional components used only to improve performance, is also included in the scope of the embodiments.

Embodiments will be described in detail below with reference to the accompanying drawings so that those having ordinary knowledge in the technical field to which the embodiments pertain can easily practice the embodiments. In the following description of the embodiments, detailed descriptions of known functions or configurations which are deemed to make the gist of the present specification obscure will be omitted. Further, the same reference numerals are used to designate the same components throughout the drawings, and repeated descriptions of the same components will be omitted.

Hereinafter, “image” may mean a single picture constituting a video, or may mean the video itself. For example, “encoding and/or decoding of an image” may mean “encoding and/or decoding of a video”, and may also mean “encoding and/or decoding of any one of images constituting the video”.

Hereinafter, the terms “video” and “motion picture” may be used to have the same meaning, and may be used interchangeably with each other.

Hereinafter, a target image may be an encoding target image, which is the target to be encoded, and/or a decoding target image, which is the target to be decoded.

Further, the target image may be an input image that is input to an encoding apparatus or an input image that is input to a decoding apparatus. And, a target image may be a current image, that is, the target to be currently encoded and/or decoded. For example, the terms “target image” and “current image” may be used to have the same meaning, and may be used interchangeably with each other.

Hereinafter, the terms “image”, “picture”, “frame”, and “screen” may be used to have the same meaning and may be used interchangeably with each other.

Hereinafter, a target block may be an encoding target block, i.e. the target to be encoded and/or a decoding target block, i.e. the target to be decoded. Further, the target block may be a current block, i.e. the target to be currently encoded and/or decoded. Here, the terms “target block” and “current block” may be used to have the same meaning, and may be used interchangeably with each other. A current block may denote an encoding target block, which is the target of encoding, during encoding and/or a decoding target block, which is the target of decoding, during decoding. Also, the current block may be at least one of a Coding Tree Unit (CTU), a coding block, a prediction block, a residual block, and a transform block.

Hereinafter, the terms “block” and “unit” may be used to have the same meaning, and may be used interchangeably with each other. Alternatively, “block” may denote a specific unit.

Hereinafter, the terms “region” and “segment” may be used interchangeably with each other.

In the following embodiments, specific information, data, a flag, an index, an element, and an attribute may have their respective values. A value of “0” corresponding to each of the information, data, flag, index, element, and attribute may indicate a false, a logical false or a first predefined value. In other words, the value of “0”, a false, logical false, and a first predefined value may be used interchangeably with each other. A value of “1” corresponding to each of the information, data, flag, index, element, and attribute may indicate a true, a logical true or a second predefined value. In other words, the value of “1”, true, logical true, and a second predefined value may be used interchangeably with each other.

When a variable such as i or j is used to indicate a row, a column, or an index, the value of i may be an integer of 0 or more or an integer of 1 or more. In other words, in the embodiments, each of a row, a column, and an index may be counted from 0 or may be counted from 1.

In embodiments, the term “one or more” or the term “at least one” may mean the term “plural”. The term “one or more” or the term “at least one” may be used interchangeably with “plural”.

Below, the terms to be used in embodiments will be described.

Encoder: An encoder denotes a device for performing encoding. That is, an encoder may mean an encoding apparatus.

Decoder: A decoder denotes a device for performing decoding. That is, a decoder may mean a decoding apparatus.

Unit: A unit may denote the unit of image encoding and decoding. The terms “unit” and “block” may be used to have the same meaning, and may be used interchangeably with each other.
A unit may be an M×N array of samples. Each of M and N may be a positive integer. A unit may typically mean an array of samples in the form of two-dimensions.
Unit or block may denote a Coding Tree Unit (CTU), a Coding Unit (CU), a coding block, a Prediction Unit (PU), a prediction block, a Transform Unit (TU) or a transform block.
In the encoding and decoding of an image, “unit” may be an area generated by the partitioning of one image. In other words, “unit” may be a region specified in one image. A single image may be partitioned into multiple units. Alternatively, one image may be partitioned into sub-parts, and the unit may denote each partitioned sub-part when encoding or decoding is performed on the partitioned sub-part.
In the encoding and decoding of an image, predefined processing may be performed on each unit depending on the type of the unit.
Depending on functions, the unit types may be classified into a macro unit, a Coding Unit (CU), a Prediction Unit (PU), a residual unit, a Transform Unit (TU), etc. Alternatively, depending on functions, the unit may denote a block, a macroblock, a coding tree unit, a coding tree block, a coding unit, a coding block, a prediction unit, a prediction block, a residual unit, a residual block, a transform unit, a transform block, etc. For example, a target unit, which is the target of encoding and/or decoding, may be at least one of a CU, a PU, a residual unit, and a TU.
The term “unit” may mean information including a luminance (luma) component block, a chrominance (chroma) component block corresponding thereto, and syntax elements for respective blocks so that the unit is designated to be distinguished from a block.
The size and shape of a unit may be variously implemented. Further, a unit may have any of various sizes and shapes. In particular, the shapes of the unit may include not only a square, but also a geometric figure that can be represented in two dimensions (2D), such as a rectangle, a trapezoid, a triangle, and a pentagon.
Further, unit information may include one or more of the type of a unit, the size of a unit, the depth of a unit, the order of encoding of a unit and the order of decoding of a unit, etc. For example, the type of a unit may indicate one of a CU, a PU, a residual unit and a TU.
One unit may be partitioned into sub-units, each having a smaller size than that of the relevant unit.

Depth: A depth may mean an extent to which the unit is partitioned. Further, the depth of the unit may indicate the level at which the corresponding unit is present when unit(s) are represented by a tree structure.
Unit partition information may include a depth indicating the depth of a unit. A depth may indicate the number of times the unit is partitioned and/or the degree to which the unit is partitioned.
In a tree structure, it may be considered that the depth of a root node is the smallest, and the depth of a leaf node is the largest. The root node may be the highest (top) node. The leaf node may be a lowest node.
A single unit may be hierarchically partitioned into multiple sub-units while having depth information based on a tree structure. In other words, the unit and sub-units, generated by partitioning the unit, may correspond to a node and child nodes of the node, respectively. Each of the partitioned sub-units may have a unit depth. Since the depth indicates the number of times the unit is partitioned and/or the degree to which the unit is partitioned, the partition information of the sub-units may include information about the sizes of the sub-units.
In a tree structure, the top node may correspond to the initial node before partitioning. The top node may be referred to as a “root node”. Further, the root node may have a minimum depth value. Here, the top node may have a depth of level ‘0’.
A node having a depth of level ‘1’ may denote a unit generated when the initial unit is partitioned once. A node having a depth of level ‘2’ may denote a unit generated when the initial unit is partitioned twice.
A leaf node having a depth of level ‘n’ may denote a unit generated when the initial unit has been partitioned n times.
The leaf node may be a bottom node, which cannot be partitioned any further. The depth of the leaf node may be the maximum level. For example, a predefined value for the maximum level may be 3.
A QT depth may denote a depth for a quad-partitioning. A BT depth may denote a depth for a binary-partitioning. A TT depth may denote a depth for a ternary-partitioning.

Sample: A sample may be a base unit constituting a block. A sample may be represented by values from 0 to 2^{Bd-}1 depending on the bit depth (Bd).
A sample may be a pixel or a pixel value.
Hereinafter, the terms “pixel” and “sample” may be used to have the same meaning, and may be used interchangeably with each other.

A Coding Tree Unit (CTU): A CTU may be composed of a single luma component (Y) coding tree block and two chroma component (Cb, Cr) coding tree blocks related to the luma component coding tree block. Further, a CTU may mean information including the above blocks and a syntax element for each of the blocks.
Each coding tree unit (CTU) may be partitioned using one or more partitioning methods, such as a quad tree (QT), a binary tree (BT), and a ternary tree (TT) so as to configure sub-units, such as a coding unit, a prediction unit, and a transform unit. A quad tree may mean a quarternary tree. Further, each coding tree unit may be partitioned using a multitype tree (MTT) using one or more partitioning methods.
“CTU” may be used as a term designating a pixel block, which is a processing unit in an image-decoding and encoding process, as in the case of partitioning of an input image.

Coding Tree Block (CTB): “CTB” may be used as a term designating any one of a Y coding tree block, a Cb coding tree block, and a Cr coding tree block.

Neighbor block: A neighbor block (or neighboring block) may mean a block adjacent to a target block. A neighbor block may mean a reconstructed neighbor block.

Hereinafter, the terms “neighbor block” and “adjacent block” may be used to have the same meaning and may be used interchangeably with each other.

A neighbor block may mean a reconstructed neighbor block.

Spatial neighbor block; A spatial neighbor block may a block spatially adjacent to a target block. A neighbor block may include a spatial neighbor block.
The target block and the spatial neighbor block may be included in a target picture.
The spatial neighbor block may mean a block, the boundary of which is in contact with the target block, or a block located within a predetermined distance from the target block.
The spatial neighbor block may mean a block adjacent to the vertex of the target block. Here, the block adjacent to the vertex of the target block may mean a block vertically adjacent to a neighbor block which is horizontally adjacent to the target block or a block horizontally adjacent to a neighbor block which is vertically adjacent to the target block.
Temporal neighbor block: A temporal neighbor block may be a block temporally adjacent to a target block. A neighbor block may include a temporal neighbor block.
The temporal neighbor block may include a co-located block (col block).
The col block may be a block in a previously reconstructed co-located picture (col picture). The location of the col block in the col-picture may correspond to the location of the target block in a target picture. Alternatively, the location of the col block in the col-picture may be equal to the location of the target block in the target picture. The col picture may be a picture included in a reference picture list.
The temporal neighbor block may be a block temporally adjacent to a spatial neighbor block of a target block.

Prediction mode: The prediction mode may be information indicating the mode used for intra prediction, or the mode used for inter prediction.

Prediction unit: A prediction unit may be a base unit for prediction, such as inter prediction, intra prediction, inter compensation, intra compensation, and motion compensation.
A single prediction unit may be divided into multiple partitions having smaller sizes or sub-prediction units. The multiple partitions may also be base units in the performance of prediction or compensation. The partitions generated by dividing the prediction unit may also be prediction units.

Prediction unit partition: A prediction unit partition may be the shape into which a prediction unit is divided.

Reconstructed neighbor unit: A reconstructed neighbor unit may be a unit which has already been decoded and reconstructed neighboring a target unit.
A reconstructed neighbor unit may be a unit that is spatially adjacent to the target unit or that is temporally adjacent to the target unit.
A reconstructed spatial neighbor unit may be a unit which is included in a target picture and which has already been reconstructed through encoding and/or decoding.
A reconstructed temporal neighbor unit may be a unit which is included in a reference image and which has already been reconstructed through encoding and/or decoding. The location of the reconstructed temporal neighbor unit in the reference image may be identical to that of the target unit in the target picture, or may correspond to the location of the target unit in the target picture. Also, a reconstructed temporal neighbor unit may be a block neighboring the corresponding block in a reference image. Here, the location of the corresponding block in the reference image may correspond to the location of the target block in the target image. Here, the fact that the locations of blocks correspond to each other may mean that the locations of the blocks are identical to each other, may mean that one block is included in another block, or may mean that one block occupies a specific location in another block.

Sub-picture: A picture may be divided into one or more sub-pictures. A sub-picture may be composed of one or more tile rows and one or more tile columns.
A sub-picture may be a region having a square shape or a rectangular (i.e., a non-square rectangular) shape in a picture. Further, a sub-picture may include one or more CTUs.
A sub-picture may be a rectangular region of one or more slices in a picture.
One sub-picture may include one or more tiles, one or more bricks, and/or one or more slices.

Tile: A tile may be a region having a square shape or rectangular (i.e., a non-square rectangular) shape in a picture.
A tile may include one or more CTUs.
A tile may be partitioned into one or more bricks.

Brick: A brick may denote one or more CTU rows in a tile.
A tile may be partitioned into one or more bricks. Each brick may include one or more CTU rows.
A tile that is not partitioned into two parts may also denote a brick.

Slice: A slice may include one or more tiles in a picture. Alternatively, a slice may include one or more bricks in a tile.
A sub-picture may contain one or more slices that collectively cover a rectangular region of a picture. Consequently, each sub-picture boundary is also always a slice boundary, and each vertical sub-picture boundary is always also a vertical tile boundary.

Parameter set: A parameter set may correspond to header information in the internal structure of a bitstream.
Header may include at least one of a picture header, a sub-picture header, a slice header, a tile group header, and a tile header.
A parameter set may include at least one of a video parameter set (VPS), a sequence parameter set (SPS), a picture parameter set (PPS), an adaptation parameter set (APS), a decoding parameter set (DPS), etc.
Information signaled through each parameter set may be applied to pictures which refer to the corresponding parameter set. For example, information in a VPS may be applied to pictures which refer to the VPS. Information in an SPS may be applied to pictures which refer to the SPS. Information in a PPS may be applied to pictures which refer to the PPS.
Each parameter set may refer to a higher parameter set. For example, a PPS may refer to an SPS. An SPS may refer to a VPS.
Further, a parameter set may include a tile group, slice header information, and tile header information. The tile group may be a group including multiple tiles. Also, the meaning of “tile group” may be identical to that of “slice”.

Rate-distortion optimization: An encoding apparatus may use rate-distortion optimization so as to provide high coding efficiency by utilizing combinations of the size of a coding unit (CU), a prediction mode, the size of a prediction unit (PU), motion information, and the size of a transform unit (TU).
A rate-distortion optimization scheme may calculate rate-distortion costs of respective combinations so as to select an optimal combination from among the combinations. The rate-distortion costs may be calculated using the equation “D+λ*R”. Generally, a combination enabling the rate-distortion cost to be minimized may be selected as the optimal combination in the rate-distortion optimization scheme.
D may denote distortion. D may be the mean of squares of differences (i.e. mean square error) between original transform coefficients and reconstructed transform coefficients in a transform unit.
R may denote the rate, which may denote a bit rate using related-context information.
λ denotes a Lagrangian multiplier. R may include not only coding parameter information, such as a prediction mode, motion information, and a coded block flag, but also bits generated due to the encoding of transform coefficients.
An encoding apparatus may perform procedures, such as inter prediction and/or intra prediction, transform, quantization, entropy encoding, inverse quantization (dequantization), and/or inverse transform so as to calculate precise D and R. These procedures may greatly increase the complexity of the encoding apparatus.
Bitstream: A bitstream may denote a stream of bits including encoded image information.

Parsing: Parsing may be the decision on the value of a syntax element, made by performing entropy decoding on a bitstream. Alternatively, the term “parsing” may mean such entropy decoding itself.

Symbol: A symbol may be at least one of the syntax element, the coding parameter, and the transform coefficient of an encoding target unit and/or a decoding target unit. Further, a symbol may be the target of entropy encoding or the result of entropy decoding.

Reference picture: A reference picture may be an image referred to by a unit so as to perform inter prediction or motion compensation. Alternatively, a reference picture may be an image including a reference unit referred to by a target unit so as to perform inter prediction or motion compensation.

Hereinafter, the terms “reference picture” and “reference image” may be used to have the same meaning, and may be used interchangeably with each other.

Reference picture list: A reference picture list may be a list including one or more reference images used for inter prediction or motion compensation.
The types of a reference picture list may include List Combined (LC), List 0 (L0), List 1 (L1), List 2 (L2), List 3 (L3), etc.
For inter prediction, one or more reference picture lists may be used.

Inter-prediction indicator: An inter-prediction indicator may indicate the inter-prediction direction for a target unit. Inter prediction may be one of unidirectional prediction and bidirectional prediction. Alternatively, the inter-prediction indicator may denote the number of reference pictures used to generate a prediction unit of a target unit. Alternatively, the inter-prediction indicator may denote the number of prediction blocks used for inter prediction or motion compensation of a target unit.

Prediction list utilization flag: A prediction list utilization flag may indicate whether a prediction unit is generated using at least one reference picture in a specific reference picture list.
An inter-prediction indicator may be derived using the prediction list utilization flag. In contrast, the prediction list utilization flag may be derived using the inter-prediction indicator. For example, the case where the prediction list utilization flag indicates “0”, which is a first value, may indicate that, for a target unit, a prediction block is not generated using a reference picture in a reference picture list. The case where the prediction list utilization flag indicates “1”, which is a second value, may indicate that, for a target unit, a prediction unit is generated using the reference picture list.

Reference picture index: A reference picture index may be an index indicating a specific reference picture in a reference picture list.

Picture Order Count (POC): A POC value for a picture may denote an order in which the corresponding picture is displayed.

Motion vector (MV): A motion vector may be a 2D vector used for inter prediction or motion compensation. A motion vector may mean an offset between a target image and a reference image.
For example, a MV may be represented in a form such as (mvₓ, mv_{y}). mvₓ may indicate a horizontal component, and mv_{y} may indicate a vertical component.
Search range: A search range may be a 2D area in which a search for a MV is performed during inter prediction. For example, the size of the search range may be M×N. M and N may be respective positive integers.

Motion vector candidate: A motion vector candidate may be a block that is a prediction candidate or the motion vector of the block that is a prediction candidate when a motion vector is predicted.
A motion vector candidate may be included in a motion vector candidate list.

Motion vector candidate list: A motion vector candidate list may be a list configured using one or more motion vector candidates.

Motion vector candidate index: A motion vector candidate index may be an indicator for indicating a motion vector candidate in the motion vector candidate list. Alternatively, a motion vector candidate index may be the index of a motion vector predictor.

Motion information: Motion information may be information including at least one of a reference picture list, a reference image, a motion vector candidate, a motion vector candidate index, a merge candidate, and a merge index, as well as a motion vector, a reference picture index, and an inter-prediction indicator.

Merge candidate list: A merge candidate list may be a list configured using one or more merge candidates.

Merge candidate: A merge candidate may be a spatial merge candidate, a temporal merge candidate, a combined merge candidate, a combined bi-prediction merge candidate, a candidate based on a history, a candidate based on an average of two candidates, a zero-merge candidate, etc. A merge candidate may include an inter-prediction indicator, and may include motion information such as prediction type information, a reference picture index for each list, a motion vector, a prediction list utilization flag, and an inter-prediction indicator.

Merge index: A merge index may be an indicator for indicating a merge candidate in a merge candidate list.
A merge index may indicate a reconstructed unit used to derive a merge candidate between a reconstructed unit spatially adjacent to a target unit and a reconstructed unit temporally adjacent to the target unit.
A merge index may indicate at least one of pieces of motion information of a merge candidate.

Transform unit: A transform unit may be the base unit of residual signal encoding and/or residual signal decoding, such as transform, inverse transform, quantization, dequantization, transform coefficient encoding, and transform coefficient decoding. A single transform unit may be partitioned into multiple sub-transform units having a smaller size. Here, a transform may include one or more of a primary transform and a secondary transform, and an inverse transform may include one or more of a primary inverse transform and a secondary inverse transform.

Scaling: Scaling may denote a procedure for multiplying a factor by a transform coefficient level.
As a result of scaling of the transform coefficient level, a transform coefficient may be generated. Scaling may also be referred to as “dequantization”.

Quantization Parameter (QP): A quantization parameter may be a value used to generate a transform coefficient level for a transform coefficient in quantization. Alternatively, a quantization parameter may also be a value used to generate a transform coefficient by scaling the transform coefficient level in dequantization. Alternatively, a quantization parameter may be a value mapped to a quantization step size.

Delta quantization parameter: A delta quantization parameter may mean a difference value between a predicted quantization parameter and the quantization parameter of a target unit.

Scan: Scan may denote a method for aligning the order of coefficients in a unit, a block or a matrix. For example, a method for aligning a 2D array in the form of a one-dimensional (1D) array may be referred to as a “scan”. Alternatively, a method for aligning a 1D array in the form of a 2D array may also be referred to as a “scan” or an “inverse scan”.

Transform coefficient: A transform coefficient may be a coefficient value generated as an encoding apparatus performs a transform. Alternatively, the transform coefficient may be a coefficient value generated as a decoding apparatus performs at least one of entropy decoding and dequantization.
A quantized level or a quantized transform coefficient level generated by applying quantization to a transform coefficient or a residual signal may also be included in the meaning of the term “transform coefficient”.

Quantized level: A quantized level may be a value generated as the encoding apparatus performs quantization on a transform coefficient or a residual signal. Alternatively, the quantized level may be a value that is the target of dequantization as the decoding apparatus performs dequantization.
A quantized transform coefficient level, which is the result of transform and quantization, may also be included in the meaning of a quantized level.

Non-zero transform coefficient: A non-zero transform coefficient may be a transform coefficient having a value other than 0 or a transform coefficient level having a value other than 0. Alternatively, a non-zero transform coefficient may be a transform coefficient, the magnitude of the value of which is not 0, or a transform coefficient level, the magnitude of the value of which is not 0.

Quantization matrix: A quantization matrix may be a matrix used in a quantization procedure or a dequantization procedure so as to improve the subjective image quality or objective image quality of an image. A quantization matrix may also be referred to as a “scaling list”.

Quantization matrix coefficient: A quantization matrix coefficient may be each element in a quantization matrix. A quantization matrix coefficient may also be referred to as a “matrix coefficient”.

Default matrix: A default matrix may be a quantization matrix predefined by the encoding apparatus and the decoding apparatus.

Non-default matrix: A non-default matrix may be a quantization matrix that is not predefined by the encoding apparatus and the decoding apparatus. The non-default matrix may mean a quantization matrix to be signaled from the encoding apparatus to the decoding apparatus by a user.

Most Probable Mode (MPM): An MPM may denote an intra-prediction mode having a high probability of being used for intra prediction for a target block.

An encoding apparatus and a decoding apparatus may determine one or more MPMs based on coding parameters related to the target block and the attributes of entities related to the target block.

The encoding apparatus and the decoding apparatus may determine one or more MPMs based on the intra-prediction mode of a reference block. The reference block may include multiple reference blocks. The multiple reference blocks may include spatial neighbor blocks adjacent to the left of the target block and spatial neighbor blocks adjacent to the top of the target block. In other words, depending on which intra-prediction modes have been used for the reference blocks, one or more different MPMs may be determined.
The one or more MPMs may be determined in the same manner both in the encoding apparatus and in the decoding apparatus. That is, the encoding apparatus and the decoding apparatus may share the same MPM list including one or more MPMs.

MPM list: An MPM list may be a list including one or more MPMs. The number of the one or more MPMs in the MPM list may be defined in advance.

MPM indicator: An MPM indicator may indicate an MPM to be used for intra prediction for a target block among one or more MPMs in the MPM list. For example, the MPM indicator may be an index for the MPM list.
Since the MPM list is determined in the same manner both in the encoding apparatus and in the decoding apparatus, there may be no need to transmit the MPM list itself from the encoding apparatus to the decoding apparatus.
The MPM indicator may be signaled from the encoding apparatus to the decoding apparatus. As the MPM indicator is signaled, the decoding apparatus may determine the MPM to be used for intra prediction for the target block among the MPMs in the MPM list.

MPM use indicator: An MPM use indicator may indicate whether an MPM usage mode is to be used for prediction for a target block. The MPM usage mode may be a mode in which the MPM to be used for intra prediction for the target block is determined using the MPM list.
The MPM use indicator may be signaled from the encoding apparatus to the decoding apparatus.

Signaling: “signaling” may denote that information is transferred from an encoding apparatus to a decoding apparatus. Alternatively, “signaling” may mean information is included in in a bitstream or a recoding medium by an encoding apparatus. Information signaled by an encoding apparatus may be used by a decoding apparatus.
The encoding apparatus may generate encoded information by performing encoding on information to be signaled. The encoded information may be transmitted from the encoding apparatus to the decoding apparatus. The decoding apparatus may obtain information by decoding the transmitted encoded information. Here, the encoding may be entropy encoding, and the decoding may be entropy decoding.

Selective Signaling: Information may be signaled selectively. A selective signaling FOR information may mean that an encoding apparatus selectively includes information (according to a specific condition) in a bitstream or a recording medium. Selective signaling for information may mean that a decoding apparatus selectively extracts information from a bitstream (according to a specific condition).

Omission of signaling: Signaling for information may be omitted. Omission of signaling for information on information may mean that an encoding apparatus does not include information (according to a specific condition) in a bitstream or a recording medium. Omission of signaling for information may mean that a decoding apparatus does not extract information from a bitstream (according to a specific condition).

Statistic value: A variable, a coding parameter, a constant, etc. may have values that can be calculated. The statistic value may be a value generated by performing calculations (operations) on the values of specified targets. For example, the statistic value may indicate one or more of the average, weighted average, weighted sum, minimum value, maximum value, mode, median value, and interpolated value of the values of a specific variable, a specific coding parameter, a specific constant, or the like.

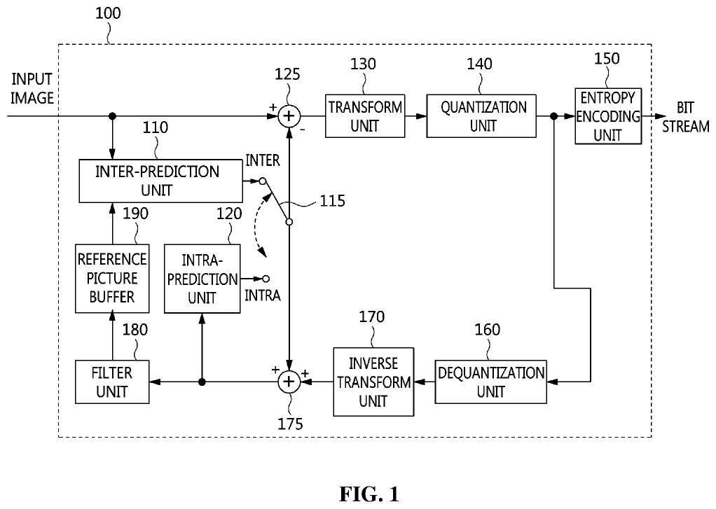

FIG. 1 is a block diagram illustrating the configuration of an embodiment of an encoding apparatus to which the present disclosure is applied.

An encoding apparatus 100 may be an encoder, a video encoding apparatus or an image encoding apparatus. A video may include one or more images (pictures). The encoding apparatus 100 may sequentially encode one or more images of the video.

Referring to FIG. 1, the encoding apparatus 100 includes an inter-prediction unit 110, an intra-prediction unit 120, a switch 115, a subtractor 125, a transform unit 130, a quantization unit 140, an entropy encoding unit 150, a dequantization (inverse quantization) unit 160, an inverse transform unit 170, an adder 175, a filter unit 180, and a reference picture buffer 190.

The encoding apparatus 100 may perform encoding on a target image using an intra mode and/or an inter mode. In other words, a prediction mode for a target block may be one of an intra mode and an inter mode.

Hereinafter, the terms “intra mode”, “intra-prediction mode”, “intra-picture mode” and “intra-picture prediction mode” may be used to have the same meaning, and may be used interchangeably with each other.

Hereinafter, the terms “inter mode”, “inter-prediction mode”, “inter-picture mode” and “inter-picture prediction mode” may be used to have the same meaning, and may be used interchangeably with each other.

Hereinafter, the term “image” may indicate only part of an image, or may indicate a block. Also, the processing of an “image” may indicate sequential processing of multiple blocks.

Further, the encoding apparatus 100 may generate a bitstream, including encoded information, via encoding on the target image, and may output and store the generated bitstream. The generated bitstream may be stored in a computer-readable storage medium and may be streamed through a wired and/or wireless transmission medium.

When the intra mode is used as a prediction mode, the switch 115 may switch to the intra mode. When the inter mode is used as a prediction mode, the switch 115 may switch to the inter mode.

The encoding apparatus 100 may generate a prediction block of a target block. Further, after the prediction block has been generated, the encoding apparatus 100 may encode a residual block for the target block using a residual between the target block and the prediction block.

When the prediction mode is the intra mode, the intra-prediction unit 120 may use pixels of previously encoded/decoded neighbor blocks adjacent to the target block as reference samples. The intra-prediction unit 120 may perform spatial prediction on the target block using the reference samples, and may generate prediction samples for the target block via spatial prediction. the prediction samples may mean samples in the prediction block.

The inter-prediction unit 110 may include a motion prediction unit and a motion compensation unit.

When the prediction mode is an inter mode, the motion prediction unit may search a reference image for the area most closely matching the target block in a motion prediction procedure, and may derive a motion vector for the target block and the found area based on the found area. Here, the motion-prediction unit may use a search range as a target area for searching.

The reference image may be stored in the reference picture buffer 190. More specifically, an encoded and/or decoded reference image may be stored in the reference picture buffer 190 when the encoding and/or decoding of the reference image have been processed.

Since a decoded picture is stored, the reference picture buffer 190 may be a Decoded Picture Buffer (DPB).

The motion compensation unit may generate a prediction block for the target block by performing motion compensation using a motion vector. Here, the motion vector may be a two-dimensional (2D) vector used for inter-prediction. Further, the motion vector may indicate an offset between the target image and the reference image.

The motion prediction unit and the motion compensation unit may generate a prediction block by applying an interpolation filter to a partial area of a reference image when the motion vector has a value other than an integer. In order to perform inter prediction or motion compensation, it may be determined which one of a skip mode, a merge mode, an advanced motion vector prediction (AMVP) mode, and a current picture reference mode corresponds to a method for predicting the motion of a PU included in a CU, based on the CU, and compensating for the motion, and inter prediction or motion compensation may be performed depending on the mode.

The subtractor 125 may generate a residual block, which is the differential between the target block and the prediction block. A residual block may also be referred to as a “residual signal”.

The residual signal may be the difference between an original signal and a prediction signal. Alternatively, the residual signal may be a signal generated by transforming or quantizing the difference between an original signal and a prediction signal or by transforming and quantizing the difference. A residual block may be a residual signal for a block unit.

The transform unit 130 may generate a transform coefficient by transforming the residual block, and may output the generated transform coefficient. Here, the transform coefficient may be a coefficient value generated by transforming the residual block.

The transform unit 130 may use one of multiple predefined transform methods when performing a transform.

The multiple predefined transform methods may include a Discrete Cosine Transform (DCT), a Discrete Sine Transform (DST), a Karhunen-Loeve Transform (KLT), etc.

The transform method used to transform a residual block may be determined depending on at least one of coding parameters for a target block and/or a neighbor block. For example, the transform method may be determined based on at least one of an inter-prediction mode for a PU, an intra-prediction mode for a PU, the size of a TU, and the shape of a TU. Alternatively, transformation information indicating the transform method may be signaled from the encoding apparatus 100 to the decoding apparatus 200.

When a transform skip mode is used, the transform unit 130 may omit transforming the residual block.

By applying quantization to the transform coefficient, a quantized transform coefficient level or a quantized level may be generated. Hereinafter, in the embodiments, each of the quantized transform coefficient level and the quantized level may also be referred to as a ‘transform coefficient’.

The quantization unit 140 may generate a quantized transform coefficient level (i.e., a quantized level or a quantized coefficient) by quantizing the transform coefficient depending on quantization parameters. The quantization unit 140 may output the quantized transform coefficient level that is generated. In this case, the quantization unit 140 may quantize the transform coefficient using a quantization matrix.

The entropy encoding unit 150 may generate a bitstream by performing probability distribution-based entropy encoding based on values, calculated by the quantization unit 140, and/or coding parameter values, calculated in the encoding procedure. The entropy encoding unit 150 may output the generated bitstream.

The entropy encoding unit 150 may perform entropy encoding on information about the pixels of the image and information required to decode the image. For example, the information required to decode the image may include syntax elements or the like.

When entropy encoding is applied, fewer bits may be assigned to more frequently occurring symbols, and more bits may be assigned to rarely occurring symbols. As symbols are represented by means of this assignment, the size of a bit string for target symbols to be encoded may be reduced. Therefore, the compression performance of video encoding may be improved through entropy encoding.

Further, for entropy encoding, the entropy encoding unit 150 may use a coding method such as exponential Golomb, Context-Adaptive Variable Length Coding (CAVLC), or Context-Adaptive Binary Arithmetic Coding (CABAC). For example, the entropy encoding unit 150 may perform entropy encoding using a Variable Length Coding/Code (VLC) table. For example, the entropy encoding unit 150 may derive a binarization method for a target symbol. Further, the entropy encoding unit 150 may derive a probability model for a target symbol/bin. The entropy encoding unit 150 may perform arithmetic coding using the derived binarization method, a probability model, and a context model.

The entropy encoding unit 150 may transform the coefficient of the form of a 2D block into the form of a 1D vector through a transform coefficient scanning method so as to encode a quantized transform coefficient level.

The coding parameters may be information required for encoding and/or decoding. The coding parameters may include information encoded by the encoding apparatus 100 and transferred from the encoding apparatus 100 to a decoding apparatus, and may also include information that may be derived in the encoding or decoding procedure. For example, information transferred to the decoding apparatus may include syntax elements.

The coding parameters may include not only information (or a flag or an index), such as a syntax element, which is encoded by the encoding apparatus and is signaled by the encoding apparatus to the decoding apparatus, but also information derived in an encoding or decoding process. Further, the coding parameters may include information required so as to encode or decode images. For example, the coding parameters may include at least one value, combinations or statistics of a size of a unit/block, a shape/form of a unit/block, a depth of a unit/block, partition information of a unit/block, a partition structure of a unit/block, information indicating whether a unit/block is partitioned in a quad-tree structure, information indicating whether a unit/block is partitioned in a binary tree structure, a partitioning direction of a binary tree structure (horizontal direction or vertical direction), a partitioning form of a binary tree structure (symmetrical partitioning or asymmetrical partitioning), information indicating whether a unit/block is partitioned in a ternary tree structure, a partitioning direction of a ternary tree structure (horizontal direction or vertical direction), a partitioning form of a ternary tree structure (symmetrical partitioning or asymmetrical partitioning, etc.), information indicating whether a unit/block is partitioned in a multi-type tree structure, a combination and a direction (horizontal direction or vertical direction, etc.) of a partitioning of the multi-type tree structure, a partitioning form of a multi-type tree structure (symmetrical partitioning or asymmetrical partitioning, etc.), a partitioning tree (a binary tree or a ternary tree) of the multi-type tree form, a type of a prediction (intra prediction or inter prediction), an intra-prediction mode/direction, an intra luma prediction mode/direction, an intra chroma prediction mode/direction, an intra partitioning information, an inter partitioning information, a coding block partitioning flag, a prediction block partitioning flag, a transform block partitioning flag, a reference sample filtering method, a reference sample filter tap, a reference sample filter coefficient, a prediction block filtering method, a prediction block filter tap, a prediction block filter coefficient, a prediction block boundary filtering method, a prediction block boundary filter tap, a prediction block boundary filter coefficient, an inter-prediction mode, motion information, a motion vector, a motion vector difference, a reference picture index, an inter-prediction direction, an inter-prediction indicator, a prediction list utilization flag, a reference picture list, a reference image, a POC, a motion vector predictor, a motion vector prediction index, a motion vector prediction candidate, a motion vector candidate list, information indicating whether a merge mode is used, a merge index, a merge candidate, a merge candidate list, information indicating whether a skip mode is used, a type of an interpolation filter, a tap of an interpolation filter, a filter coefficient of an interpolation filter, a magnitude of a motion vector, accuracy of motion vector representation, a transform type, a transform size, information indicating whether a first transform is used, information indicating whether an additional (secondary) transform is used, first transform selection information (or a first transform index), secondary transform selection information (or a secondary transform index), information indicating a presence or absence of a residual signal, a coded block pattern, a coded block flag, a quantization parameter, a residual quantization parameter, a quantization matrix, information about an intra-loop filter, information indicating whether an intra-loop filter is applied, a coefficient of an intra-loop filter, a tap of an intra-loop filter, a shape/form of an intra-loop filter, information indicating whether a deblocking filter is applied, a coefficient of a deblocking filter, a tap of a deblocking filter, deblocking filter strength, a shape/form of a deblocking filter, information indicating whether an adaptive sample offset is applied, a value of an adaptive sample offset, a category of an adaptive sample offset, a type of an adaptive sample offset, information indicating whether an adaptive in-loop filter is applied, a coefficient of an adaptive in-loop filter, a tap of an adaptive in-loop filter, a shape/form of an adaptive in-loop filter, a binarization/inverse binarization method, a context model, a context model decision method, a context model update method, information indicating whether a regular mode is performed, information whether a bypass mode is performed, a significant coefficient flag, a last significant coefficient flag, a coding flag for a coefficient group, a position of a last significant coefficient, information indicating whether a value of a coefficient is greater than 1, information indicating whether a value of a coefficient is greater than 2, information indicating whether a value of a coefficient is greater than 3, a remaining coefficient value information, a sign information, a reconstructed luma sample, a reconstructed chroma sample, a context bin, a bypass bin, a residual luma sample, a residual chroma sample, a transform coefficient, a luma transform coefficient, a chroma transform coefficient, a quantized level, a luma quantized level, a chroma quantized level, a transform coefficient level, a transform coefficient level scanning method, a size of a motion vector search region on a side of a decoding apparatus, a shape/form of a motion vector search region on a side of a decoding apparatus, the number of a motion vector search on a side of a decoding apparatus, a size of a CTU, a minimum block size, a maximum block size, a maximum block depth, a minimum block depth, an image display/output order, slice identification information, a slice type, slice partition information, tile group identification information, a tile group type, a tile group partitioning information, tile identification information, a tile type, tile partitioning information, a picture type, bit depth, input sample bit depth, reconstructed sample bit depth, residual sample bit depth, transform coefficient bit depth, quantized level bit depth, information about a luma signal, information about a chroma signal, a color space of a target block and a color space of a residual block. Further, the above-described coding parameter-related information may also be included in the coding parameter. Information used to calculate and/or derive the above-described coding parameter may also be included in the coding parameter. Information calculated or derived using the above-described coding parameter may also be included in the coding parameter.

The first transform selection information may indicate a first transform which is applied to a target block.

The second transform selection information may indicate a second transform which is applied to a target block.

The residual signal may denote the difference between the original signal and a prediction signal. Alternatively, the residual signal may be a signal generated by transforming the difference between the original signal and the prediction signal. Alternatively, the residual signal may be a signal generated by transforming and quantizing the difference between the original signal and the prediction signal. A residual block may be the residual signal for a block.

Here, signaling information may mean that the encoding apparatus 100 includes an entropy-encoded information, generated by performing entropy encoding a flag or an index, in a bitstream, and that the decoding apparatus 200 acquires information by performing entropy decoding on the entropy-encoded information, extracted from the bitstream. Here, the information may comprise a flag, an index, etc.

A signal may mean information to be signaled. Hereinafter, information for an image and a block may be referred to as a signal. Further, hereinafter, the terms “information” and “signal” may be used to have the same meaning and may be used interchangeably with each other. For example, a specific signal may be a signal representing a specific block. An original signal may be a signal representing a target block. A prediction signal may be a signal representing a prediction block. A residual signal may be a signal representing a residual block.

A bitstream may include information based on a specific syntax. The encoding apparatus 100 may generate a bitstream including information depending on a specific syntax. The decoding apparatus 200 may acquire information from the bitstream depending on a specific syntax.

Since the encoding apparatus 100 performs encoding via inter prediction, the encoded target image may be used as a reference image for additional image(s) to be subsequently processed. Therefore, the encoding apparatus 100 may reconstruct or decode the encoded target image and store the reconstructed or decoded image as a reference image in the reference picture buffer 190. For decoding, dequantization and inverse transform on the encoded target image may be processed.

The quantized level may be inversely quantized by the dequantization unit 160, and may be inversely transformed by the inverse transform unit 170. The dequantization unit 160 may generate an inversely quantized coefficient by performing inverse transform for the quantized level. The inverse transform unit 170 may generate a inversely quantized and inversely transformed coefficient by performing inverse transform for the inversely quantized coefficient.

The inversely quantized and inversely transformed coefficient may be added to the prediction block by the adder 175. The inversely quantized and inversely transformed coefficient and the prediction block are added, and then a reconstructed block may be generated. Here, the inversely quantized and/or inversely transformed coefficient may denote a coefficient on which one or more of dequantization and inverse transform are performed, and may also denote a reconstructed residual block. Here, the reconstructed block may mean a recovered block or a decoded block.

The reconstructed block may be subjected to filtering through the filter unit 180. The filter unit 180 may apply one or more of a deblocking filter, a Sample Adaptive Offset (SAO) filter, an Adaptive Loop Filter (ALF), and a Non Local Filter (NLF) to a reconstructed sample, the reconstructed block or a reconstructed picture. The filter unit 180 may also be referred to as an “in-loop filter”.

The deblocking filter may eliminate block distortion occurring at the boundaries between blocks in a reconstructed picture. In order to determine whether to apply the deblocking filter, the number of columns or rows which are included in a block and which include pixel(s) based on which it is determined whether to apply the deblocking filter to a target block may be decided on.

When the deblocking filter is applied to the target block, the applied filter may differ depending on the strength of the required deblocking filtering. In other words, among different filters, a filter decided on in consideration of the strength of deblocking filtering may be applied to the target block. When a deblocking filter is applied to a target block, one or more filters of a long-tap filter, a strong filter, a weak filter and Gaussian filter may be applied to the target block depending on the strength of required deblocking filtering.

Also, when vertical filtering and horizontal filtering are performed on the target block, the horizontal filtering and the vertical filtering may be processed in parallel.

The SAO may add a suitable offset to the values of pixels to compensate for coding error. The SAO may perform, for the image to which deblocking is applied, correction that uses an offset in the difference between an original image and the image to which deblocking is applied, on a pixel basis. To perform an offset correction for an image, a method for dividing the pixels included in the image into a certain number of regions, determining a region to which an offset is to be applied, among the divided regions, and applying an offset to the determined region may be used, and a method for applying an offset in consideration of edge information of each pixel may also be used.

The ALF may perform filtering based on a value obtained by comparing a reconstructed image with an original image. After pixels included in an image have been divided into a predetermined number of groups, filters to be applied to each group may be determined, and filtering may be differentially performed for respective groups. information related to whether to apply an adaptive loop filter may be signaled for each CU. Such information may be signaled for a luma signal. The shapes and filter coefficients of ALFs to be applied to respective blocks may differ for respective blocks. Alternatively, regardless of the features of a block, an ALF having a fixed form may be applied to the block.

A non-local filter may perform filtering based on reconstructed blocks, similar to a target block. A region similar to the target block may be selected from a reconstructed picture, and filtering of the target block may be performed using the statistical properties of the selected similar region. Information about whether to apply a non-local filter may be signaled for a Coding Unit (CU). Also, the shapes and filter coefficients of the non-local filter to be applied to blocks may differ depending on the blocks.

The reconstructed block or the reconstructed image subjected to filtering through the filter unit 180 may be stored in the reference picture buffer 190 as a reference picture. The reconstructed block subjected to filtering through the filter unit 180 may be a part of a reference picture. In other words, the reference picture may be a reconstructed picture composed of reconstructed blocks subjected to filtering through the filter unit 180. The stored reference picture may be subsequently used for inter prediction or a motion compensation.

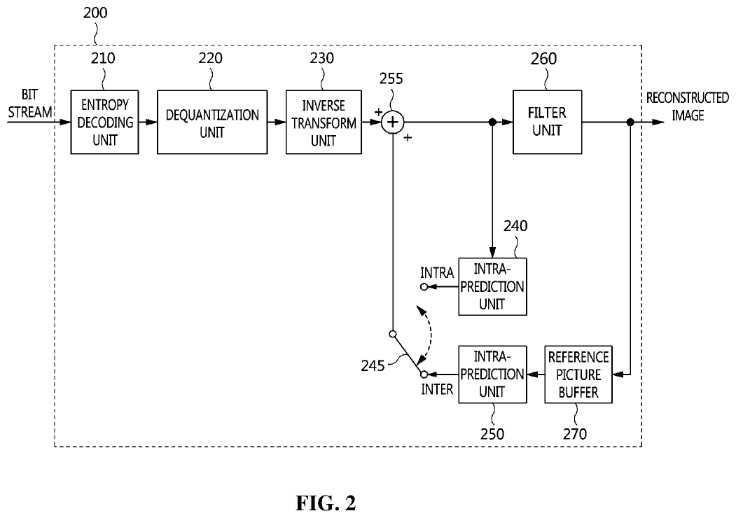

FIG. 2 is a block diagram illustrating the configuration of an embodiment of a decoding apparatus to which the present disclosure is applied.

A decoding apparatus 200 may be a decoder, a video decoding apparatus or an image decoding apparatus.

Referring to FIG. 2, the decoding apparatus 200 may include an entropy decoding unit 210, a dequantization (inverse quantization) unit 220, an inverse transform unit 230, an intra-prediction unit 240, an inter-prediction unit 250, a switch 245 an adder 255, a filter unit 260, and a reference picture buffer 270.

The decoding apparatus 200 may receive a bitstream output from the encoding apparatus 100. The decoding apparatus 200 may receive a bitstream stored in a computer-readable storage medium, and may receive a bitstream that is streamed through a wired/wireless transmission medium.

The decoding apparatus 200 may perform decoding on the bitstream in an intra mode and/or an inter mode. Further, the decoding apparatus 200 may generate a reconstructed image or a decoded image via decoding, and may output the reconstructed image or decoded image.

For example, switching to an intra mode or an inter mode based on the prediction mode used for decoding may be performed by the switch 245. When the prediction mode used for decoding is an intra mode, the switch 245 may be operated to switch to the intra mode. When the prediction mode used for decoding is an inter mode, the switch 245 may be operated to switch to the inter mode.

The decoding apparatus 200 may acquire a reconstructed residual block by decoding the input bitstream, and may generate a prediction block. When the reconstructed residual block and the prediction block are acquired, the decoding apparatus 200 may generate a reconstructed block, which is the target to be decoded, by adding the reconstructed residual block and the prediction block.

The entropy decoding unit 210 may generate symbols by performing entropy decoding on the bitstream based on the probability distribution of a bitstream. The generated symbols may include symbols in a form of a quantized transform coefficient level (i.e., a quantized level or a quantized coefficient). Here, the entropy decoding method may be similar to the above-described entropy encoding method. That is, the entropy decoding method may be the reverse procedure of the above-described entropy encoding method.

The entropy decoding unit 210 may change a coefficient having a one-dimensional (1D) vector form to a 2D block shape through a transform coefficient scanning method in order to decode a quantized transform coefficient level.

For example, the coefficients of the block may be changed to 2D block shapes by scanning the block coefficients using up-right diagonal scanning. Alternatively, which one of up-right diagonal scanning, vertical scanning, and horizontal scanning is to be used may be determined depending on the size and/or the intra-prediction mode of the corresponding block.

The quantized coefficient may be inversely quantized by the dequantization unit 220. The dequantization unit 220 may generate an inversely quantized coefficient by performing dequantization on the quantized coefficient. Further, the inversely quantized coefficient may be inversely transformed by the inverse transform unit 230. The inverse transform unit 230 may generate a reconstructed residual block by performing an inverse transform on the inversely quantized coefficient. As a result of performing dequantization and the inverse transform on the quantized coefficient, the reconstructed residual block may be generated. Here, the dequantization unit 220 may apply a quantization matrix to the quantized coefficient when generating the reconstructed residual block.

When the intra mode is used, the intra-prediction unit 240 may generate a prediction block by performing spatial prediction that uses the pixel values of previously decoded neighbor blocks adjacent to a target block for the target block.

The inter-prediction unit 250 may include a motion compensation unit. Alternatively, the inter-prediction unit 250 may be designated as a “motion compensation unit”.

When the inter mode is used, the motion compensation unit may generate a prediction block by performing motion compensation that uses a motion vector and a reference image stored in the reference picture buffer 270 for the target block.

The motion compensation unit may apply an interpolation filter to a partial area of the reference image when the motion vector has a value other than an integer, and may generate a prediction block using the reference image to which the interpolation filter is applied. In order to perform motion compensation, the motion compensation unit may determine which one of a skip mode, a merge mode, an Advanced Motion Vector Prediction (AMVP) mode, and a current picture reference mode corresponds to the motion compensation method used for a PU included in a CU, based on the CU, and may perform motion compensation depending on the determined mode.

The reconstructed residual block and the prediction block may be added to each other by the adder 255. The adder 255 may generate a reconstructed block by adding the reconstructed residual block to the prediction block.

The reconstructed block may be subjected to filtering through the filter unit 260. The filter unit 260 may apply at least one of a deblocking filter, an SAO filter, an ALF, and a NLF to the reconstructed block or the reconstructed image. The reconstructed image may be a picture including the reconstructed block.

The filter unit may output the reconstructed image.

The reconstructed image and/or the reconstructed block subjected to filtering through the filter unit 260 may be stored as a reference picture in the reference picture buffer 270. The reconstructed block subjected to filtering through the filter unit 260 may be a part of the reference picture. In other words, the reference picture may be an image composed of reconstructed blocks subjected to filtering through the filter unit 260. The stored reference picture may be subsequently used for inter prediction or a motion compensation.

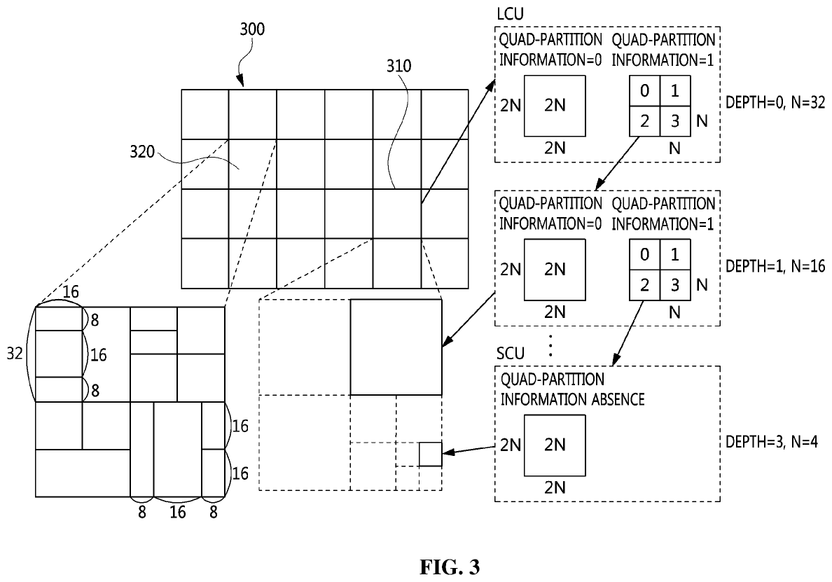

FIG. 3 is a diagram schematically illustrating the partition structure of an image when the image is encoded and decoded.

FIG. 3 may schematically illustrate an example in which a single unit is partitioned into multiple sub-units.

In order to efficiently partition the image, a Coding Unit (CU) may be used in encoding and decoding. The term “unit” may be used to collectively designate 1) a block including image samples and 2) a syntax element. For example, the “partitioning of a unit” may mean the “partitioning of a block corresponding to a unit”.

A CU may be used as a base unit for image encoding/decoding. A CU may be used as a unit to which one mode selected from an intra mode and an inter mode in image encoding/decoding is applied. In other words, in image encoding/decoding, which one of an intra mode and an inter mode is to be applied to each CU may be determined.

Further, a CU may be a base unit in prediction, transform, quantization, inverse transform, dequantization, and encoding/decoding of transform coefficients.

Referring to FIG. 3, an image 200 may be sequentially partitioned into units corresponding to a Largest Coding Unit (LCU), and a partition structure may be determined for each LCU. Here, the LCU may be used to have the same meaning as a Coding Tree Unit (CTU).

The partitioning of a unit may mean the partitioning of a block corresponding to the unit. Block partition information may include depth information about the depth of a unit. The depth information may indicate the number of times the unit is partitioned and/or the degree to which the unit is partitioned. A single unit may be hierarchically partitioned into a plurality of sub-units while having depth information based on a tree structure.

Each of partitioned sub-units may have depth information. The depth information may be information indicating the size of a CU. The depth information may be stored for each CU.

Each CU may have depth information. When the CU is partitioned, CUs resulting from partitioning may have a depth increased from the depth of the partitioned CU by 1.

The partition structure may mean the distribution of Coding Units (CUs) to efficiently encode the image in an LCU 310. Such a distribution may be determined depending on whether a single CU is to be partitioned into multiple CUs. The number of CUs generated by partitioning may be a positive integer of 2 or more, including 2, 3, 4, 8, 16, etc.

The horizontal size and the vertical size of each of CUs generated by the partitioning may be less than the horizontal size and the vertical size of a CU before being partitioned, depending on the number of CUs generated by partitioning. For example, the horizontal size and the vertical size of each of CUs generated by the partitioning may be half of the horizontal size and the vertical size of a CU before being partitioned.

Each partitioned CU may be recursively partitioned into four CUs in the same way. Via the recursive partitioning, at least one of the horizontal size and the vertical size of each partitioned CU may be reduced compared to at least one of the horizontal size and the vertical size of the CU before being partitioned.

The partitioning of a CU may be recursively performed up to a predefined depth or a predefined size.

For example, the depth of a CU may have a value ranging from 0 to 3. The size of the CU may range from a size of 64×64 to a size of 8×8 depending on the depth of the CU.

For example, the depth of an LCU 310 may be 0, and the depth of a Smallest Coding Unit (SCU) may be a predefined maximum depth. Here, as described above, the LCU may be the CU having the maximum coding unit size, and the SCU may be the CU having the minimum coding unit size.

Partitioning may start at the LCU 310, and the depth of a CU may be increased by 1 whenever the horizontal and/or vertical sizes of the CU are reduced by partitioning.

For example, for respective depths, a CU that is not partitioned may have a size of 2N×2N. Further, in the case of a CU that is partitioned, a CU having a size of 2N×2N may be partitioned into four CUs, each having a size of N×N. The value of N may be halved whenever the depth is increased by 1.

Referring to FIG. 3, an LCU having a depth of 0 may have 64×64 pixels or 64×64 blocks. 0 may be a minimum depth. An SCU having a depth of 3 may have 8×8 pixels or 8×8 blocks. 3 may be a maximum depth. Here, a CU having 64×64 blocks, which is the LCU, may be represented by a depth of 0. A CU having 32×32 blocks may be represented by a depth of 1. A CU having 16×16 blocks may be represented by a depth of 2. A CU having 8×8 blocks, which is the SCU, may be represented by a depth of 3.

Information about whether the corresponding CU is partitioned may be represented by the partition information of the CU. The partition information may be 1-bit information. All CUs except the SCU may include partition information. For example, the value of the partition information of a CU that is not partitioned may be a first value. The value of the partition information of a CU that is partitioned may be a second value. When the partition information indicates whether a CU is partitioned or not, the first value may be “0” and the second value may be “1”.

For example, when a single CU is partitioned into four CUs, the horizontal size and vertical size of each of four CUs generated by partitioning may be half the horizontal size and the vertical size of the CU before being partitioned. When a CU having a 32×32 size is partitioned into four CUs, the size of each of four partitioned CUs may be 16×16. When a single CU is partitioned into four CUs, it may be considered that the CU has been partitioned in a quad-tree structure. In other words, it may be considered that a quad-tree partition has been applied to a CU.

For example, when a single CU is partitioned into two CUs, the horizontal size or the vertical size of each of two CUs generated by partitioning may be half the horizontal size or the vertical size of the CU before being partitioned. When a CU having a 32×32 size is vertically partitioned into two CUs, the size of each of two partitioned CUs may be 16×32. When a CU having a 32×32 size is horizontally partitioned into two CUs, the size of each of two partitioned CUs may be 32×16. When a single CU is partitioned into two CUs, it may be considered that the CU has been partitioned in a binary-tree structure. In other words, it may be considered that a binary-tree partition has been applied to a CU.

For example, when a single CU is partitioned (or split) into three CUs, the original CU before being partitioned is partitioned so that the horizontal size or vertical size thereof is divided at a ratio of 1:2:1, thus enabling three sub-CUs to be generated. For example, when a CU having a 16×32 size is horizontally partitioned into three sub-CUs, the three sub-CUs resulting from the partitioning may have sizes of 16×8, 16×16, and 16×8, respectively, in a direction from the top to the bottom. For example, when a CU having a 32×32 size is vertically partitioned into three sub-CUs, the three sub-CUs resulting from the partitioning may have sizes of 8×32, 16×32, and 8×32, respectively, in a direction from the left to the right. When a single CU is partitioned into three CUs, it may be considered that the CU is partitioned in a ternary-tree form. In other words, it may be considered that a ternary-tree partition has been applied to the CU.

Both of quad-tree partitioning and binary-tree partitioning are applied to the LCU 310 of FIG. 3.

In the encoding apparatus 100, a Coding Tree Unit (CTU) having a size of 64×64 may be partitioned into multiple smaller CUs by a recursive quad-tree structure. A single CU may be partitioned into four CUs having the same size. Each CU may be recursively partitioned, and may have a quad-tree structure.

By the recursive partitioning of a CU, an optimal partitioning method that incurs a minimum rate-distortion cost may be selected.

The Coding Tree Unit (CTU) 320 in FIG. 3 is an example of a CTU to which all of a quad-tree partition, a binary-tree partition, and a ternary-tree partition are applied.

As described above, in order to partition a CTU, at least one of a quad-tree partition, a binary-tree partition, and a ternary-tree partition may be applied to the CTU. Partitions may be applied based on specific priority.

For example, a quad-tree partition may be preferentially applied to the CTU. A CU that cannot be partitioned in a quad-tree form any further may correspond to a leaf node of a quad-tree. A CU corresponding to the leaf node of the quad-tree may be a root node of a binary tree and/or a ternary tree. That is, the CU corresponding to the leaf node of the quad-tree may be partitioned in a binary-tree form or a ternary-tree form, or may not be partitioned any further. In this case, each CU, which is generated by applying a binary-tree partition or a ternary-tree partition to the CU corresponding to the leaf node of a quad-tree, is prevented from being subjected again to quad-tree partitioning, thus effectively performing partitioning of a block and/or signaling of block partition information.

The partition of a CU corresponding to each node of a quad-tree may be signaled using quad-partition information. Quad-partition information having a first value (e.g., “1”) may indicate that the corresponding CU is partitioned in a quad-tree form. Quad-partition information having a second value (e.g., “0”) may indicate that the corresponding CU is not partitioned in a quad-tree form. The quad-partition information may be a flag having a specific length (e.g., 1 bit).

Priority may not exist between a binary-tree partition and a ternary-tree partition. That is, a CU corresponding to the leaf node of a quad-tree may be partitioned in a binary-tree form or a ternary-tree form. Also, the CU generated through a binary-tree partition or a ternary-tree partition may be further partitioned in a binary-tree form or a ternary-tree form, or may not be partitioned any further.

Partitioning performed when priority does not exist between a binary-tree partition and a ternary-tree partition may be referred to as a “multi-type tree partition”. That is, a CU corresponding to the leaf node of a quad-tree may be the root node of a multi-type tree. Partitioning of a CU corresponding to each node of the multi-type tree may be signaled using at least one of information indicating whether the CU is partitioned in a multi-type tree, partition direction information, and partition tree information. For partitioning of a CU corresponding to each node of a multi-type tree, information indicating whether partitioning in the multi-type tree is performed, partition direction information, and partition tree information may be sequentially signaled.

For example, information indicating whether a CU is partitioned in a multi-type tree and having a first value (e.g., “1”) may indicate that the corresponding CU is partitioned in a multi-type tree form. Information indicating whether a CU is partitioned in a multi-type tree and having a second value (e.g., “0”) may indicate that the corresponding CU is not partitioned in a multi-type tree form.

When a CU corresponding to each node of a multi-type tree is partitioned in a multi-type tree form, the corresponding CU may further include partition direction information.

The partition direction information may indicate the partition direction of the multi-type tree partition. Partition direction information having a first value (e.g., “1”) may indicate that the corresponding CU is partitioned in a vertical direction. Partition direction information having a second value (e.g., “0”) may indicate that the corresponding CU is partitioned in a horizontal direction.

When a CU corresponding to each node of a multi-type tree is partitioned in a multi-type tree form, the corresponding CU may further include partition-tree information. The partition-tree information may indicate the tree that is used for a multi-type tree partition.

For example, partition-tree information having a first value (e.g., “1”) may indicate that the corresponding CU is partitioned in a binary-tree form. Partition-tree information having a second value (e.g., “0”) may indicate that the corresponding CU is partitioned in a ternary-tree form.

Here, each of the above-described information indicating whether partitioning in the multi-type tree is performed, partition-tree information, and partition direction information may be a flag having a specific length (e.g., 1 bit).

At least one of the above-described quad-partition information, information indicating whether partitioning in the multi-type tree is performed, partition direction information, and partition-tree information may be entropy-encoded and/or entropy-decoded. In order to perform entropy encoding/decoding of such information, information of a neighbor CU adjacent to a target CU may be used.

For example, it may be considered that there is a high probability that the partition form of a left CU and/or an above CU (i.e., partitioning/non-partitioning, a partition tree and/or a partition direction) and the partition form of a target CU will be similar to each other. Therefore, based on the information of a neighbor CU, context information for entropy encoding and/or entropy decoding of the information of the target CU may be derived. Here, the information of the neighbor CU may include at least one of 1) quad-partition information of the neighbor CU, 2) information indicating whether the neighbor CU is partitioned in a multi-type tree, 3) partition direction information of the neighbor CU, and 4) partition-tree information of the neighbor CU.

In another embodiment, of a binary-tree partition and a ternary-tree partition, the binary-tree partition may be preferentially performed. That is, the binary-tree partition may be first applied, and then a CU corresponding to the leaf node of a binary tree may be set to the root node of a ternary tree. In this case, a quad-tree partition or a binary-tree partition may not be performed on the CU corresponding to the node of the ternary tree.

A CU, which is not partitioned any further through a quad-tree partition, a binary-tree partition, and/or a ternary-tree partition, may be the unit of encoding, prediction and/or transform. That is, the CU may not be partitioned any further for prediction and/or transform. Therefore, a partition structure for partitioning the CU into Prediction Units (PUs) and/or Transform Units (TUs), partition information thereof, etc. may not be present in a bitstream.

However, when the size of a CU, which is the unit of partitioning, is greater than the size of a maximum transform block, the CU may be recursively partitioned until the size of the CU becomes less than or equal to the size of the maximum transform block. For example, when the size of a CU is 64×64 and the size of the maximum transform block is 32×32, the CU may be partitioned into four 32×32 blocks so as to perform a transform. For example, when the size of a CU is 32×64 and the size of the maximum transform block is 32×32, the CU may be partitioned into two 32×32 blocks.

In this case, information indicating whether a CU is partitioned for a transform may not be separately signaled. Without signaling, whether a CU is partitioned may be determined via a comparison between the horizontal size (and/or vertical size) of the CU and the horizontal size (and/or vertical size) of the maximum transform block. For example, when the horizontal size of the CU is greater than the horizontal size of the maximum transform block, the CU may be vertically bisected. Further, when the vertical size of the CU is greater than the vertical size of the maximum transform block, the CU may be horizontally bisected.

Information about the maximum size and/or minimum size of a CU and information about the maximum size and/or minimum size of a transform block may be signaled or determined at a level higher than that of the CU. For example, the higher level may be a sequence level, a picture level, a tile level, a tile group level or a slice level. For example, the minimum size of the CU may be set to 4×4. For example, the maximum size of the transform block may be set to 64×64. For example, the maximum size of the transform block may be set to 4×4.

Information about the minimum size of a CU corresponding to the leaf node of a quad-tree (i.e., the minimum size of the quad-tree) and/or information about the maximum depth of a path from the root node to the leaf node of a multi-type tree (i.e., the maximum depth of a multi-type tree) may be signaled or determined at a level higher than that of the CU. For example, the higher level may be a sequence level, a picture level, a slice level, a tile group level or a tile level. Information about the minimum size of a quad-tree and/or information about the maximum depth of a multi-type tree may be separately signaled or determined at each of an intra-slice level and an inter-slice level.

Information about the difference between the size of a CTU and the maximum size of a transform block may be signaled or determined at a level higher than that of a CU. For example, the higher level may be a sequence level, a picture level, a slice level, a tile group level or a tile level. Information about the maximum size of a CU corresponding to each node of a binary tree (i.e., the maximum size of the binary tree) may be determined based on the size and the difference information of a CTU. The maximum size of a CU corresponding to each node of a ternary tree (i.e., the maximum size of the ternary tree) may have different values depending on the type of slice. For example, the maximum size of the ternary tree at an intra-slice level may be 32×32. For example, the maximum size of the ternary tree at an inter-slice level may be 128×128. For example, the minimum size of a CU corresponding to each node of a binary tree (i.e., the minimum size of the binary tree) and/or the minimum size of a CU corresponding to each node of a ternary tree (i.e., the minimum size of the ternary tree) may be set to the minimum size of a CU.

In a further example, the maximum size of a binary tree and/or the maximum size of a ternary tree may be signaled or determined at a slice level. Also, the minimum size of a binary tree and/or the minimum size of a ternary tree may be signaled or determined at a slice level.

Based on the above-described various block sizes and depths, quad-partition information, information indicating whether partitioning in a multi-type tree is performed, partition tree information and/or partition direction information may or may not be present in a bitstream.

For example, when the size of a CU is not greater than the minimum size of a quad-tree, the CU may not include quad-partition information, and quad-partition information of the CU may be inferred as a second value.

For example, when the size of a CU corresponding to each node of a multi-type tree (horizontal size and vertical size) is greater than the maximum size of a binary tree (horizontal size and vertical size) and/or the maximum size of a ternary tree (horizontal size and vertical size), the CU may not be partitioned in a binary-tree form and/or a ternary-tree form. By means of this determination manner, information indicating whether partitioning in a multi-type tree is performed may not be signaled, but may be inferred as a second value.

Alternatively, when the size of a CU corresponding to each node of a multi-type tree (horizontal size and vertical size) is equal to the minimum size of a binary tree (horizontal size and vertical size), or when the size of a CU (horizontal size and vertical size) is equal to twice the minimum size of a ternary tree (horizontal size and vertical size), the CU may not be partitioned in a binary tree form and/or a ternary tree form. By means of this determination manner, information indicating whether partitioning in a multi-type tree is performed may not be signaled, but may be inferred as a second value. The reason for this is that, when a CU is partitioned in a binary tree form and/or a ternary tree form, a CU smaller than the minimum size of the binary tree and/or the minimum size of the ternary tree is generated.

Alternatively, a binary-tree partition or a ternary-tree partition may be limited based on the size of a virtual pipeline data unit (i.e., the size of a pipeline buffer). For example, when a CU is partitioned into sub-CUs unsuitable for the size of a pipeline buffer through a binary-tree partition or a ternary-tree partition, a binary-tree partition or a ternary-tree partition may be limited. The size of the pipeline buffer may be equal to the maximum size of a transform block (e.g., 64×64).

For example, when the size of the pipeline buffer is 64×64, the following partitions may be limited.
Ternary-tree partition for N×M CU (where N and/or M are 128)
Horizontal binary-tree partition for 128×N CU (where N<=64)
Vertical binary-tree partition for N×128 CU (where N<=64)

Alternatively, when the depth of a CU corresponding to each node of a multi-type tree is equal to the maximum depth of the multi-type tree, the CU may not be partitioned in a binary-tree form and/or a ternary-tree form. By means of this determination manner, information indicating whether partitioning in a multi-type tree is performed may not be signaled, but may be inferred as a second value.

Alternatively, information indicating whether partitioning in a multi-type tree is performed may be signaled only when at least one of a vertical binary-tree partition, a horizontal binary-tree partition, a vertical ternary-tree partition, and a horizontal ternary-tree partition is possible for a CU corresponding to each node of a multi-type tree. Otherwise, the CU may not be partitioned in a binary-tree form and/or a ternary-tree form. By means of this determination manner, information indicating whether partitioning in a multi-type tree is performed may not be signaled, but may be inferred as a second value.

Alternatively, partition direction information may be signaled only when both a vertical binary-tree partition and a horizontal binary-tree partition are possible or only when both a vertical ternary-tree partition and a horizontal ternary-tree partition are possible, for a CU corresponding to each node of a multi-type tree. Otherwise, the partition direction information may not be signaled, but may be inferred as a value indicating the direction in which the CU can be partitioned.

Alternatively, partition tree information may be signaled only when both a vertical binary-tree partition and a vertical ternary-tree partition are possible or only when both a horizontal binary-tree partition and a horizontal ternary-tree partition are possible, for a CU corresponding to each node of a multi-type tree. Otherwise, the partition tree information may not be signaled, but may be inferred as a value indicating a tree that can be applied to the partition of the CU.

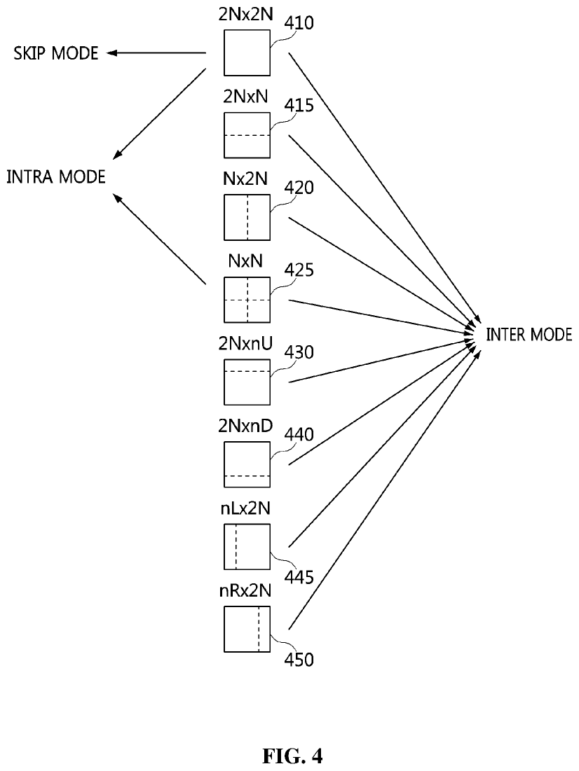

FIG. 4 is a diagram illustrating the form of a Prediction Unit that a Coding Unit can include.

When, among CUs partitioned from an LCU, a CU, which is not partitioned any further, may be divided into one or more Prediction Units (PUs). Such division is also referred to as “partitioning”.

A PU may be a base unit for prediction. A PU may be encoded and decoded in any one of a skip mode, an inter mode, and an intra mode. A PU may be partitioned into various shapes depending on respective modes. For example, the target block, described above with reference to FIG. 1, and the target block, described above with reference to FIG. 2, may each be a PU.

A CU may not be split into PUs. When the CU is not split into PUs, the size of the CU and the size of a PU may be equal to each other.

In a skip mode, partitioning may not be present in a CU. In the skip mode, a 2N×2N mode 410, in which the sizes of a PU and a CU are identical to each other, may be supported without partitioning.

In an inter mode, 8 types of partition shapes may be present in a CU. For example, in the inter mode, the 2N×2N mode 410, a 2N×N mode 415, an N×2N mode 420, an N×N mode 425, a 2NxnU mode 430, a 2NxnD mode 435, an nL×2N mode 440, and an nR×2N mode 445 may be supported.

In an intra mode, the 2N×2N mode 410 and the N×N mode 425 may be supported.

In the 2N×2N mode 410, a PU having a size of 2N×2N may be encoded. The PU having a size of 2N×2N may mean a PU having a size identical to that of the CU. For example, the PU having a size of 2N×2N may have a size of 64×64, 32×32, 16×16 or 8×8.

In the N×N mode 425, a PU having a size of N×N may be encoded.

For example, in intra prediction, when the size of a PU is 8×8, four partitioned PUs may be encoded. The size of each partitioned PU may be 4×4.

When a PU is encoded in an intra mode, the PU may be encoded using any one of multiple intra-prediction modes. For example, HEVC technology may provide 35 intra-prediction modes, and the PU may be encoded in any one of the 35 intra-prediction modes.

Which one of the 2N×2N mode 410 and the N×N mode 425 is to be used to encode the PU may be determined based on rate-distortion cost.

The encoding apparatus 100 may perform an encoding operation on a PU having a size of 2N×2N. Here, the encoding operation may be the operation of encoding the PU in each of multiple intra-prediction modes that can be used by the encoding apparatus 100. Through the encoding operation, the optimal intra-prediction mode for a PU having a size of 2N×2N may be derived. The optimal intra-prediction mode may be an intra-prediction mode in which a minimum rate-distortion cost occurs upon encoding the PU having a size of 2N×2N, among multiple intra-prediction modes that can be used by the encoding apparatus 100.

Further, the encoding apparatus 100 may sequentially perform an encoding operation on respective PUs obtained from N×N partitioning. Here, the encoding operation may be the operation of encoding a PU in each of multiple intra-prediction modes that can be used by the encoding apparatus 100. By means of the encoding operation, the optimal intra-prediction mode for the PU having a size of N×N may be derived. The optimal intra-prediction mode may be an intra-prediction mode in which a minimum rate-distortion cost occurs upon encoding the PU having a size of N×N, among multiple intra-prediction modes that can be used by the encoding apparatus 100.

The encoding apparatus 100 may determine which of a PU having a size of 2N×2N and PUs having sizes of N×N to be encoded based on a comparison of a rate-distortion cost of the PU having a size of 2N×2N and a rate-distortion costs of the PUs having sizes of N×N.

A single CU may be partitioned into one or more PUs, and a PU may be partitioned into multiple PUs.

For example, when a single PU is partitioned into four PUs, the horizontal size and vertical size of each of four PUs generated by partitioning may be half the horizontal size and the vertical size of the PU before being partitioned. When a PU having a 32×32 size is partitioned into four PUs, the size of each of four partitioned PUs may be 16×16. When a single PU is partitioned into four PUs, it may be considered that the PU has been partitioned in a quad-tree structure.

For example, when a single PU is partitioned into two PUs, the horizontal size or the vertical size of each of two PUs generated by partitioning may be half the horizontal size or the vertical size of the PU before being partitioned. When a PU having a 32×32 size is vertically partitioned into two PUs, the size of each of two partitioned PUs may be 16×32. When a PU having a 32×32 size is horizontally partitioned into two PUs, the size of each of two partitioned PUs may be 32×16. When a single PU is partitioned into two PUs, it may be considered that the PU has been partitioned in a binary-tree structure.

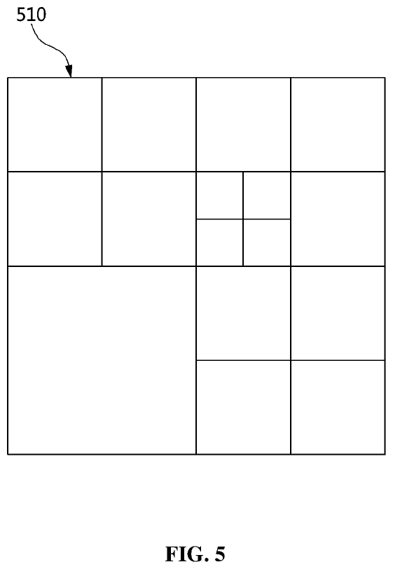

FIG. 5 is a diagram illustrating the form of a Transform Unit that can be included in a Coding Unit.

A Transform Unit (TU) may have a base unit that is used for a procedure, such as transform, quantization, inverse transform, dequantization, entropy encoding, and entropy decoding, in a CU.

A TU may have a square shape or a rectangular shape. A shape of a TU may be determined based on a size and/or a shape of a CU.

Among CUs partitioned from the LCU, a CU which is not partitioned into CUs any further may be partitioned into one or more TUs. Here, the partition structure of a TU may be a quad-tree structure. For example, as shown in FIG. 5, a single CU 510 may be partitioned one or more times depending on the quad-tree structure. By means of this partitioning, the single CU 510 may be composed of TUs having various sizes.

It can be considered that when a single CU is split two or more times, the CU is recursively split. Through splitting, a single CU may be composed of Transform Units (TUs) having various sizes.

Alternatively, a single CU may be split into one or more TUs based on the number of vertical lines and/or horizontal lines that split the CU.

A CU may be split into symmetric TUs or asymmetric TUs. For splitting into asymmetric TUs, information about the size and/or shape of each TU may be signaled from the encoding apparatus 100 to the decoding apparatus 200. Alternatively, the size and/or shape of each TU may be derived from information about the size and/or shape of the CU.

A CU may not be split into TUs. When the CU is not split into TUs, the size of the CU and the size of a TU may be equal to each other.

A single CU may be partitioned into one or more TUs, and a TU may be partitioned into multiple TUs.

For example, when a single TU is partitioned into four TUs, the horizontal size and vertical size of each of four TUs generated by partitioning may be half the horizontal size and the vertical size of the TU before being partitioned. When a TU having a 32×32 size is partitioned into four TUs, the size of each of four partitioned TUs may be 16×16. When a single TU is partitioned into four TUs, it may be considered that the TU has been partitioned in a quad-tree structure.

For example, when a single TU is partitioned into two TUs, the horizontal size or the vertical size of each of two TUs generated by partitioning may be half the horizontal size or the vertical size of the TU before being partitioned. When a TU having a 32×32 size is vertically partitioned into two TUs, the size of each of two partitioned TUs may be 16×32.

When a TU having a 32×32 size is horizontally partitioned into two TUs, the size of each of two partitioned TUs may be 32×16. When a single TU is partitioned into two TUs, it may be considered that the TU has been partitioned in a binary-tree structure.

In a way differing from that illustrated in FIG. 5, a CU may be split.

For example, a single CU may be split into three CUs. The horizontal sizes or vertical sizes of the three CUs generated from splitting may be ¼, ½, and ¼, respectively, of the horizontal size or vertical size of the original CU before being split.

For example, when a CU having a 32×32 size is vertically split into three CUs, the sizes of the three CUs generated from the splitting may be 8×32, 16×32, and 8×32, respectively. In this way, when a single CU is split into three CUs, it may be considered that the CU is split in the form of a ternary tree.

One of exemplary splitting forms, that is, quad-tree splitting, binary tree splitting, and ternary tree splitting, may be applied to the splitting of a CU, and multiple splitting schemes may be combined and used together for splitting of a CU. Here, the case where multiple splitting schemes are combined and used together may be referred to as “complex tree-format splitting”.

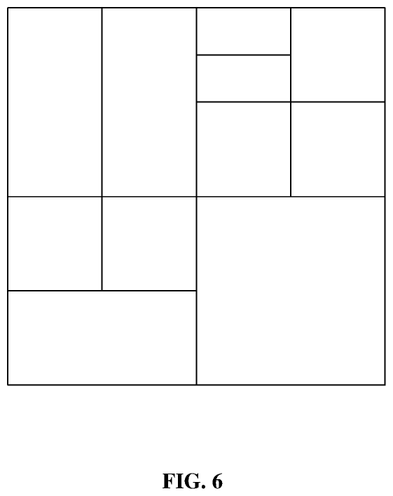

FIG. 6 illustrates the splitting of a block according to an example.

In a video encoding and/or decoding process, a target block may be split, as illustrated in FIG. 6. For example, the target block may be a CU.

For splitting of the target block, an indicator indicating split information may be signaled from the encoding apparatus 100 to the decoding apparatus 200. The split information may be information indicating how the target block is split.

The split information may be one or more of a split flag (hereinafter referred to as “split_flag”), a quad-binary flag (hereinafter referred to as “QB_flag”), a quad-tree flag (hereinafter referred to as “quadtree_flag”), a binary tree flag (hereinafter referred to as “binarytree_flag”), and a binary type flag (hereinafter referred to as “Btype_flag”).

“split_flag” may be a flag indicating whether a block is split. For example, a split_flag value of 1 may indicate that the corresponding block is split. A split_flag value of 0 may indicate that the corresponding block is not split.

“QB_flag” may be a flag indicating which one of a quad-tree form and a binary tree form corresponds to the shape in which the block is split. For example, a QB_flag value of 0 may indicate that the block is split in a quad-tree form. A QB_flag value of 1 may indicate that the block is split in a binary tree form. Alternatively, a QB_flag value of 0 may indicate that the block is split in a binary tree form. A QB_flag value of 1 may indicate that the block is split in a quad-tree form.

“quadtree_flag” may be a flag indicating whether a block is split in a quad-tree form. For example, a quadtree_flag value of 1 may indicate that the block is split in a quad-tree form. A quadtree_flag value of 0 may indicate that the block is not split in a quad-tree form.

“binarytree_flag” may be a flag indicating whether a block is split in a binary tree form. For example, a binarytree_flag value of 1 may indicate that the block is split in a binary tree form. A binarytree_flag value of 0 may indicate that the block is not split in a binary tree form.

“Btype_flag” may be a flag indicating which one of a vertical split and a horizontal split corresponds to a split direction when a block is split in a binary tree form. For example, a Btype_flag value of 0 may indicate that the block is split in a horizontal direction. A Btype_flag value of 1 may indicate that a block is split in a vertical direction. Alternatively, a Btype_flag value of 0 may indicate that the block is split in a vertical direction. A Btype_flag value of 1 may indicate that a block is split in a horizontal direction.

For example, the split information of the block in FIG. 6 may be derived by signaling at least one of quadtree_flag, binarytree_flag, and Btype_flag, as shown in the following Table 1.

TABLE 1

| quadtree_flag | binarytree_flag | Btype_flag |
|---|---|---|
| 1 | | |
| 0 | | |
| | 1 | |
| | | 1 |
| | 0 | |
| | 0 | |
| 1 | | |
| 0 | | |
| | 1 | |
| | | 0 |
| | 0 | |
| | 0 | |
| 0 | | |
| | 0 | |
| 0 | | |
| | 0 | |
| 0 | | |
| | 0 | |
| 0 | | |
| | 1 | |
| | | 0 |
| | 1 | |
| | | 1 |
| | 0 | |
| | 0 | |
| | 0 | |
| 0 | | |
| | 0 | |

For example, the split information of the block in FIG. 6 may be derived by signaling at least one of split_flag, QB_flag, and Btype_flag, as shown in the following Table 2.

TABLE 2

| split_flag | QB_flag | Btype_flag |
|---|---|---|
| 1 | | |
| | 0 | |
| 1 | | |
| | 1 | |
| | | 1 |
| 0 | | |
| 0 | | |
| 1 | | |
| | 0 | |
| 1 | | |
| | 1 | |
| | | 0 |
| 0 | | |
| 0 | | |
| 0 | | |
| 0 | | |
| 0 | | |
| 1 | | |
| | 1 | |
| | | 0 |
| 1 | | |
| | | 1 |
| 0 | | |
| 0 | | |
| 0 | | |
| 0 | | |

The splitting method may be limited only to a quad-tree or to a binary tree depending on the size and/or shape of the block. When this limitation is applied, split-flag may be a flag indicating whether a block is split in a quad-tree form or a flag indicating whether a block is split in a binary tree form. The size and shape of a block may be derived depending on the depth information of the block, and the depth information may be signaled from the encoding apparatus 100 to the decoding apparatus 200.

When the size of a block falls within a specific range, only splitting in a quad-tree form may be possible. For example, the specific range may be defined by at least one of a maximum block size and a minimum block size at which only splitting in a quad-tree form is possible.

Information indicating the maximum block size and the minimum block size at which only splitting in a quad-tree form is possible may be signaled from the encoding apparatus 100 to the decoding apparatus 200 through a bitstream. Further, this information may be signaled for at least one of units such as a video, a sequence, a picture, a parameter, a tile group, and a slice (or a segment).

Alternatively, the maximum block size and/or the minimum block size may be fixed sizes predefined by the encoding apparatus 100 and the decoding apparatus 200. For example, when the size of a block is above 64×64 and below 256×256, only splitting in a quad-tree form may be possible. In this case, split_flag may be a flag indicating whether splitting in a quad-tree form is performed.

When the size of a block is greater than the maximum size of a transform block, only partitioning in a quad-tree form may be possible. Here, a sub-block resulting from partitioning may be at least one of a CU and a TU.

In this case, split_flag may be a flag indicating whether a CU is partitioned in a quad-tree form.

When the size of a block falls within the specific range, only splitting in a binary tree form or a ternary tree form may be possible. For example, the specific range may be defined by at least one of a maximum block size and a minimum block size at which only splitting in a binary tree form or a ternary tree form is possible.

Information indicating the maximum block size and/or the minimum block size at which only splitting in a binary tree form or splitting in a ternary tree form is possible may be signaled from the encoding apparatus 100 to the decoding apparatus 200 through a bitstream. Further, this information may be signaled for at least one of units such as a sequence, a picture, and a slice (or a segment).

Alternatively, the maximum block size and/or the minimum block size may be fixed sizes predefined by the encoding apparatus 100 and the decoding apparatus 200. For example, when the size of a block is above 8×8 and below 16×16, only splitting in a binary tree form may be possible. In this case, split_flag may be a flag indicating whether splitting in a binary tree form or a ternary tree form is performed.

The above description of partitioning in a quad-tree form may be equally applied to a binary-tree form and/or a ternary-tree form.

The partition of a block may be limited by a previous partition. For example, when a block is partitioned in a specific binary-tree form and then multiple sub-blocks are generated from the partitioning, each sub-block may be additionally partitioned only in a specific tree form. Here, the specific tree form may be at least one of a binary-tree form, a ternary-tree form, and a quad-tree form.

When the horizontal size or vertical size of a partition block is a size that cannot be split further, the above-described indicator may not be signaled.

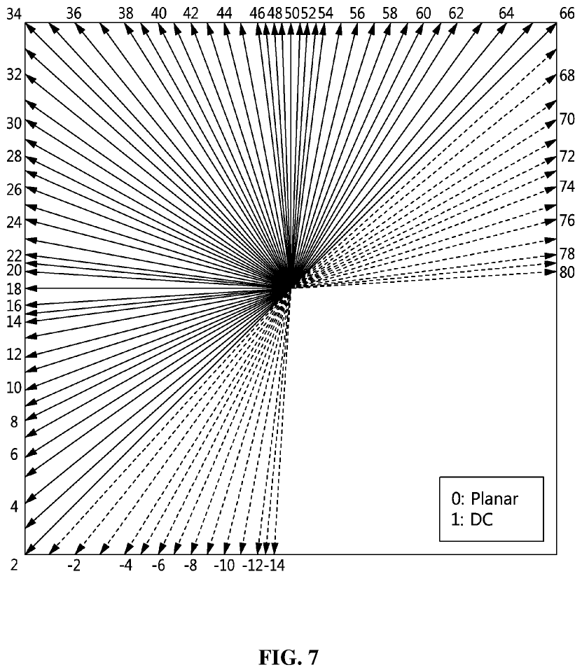

FIG. 7 is a diagram for explaining an embodiment of an intra-prediction process.

Arrows radially extending from the center of the graph in FIG. 7 indicate the prediction directions of intra-prediction modes. Further, numbers appearing near the arrows indicate examples of mode values assigned to intra-prediction modes or to the prediction directions of the intra-prediction modes.

In FIG. 7, A number θ may represent a Planar mode which is a non-directional intra prediction mode. A number 1 may represent a DC mode which is a non-directional intra prediction mode

Intra encoding and/or decoding may be performed using a reference sample of neighbor block of a target block. The neighbor block may be a reconstructed neighbor block. The reference sample may mean a neighbor sample.

For example, intra encoding and/or decoding may be performed using the value of a reference sample which are included in are reconstructed neighbor block or the coding parameters of the reconstructed neighbor block.

The encoding apparatus 100 and/or the decoding apparatus 200 may generate a prediction block by performing intra prediction on a target block based on information about samples in a target image. When intra prediction is performed, the encoding apparatus 100 and/or the decoding apparatus 200 may generate a prediction block for the target block by performing intra prediction based on information about samples in the target image. When intra prediction is performed, the encoding apparatus 100 and/or the decoding apparatus 200 may perform directional prediction and/or non-directional prediction based on at least one reconstructed reference sample.

A prediction block may be a block generated as a result of performing intra prediction. A prediction block may correspond to at least one of a CU, a PU, and a TU.

The unit of a prediction block may have a size corresponding to at least one of a CU, a PU, and a TU. The prediction block may have a square shape having a size of 2N×2N or N×N. The size of N×N may include sizes of 4×4, 8×8, 16×16, 32×32, 64×64, or the like.

Alternatively, a prediction block may a square block having a size of 2×2, 4×4, 8×8, 16×16, 32×32, 64×64 or the like or a rectangular block having a size of 2×8, 4×8, 2×16, 4×16, 8×16, or the like.

Intra prediction may be performed in consideration of the intra-prediction mode for the target block. The number of intra-prediction modes that the target block can have may be a predefined fixed value, and may be a value determined differently depending on the attributes of a prediction block. For example, the attributes of the prediction block may include the size of the prediction block, the type of prediction block, etc. Further, the attribute of a prediction block may indicate a coding parameter for the prediction block.

For example, the number of intra-prediction modes may be fixed at N regardless of the size of a prediction block. Alternatively, the number of intra-prediction modes may be, for example, 3, 5, 9, 17, 34, 35, 36, 65, 67 or 95.

The intra-prediction modes may be non-directional modes or directional modes.

For example, the intra-prediction modes may include two non-directional modes and 65 directional modes corresponding to numbers 0 to 66 illustrated in FIG. 7.

For example, the intra-prediction modes may include two non-directional modes and 93 directional modes corresponding to numbers −14 to 80 illustrated in FIG. 7 in a case that a specific intra prediction method is used.

The two non-directional modes may include a DC mode and a planar mode.

A directional mode may be a prediction mode having a specific direction or a specific angle. The directional mode may also be referred to as an “angular mode”.

An intra-prediction mode may be represented by at least one of a mode number, a mode value, a mode angle, and a mode direction. In other words, the terms “(mode) number of the intra-prediction mode”, “(mode) value of the intra-prediction mode”, “(mode) angle of the intra-prediction mode”, and “(mode) direction of the intra-prediction mode” may be used to have the same meaning, and may be used interchangeably with each other.

The number of intra-prediction modes may be M. The value of M may be 1 or more. In other words, the number of intra-prediction modes may be M, which includes the number of non-directional modes and the number of directional modes.

The number of intra-prediction modes may be fixed to M regardless of the size and/or the color component of a block. For example, the number of intra-prediction modes may be fixed at any one of 35 and 67 regardless of the size of a block.

Alternatively, the number of intra-prediction modes may differ depending on the shape, the size and/or the type of the color component of a block.

For example, in FIG. 7, directional prediction modes illustrated as dashed lines may be applied only for a prediction for a non-square block.

For example, the larger the size of the block, the greater the number of intra-prediction modes. Alternatively, the larger the size of the block, the smaller the number of intra-prediction modes. When the size of the block is 4×4 or 8×8, the number of intra-prediction modes may be 67. When the size of the block is 16×16, the number of intra-prediction modes may be 35. When the size of the block is 32×32, the number of intra-prediction modes may be 19. When the size of a block is 64×64, the number of intra-prediction modes may be 7.

For example, the number of intra prediction modes may differ depending on whether a color component is a luma signal or a chroma signal. Alternatively, the number of intra-prediction modes corresponding to a luma component block may be greater than the number of intra-prediction modes corresponding to a chroma component block.

For example, in a vertical mode having a mode value of 50, prediction may be performed in a vertical direction based on the pixel value of a reference sample. For example, in a horizontal mode having a mode value of 18, prediction may be performed in a horizontal direction based on the pixel value of a reference sample.

Even in directional modes other than the above-described mode, the encoding apparatus 100 and the decoding apparatus 200 may perform intra prediction on a target unit using reference samples depending on angles corresponding to the directional modes.

Intra-prediction modes located on a right side with respect to the vertical mode may be referred to as ‘vertical-right modes’. Intra-prediction modes located below the horizontal mode may be referred to as ‘horizontal-below modes’. For example, in FIG. 7, the intra-prediction modes in which a mode value is one of 51, 52, 53, 54, 55, 56, 57, 58, 59, 60, 61, 62, 63, 64, 65, and 66 may be vertical-right modes. Intra-prediction modes in which a mode value is one of 2, 3, 4, 5, 6, 7, 8, 9, 10, 11, 12, 13, 14, 15, 16, and 17 may be horizontal-below modes.

The non-directional mode may include a DC mode and a planar mode. For example, a value of the DC mode may be 1. A value of the planar mode may be 0.

The directional mode may include an angular mode. Among the plurality of the intra prediction modes, remaining modes except for the DC mode and the planar mode may be directional modes.

When the intra-prediction mode is a DC mode, a prediction block may be generated based on the average of pixel values of a plurality of reference pixels. For example, a value of a pixel of a prediction block may be determined based on the average of pixel values of a plurality of reference pixels.

The number of above-described intra-prediction modes and the mode values of respective intra-prediction modes are merely exemplary. The number of above-described intra-prediction modes and the mode values of respective intra-prediction modes may be defined differently depending on the embodiments, implementation and/or requirements.

In order to perform intra prediction on a target block, the step of checking whether samples included in a reconstructed neighbor block can be used as reference samples of a target block may be performed. When a sample that cannot be used as a reference sample of the target block is present among samples in the neighbor block, a value generated via copying and/or interpolation that uses at least one sample value, among the samples included in the reconstructed neighbor block, may replace the sample value of the sample that cannot be used as the reference sample. When the value generated via copying and/or interpolation replaces the sample value of the existing sample, the sample may be used as the reference sample of the target block.

When intra prediction is used, a filter may be applied to at least one of a reference sample and a prediction sample based on at least one of the intra-prediction mode and the size of the target block.

The type of filter to be applied to at least one of a reference sample and a prediction sample may differ depending on at least one of the intra-prediction mode of a target block, the size of the target block, and the shape of the target block. The types of filters may be classified depending on one or more of the length of filter tap, the value of a filter coefficient, and filter strength. The length of filter tap may mean the number of filter taps. Also, the number of filter tap may mean the length of the filter.

When the intra-prediction mode is a planar mode, a sample value of a prediction target block may be generated using a weighted sum of an above reference sample of the target block, a left reference sample of the target block, an above-right reference sample of the target block, and a below-left reference sample of the target block depending on the location of the prediction target sample in the prediction block when the prediction block of the target block is generated.

When the intra-prediction mode is a DC mode, the average of reference samples above the target block and the reference samples to the left of the target block may be used when the prediction block of the target block is generated. Also, filtering using the values of reference samples may be performed on specific rows or specific columns in the target block. The specific rows may be one or more upper rows adjacent to the reference sample. The specific columns may be one or more left columns adjacent to the reference sample.

When the intra-prediction mode is a directional mode, a prediction block may be generated using the above reference samples, left reference samples, above-right reference sample and/or below-left reference sample of the target block.

In order to generate the above-described prediction sample, real-number-based interpolation may be performed.

The intra-prediction mode of the target block may be predicted from intra prediction mode of a neighbor block adjacent to the target block, and the information used for prediction may be entropy-encoded/decoded.

For example, when the intra-prediction modes of the target block and the neighbor block are identical to each other, it may be signaled, using a predefined flag, that the intra-prediction modes of the target block and the neighbor block are identical.

For example, an indicator for indicating an intra-prediction mode identical to that of the target block, among intra-prediction modes of multiple neighbor blocks, may be signaled.

When the intra-prediction modes of the target block and a neighbor block are different from each other, information about the intra-prediction mode of the target block may be encoded and/or decoded using entropy encoding and/or decoding.

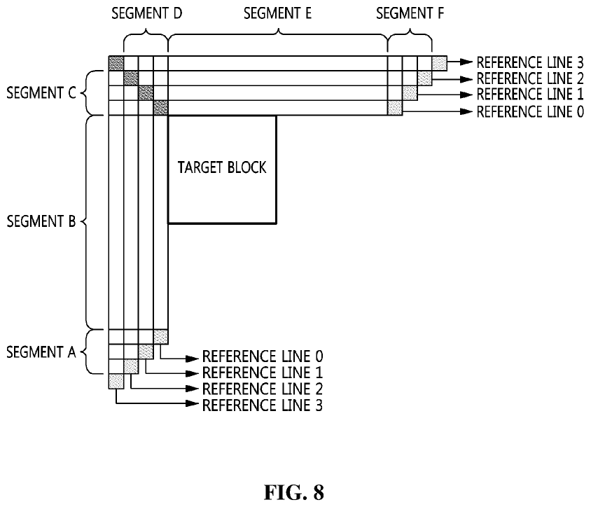

FIG. 8 is a diagram illustrating reference samples used in an intra-prediction procedure.

Reconstructed reference samples used for intra prediction of the target block may include below-left reference samples, left reference samples, an above-left corner reference sample, above reference samples, and above-right reference samples.

For example, the left reference samples may mean reconstructed reference pixels adjacent to the left side of the target block. The above reference samples may mean reconstructed reference pixels adjacent to the top of the target block. The above-left corner reference sample may mean a reconstructed reference pixel located at the above-left corner of the target block. The below-left reference samples may mean reference samples located below a left sample line composed of the left reference samples, among samples located on the same line as the left sample line. The above-right reference samples may mean reference samples located to the right of an above sample line composed of the above reference samples, among samples located on the same line as the above sample line.

When the size of a target block is N×N, the numbers of the below-left reference samples, the left reference samples, the above reference samples, and the above-right reference samples may each be N.

By performing intra prediction on the target block, a prediction block may be generated. The generation of the prediction block may include the determination of the values of pixels in the prediction block. The sizes of the target block and the prediction block may be equal.

The reference samples used for intra prediction of the target block may vary depending on the intra-prediction mode of the target block. The direction of the intra-prediction mode may represent a dependence relationship between the reference samples and the pixels of the prediction block. For example, the value of a specified reference sample may be used as the values of one or more specified pixels in the prediction block. In this case, the specified reference sample and the one or more specified pixels in the prediction block may be the sample and pixels which are positioned in a straight line in the direction of an intra-prediction mode. In other words, the value of the specified reference sample may be copied as the value of a pixel located in a direction reverse to the direction of the intra-prediction mode. Alternatively, the value of a pixel in the prediction block may be the value of a reference sample located in the direction of the intra-prediction mode with respect to the location of the pixel.

In an example, when the intra-prediction mode of a target block is a vertical mode, the above reference samples may be used for intra prediction. When the intra-prediction mode is the vertical mode, the value of a pixel in the prediction block may be the value of a reference sample vertically located above the location of the pixel. Therefore, the above reference samples adjacent to the top of the target block may be used for intra prediction. Furthermore, the values of pixels in one row of the prediction block may be identical to those of the above reference samples.

In an example, when the intra-prediction mode of a target block is a horizontal mode, the left reference samples may be used for intra prediction. When the intra-prediction mode is the horizontal mode, the value of a pixel in the prediction block may be the value of a reference sample horizontally located left to the location of the pixel. Therefore, the left reference samples adjacent to the left of the target block may be used for intra prediction. Furthermore, the values of pixels in one column of the prediction block may be identical to those of the left reference samples.

In an example, when the mode value of the intra-prediction mode of the current block is 34, at least some of the left reference samples, the above-left corner reference sample, and at least some of the above reference samples may be used for intra prediction. When the mode value of the intra-prediction mode is 34, the value of a pixel in the prediction block may be the value of a reference sample diagonally located at the above-left corner of the pixel.

Further, At least a part of the above-right reference samples may be used for intra prediction in a case that an intra prediction mode of which a mode value is a value ranging from 52 to 66.

Further, At least a part of the below-left reference samples may be used for intra prediction in a case that an intra prediction mode of which a mode value is a value ranging from 2 to 17.

Further, the above-left corner reference sample may be used for intra prediction in a case that an intra prediction mode of which a mode value is a value ranging from 19 to 49.

The number of reference samples used to determine the pixel value of one pixel in the prediction block may be either 1, or 2 or more.

As described above, the pixel value of a pixel in the prediction block may be determined depending on the location of the pixel and the location of a reference sample indicated by the direction of the intra-prediction mode. When the location of the pixel and the location of the reference sample indicated by the direction of the intra-prediction mode are integer positions, the value of one reference sample indicated by an integer position may be used to determine the pixel value of the pixel in the prediction block.

When the location of the pixel and the location of the reference sample indicated by the direction of the intra-prediction mode are not integer positions, an interpolated reference sample based on two reference samples closest to the location of the reference sample may be generated. The value of the interpolated reference sample may be used to determine the pixel value of the pixel in the prediction block. In other words, when the location of the pixel in the prediction block and the location of the reference sample indicated by the direction of the intra-prediction mode indicate the location between two reference samples, an interpolated value based on the values of the two samples may be generated.

The prediction block generated via prediction may not be identical to an original target block. In other words, there may be a prediction error which is the difference between the target block and the prediction block, and there may also be a prediction error between the pixel of the target block and the pixel of the prediction block.

Hereinafter, the terms “difference”, “error”, and “residual” may be used to have the same meaning, and may be used interchangeably with each other.

For example, in the case of directional intra prediction, the longer the distance between the pixel of the prediction block and the reference sample, the greater the prediction error that may occur. Such a prediction error may result in discontinuity between the generated prediction block and neighbor blocks.

In order to reduce the prediction error, filtering for the prediction block may be used. Filtering may be configured to adaptively apply a filter to an area, regarded as having a large prediction error, in the prediction block. For example, the area regarded as having a large prediction error may be the boundary of the prediction block. Further, an area regarded as having a large prediction error in the prediction block may differ depending on the intra-prediction mode, and the characteristics of filters may also differ depending thereon.

As illustrated in FIG. 8, for intra prediction of a target block, at least one of reference line 0 to reference line 3 may be used.

Each reference line in FIG. 8 may indicate a reference sample line comprising one or more reference samples. As the number of the reference line is lower, a line of reference samples closer to a target block may be indicated.

Samples in segment A and segment F may be acquired through padding that uses samples closest to the target block in segment B and segment E instead of being acquired from reconstructed neighbor blocks.

Index information indicating a reference sample line to be used for intra-prediction of the target block may be signaled. The index information may indicate a reference sample line to be used for intra-prediction of the target block, among multiple reference sample lines. For example, the index information may have a value corresponding to any one of 0 to 3.

When the top boundary of the target block is the boundary of a CTU, only reference sample line θ may be available. Therefore, in this case, index information may not be signaled. When an additional reference sample line other than reference sample line 0 is used, filtering of a prediction block, which will be described later, may not be performed.

In the case of inter-color intra prediction, a prediction block for a target block of a second color component may be generated based on the corresponding reconstructed block of a first color component.

For example, the first color component may be a luma component, and the second color component may be a chroma component.

In order to perform inter-color intra prediction, parameters for a linear model between the first color component and the second color component may be derived based on a template.

The template may include reference samples above the target block (above reference samples) and/or reference samples to the left of the target block (left reference samples), and may include above reference samples and/or left reference samples of a reconstructed block of the first color component, which correspond to the reference samples.

For example, parameters for a linear model may be derived using 1) the value of the sample of a first color component having the maximum value, among the samples in the template, 2) the value of the sample of a second color component corresponding to the sample of the first color component, 3) the value of the sample of a first color component having the minimum value, among the samples in the template, and 4) the value of the sample of a second color component corresponding to the sample of the first color component.

When the parameters for the linear model are derived, a prediction block for the target block may be generated by applying the corresponding reconstructed block to the linear model.

Depending on the image format, sub-sampling may be performed on samples adjacent to the reconstructed block of the first color component and the corresponding reconstructed block of the first color component. For example, when one sample of the second color component corresponds to four samples of the first color component, one corresponding sample may be calculated by performing sub-sampling on the four samples of the first color component. When sub-sampling is performed, derivation of the parameters for the linear model and inter-color intra prediction may be performed based on the sub-sampled corresponding sample.

Information about whether inter-color intra prediction is performed and/or the range of the template may be signaled in an intra-prediction mode.

The target block may be partitioned into two or four sub-blocks in a horizontal direction and/or a vertical direction.

The sub-blocks resulting from the partitioning may be sequentially reconstructed. That is, as intra-prediction is performed on each sub-block, a sub-prediction block for the sub-block may be generated. Also, as dequantization (inverse quantization) and/or an inverse transform are performed on each sub-block, a sub-residual block for the corresponding sub-block may be generated. A reconstructed sub-block may be generated by adding the sub-prediction block to the sub-residual block. The reconstructed sub-block may be used as a reference sample for intra prediction of the sub-block having the next priority.

A sub-block may be a block including a specific number (e.g., 16) of samples or more. For example, when the target block is an 8×4 block or a 4×8 block, the target block may be partitioned into two sub-blocks. Also, when the target block is a 4×4 block, the target block cannot be partitioned into sub-blocks. When the target block has another size, the target block may be partitioned into four sub-blocks.

Information about whether intra prediction based on such sub-blocks is performed and/or information about a partition direction (horizontal direction or vertical direction) may be signaled.

Such sub-block-based intra prediction may be limited such that it is performed only when reference sample line 0 is used. When sub-block-based intra-prediction is performed, filtering of a prediction block, which will be described below, may not be performed.

A final prediction block may be generated by performing filtering on the prediction block generated via intra prediction.

Filtering may be performed by applying specific weights to a filtering target sample, which is the target to be filtered, a left reference sample, an above reference sample, and/or an above-left reference sample.

The weights and/or reference samples (e.g., the range of reference samples, the locations of the reference samples, etc.) used for filtering may be determined based on at least one of a block size, an intra-prediction mode, and the location of the filtering target sample in a prediction block.

For example, filtering may be performed only in a specific intra-prediction mode (e.g., DC mode, planar mode, vertical mode, horizontal mode, diagonal mode and/or adjacent diagonal mode).

The adjacent diagonal mode may be a mode having a number obtained by adding k to the number of the diagonal mode, and may be a mode having a number obtained by subtracting k from the number of the diagonal mode. In other words, the number of the adjacent diagonal mode may be the sum of the number of the diagonal mode and k, or may be the difference between the number of the diagonal mode and k. For example, k may be a positive integer of 8 or less.

The intra-prediction mode of the target block may be derived using the intra-prediction mode of a neighbor block adjacent to the target block, and such a derived intra-prediction mode may be entropy-encoded and/or entropy-decoded.

For example, when the intra-prediction mode of the target block is identical to the intra-prediction mode of the neighbor block, information indicating that the intra-prediction mode of the target block is identical to the intra-prediction mode of the neighbor block may be signaled using specific flag information.

Further, for example, indicator information for a neighbor block having an intra-prediction mode identical to the intra-prediction mode of the target block, among intra-prediction modes of multiple neighbor blocks, may be signaled.

For example, when the intra-prediction mode of the target block is different from the intra-prediction mode of the neighbor block, entropy encoding and/or entropy decoding may be performed on information about the intra-prediction mode of the target block by performing entropy encoding and/or entropy decoding based on the intra-prediction mode of the neighbor block.

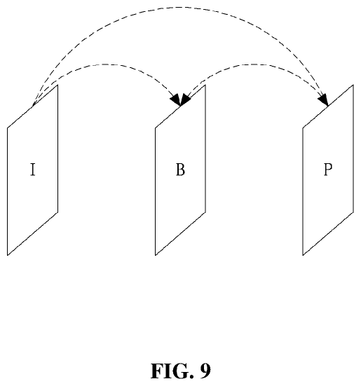

FIG. 9 is a diagram for explaining an embodiment of an inter prediction procedure.

The rectangles shown in FIG. 9 may represent images (or pictures). Further, in FIG. 9, arrows may represent prediction directions. An arrow pointing from a first picture to a second picture means that the second picture refers to the first picture. That is, each image may be encoded and/or decoded depending on the prediction direction.

Images may be classified into an Intra Picture (I picture), a Uni-prediction Picture or Predictive Coded Picture (P picture), and a Bi-prediction Picture or Bi-predictive Coded Picture (B picture) depending on the encoding type. Each picture may be encoded and/or decoded depending on the encoding type thereof.

When a target image that is the target to be encoded is an I picture, the target image may be encoded using data contained in the image itself without inter prediction that refers to other images. For example, an I picture may be encoded only via intra prediction.

When a target image is a P picture, the target image may be encoded via inter prediction, which uses reference pictures existing in one direction. Here, the one direction may be a forward direction or a backward direction.

When a target image is a B picture, the image may be encoded via inter prediction that uses reference pictures existing in two directions, or may be encoded via inter prediction that uses reference pictures existing in one of a forward direction and a backward direction. Here, the two directions may be the forward direction and the backward direction.

A P picture and a B picture that are encoded and/or decoded using reference pictures may be regarded as images in which inter prediction is used.

Below, inter prediction in an inter mode according to an embodiment will be described in detail.

Inter prediction or a motion compensation may be performed using a reference image and motion information.

In an inter mode, the encoding apparatus 100 may perform inter prediction and/or motion compensation on a target block. The decoding apparatus 200 may perform inter prediction and/or motion compensation, corresponding to inter prediction and/or motion compensation performed by the encoding apparatus 100, on a target block.

Motion information of the target block may be individually derived by the encoding apparatus 100 and the decoding apparatus 200 during the inter prediction. The motion information may be derived using motion information of a reconstructed neighbor block, motion information of a col block, and/or motion information of a block adjacent to the col block.

For example, the encoding apparatus 100 or the decoding apparatus 200 may perform prediction and/or motion compensation by using motion information of a spatial candidate and/or a temporal candidate as motion information of the target block. The target block may mean a PU and/or a PU partition.

A spatial candidate may be a reconstructed block which is spatially adjacent to the target block.

A temporal candidate may be a reconstructed block corresponding to the target block in a previously reconstructed co-located picture (col picture).

In inter prediction, the encoding apparatus 100 and the decoding apparatus 200 may improve encoding efficiency and decoding efficiency by utilizing the motion information of a spatial candidate and/or a temporal candidate. The motion information of a spatial candidate may be referred to as ‘spatial motion information’. The motion information of a temporal candidate may be referred to as ‘temporal motion information’.

Below, the motion information of a spatial candidate may be the motion information of a PU including the spatial candidate. The motion information of a temporal candidate may be the motion information of a PU including the temporal candidate. The motion information of a candidate block may be the motion information of a PU including the candidate block.

Inter prediction may be performed using a reference picture.

The reference picture may be at least one of a picture previous to a target picture and a picture subsequent to the target picture. The reference picture may be an image used for the prediction of the target block.

In inter prediction, a region in the reference picture may be specified by utilizing a reference picture index (or refIdx) for indicating a reference picture, a motion vector, which will be described later, etc. Here, the region specified in the reference picture may indicate a reference block.

Inter prediction may select a reference picture, and may also select a reference block corresponding to the target block from the reference picture. Further, inter prediction may generate a prediction block for the target block using the selected reference block.

The motion information may be derived during inter prediction by each of the encoding apparatus 100 and the decoding apparatus 200.

A spatial candidate may be a block 1) which is present in a target picture, 2) which has been previously reconstructed via encoding and/or decoding, and 3) which is adjacent to the target block or is located at the corner of the target block. Here, the “block located at the corner of the target block” may be either a block vertically adjacent to a neighbor block that is horizontally adjacent to the target block, or a block horizontally adjacent to a neighbor block that is vertically adjacent to the target block. Further, “block located at the corner of the target block” may have the same meaning as “block adjacent to the corner of the target block”. The meaning of “block located at the corner of the target block” may be included in the meaning of “block adjacent to the target block”.

For example, a spatial candidate may be a reconstructed block located to the left of the target block, a reconstructed block located above the target block, a reconstructed block located at the below-left corner of the target block, a reconstructed block located at the above-right corner of the target block, or a reconstructed block located at the above-left corner of the target block.

Each of the encoding apparatus 100 and the decoding apparatus 200 may identify a block present at the location spatially corresponding to the target block in a col picture. The location of the target block in the target picture and the location of the identified block in the col picture may correspond to each other.

Each of the encoding apparatus 100 and the decoding apparatus 200 may determine a col block present at the predefined relative location for the identified block to be a temporal candidate. The predefined relative location may be a location present inside and/or outside the identified block.

For example, the col block may include a first col block and a second col block. When the coordinates of the identified block are (xP, yP) and the size of the identified block is represented by (nPSW, nPSH), the first col block may be a block located at coordinates (xP+nPSW, yP+nPSH). The second col block may be a block located at coordinates (xP+(nPSW>>1), yP+(nPSH>>1)). The second col block may be selectively used when the first col block is unavailable.

The motion vector of the target block may be determined based on the motion vector of the col block. Each of the encoding apparatus 100 and the decoding apparatus 200 may scale the motion vector of the col block. The scaled motion vector of the col block may be used as the motion vector of the target block. Further, a motion vector for the motion information of a temporal candidate stored in a list may be a scaled motion vector.

The ratio of the motion vector of the target block to the motion vector of the col block may be identical to the ratio of a first temporal distance to a second temporal distance. The first temporal distance may be the distance between the reference picture and the target picture of the target block. The second temporal distance may be the distance between the reference picture and the col picture of the col block.

The scheme for deriving motion information may change depending on the inter-prediction mode of a target block. For example, as inter-prediction modes applied for inter prediction, an Advanced Motion Vector Predictor (AMVP) mode, a merge mode, a skip mode, a merge mode with a motion vector difference, a sub block merge mode, a triangle partition mode, an inter-intra combined prediction mode, an affine inter mode, a current picture reference mode, etc. may be present. The merge mode may also be referred to as a “motion merge mode”. Individual modes will be described in detail below.

### 1) AMVP Mode

When an AMVP mode is used, the encoding apparatus 100 may search a neighbor region of a target block for a similar block. The encoding apparatus 100 may acquire a prediction block by performing prediction on the target block using motion information of the found similar block. The encoding apparatus 100 may encode a residual block, which is the difference between the target block and the prediction block.

### 1-1) Creation of List of Prediction Motion Vector Candidates

When an AMVP mode is used as the prediction mode, each of the encoding apparatus 100 and the decoding apparatus 200 may create a list of prediction motion vector candidates using the motion vector of a spatial candidate, the motion vector of a temporal candidate, and a zero vector. The prediction motion vector candidate list may include one or more prediction motion vector candidates. At least one of the motion vector of a spatial candidate, the motion vector of a temporal candidate, and a zero vector may be determined and used as a prediction motion vector candidate.

Hereinafter, the terms “prediction motion vector (candidate)” and “motion vector (candidate)” may be used to have the same meaning, and may be used interchangeably with each other.

Hereinafter, the terms “prediction motion vector candidate” and “AMVP candidate” may be used to have the same meaning, and may be used interchangeably with each other.

Hereinafter, the terms “prediction motion vector candidate list” and “AMVP candidate list” may be used to have the same meaning, and may be used interchangeably with each other.

Spatial candidates may include a reconstructed spatial neighbor block. In other words, the motion vector of the reconstructed neighbor block may be referred to as a “spatial prediction motion vector candidate”.

Temporal candidates may include a col block and a block adjacent to the col block. In other words, the motion vector of the col block or the motion vector of the block adjacent to the col block may be referred to as a “temporal prediction motion vector candidate”.

The zero vector may be a (0, 0) motion vector.

The prediction motion vector candidates may be motion vector predictors for predicting a motion vector. Also, in the encoding apparatus 100, each prediction motion vector candidate may be an initial search location for a motion vector.

1-2) Search for Motion Vectors that Use List of Prediction Motion Vector Candidates

The encoding apparatus 100 may determine the motion vector to be used to encode a target block within a search range using a list of prediction motion vector candidates. Further, the encoding apparatus 100 may determine a prediction motion vector candidate to be used as the prediction motion vector of the target block, among prediction motion vector candidates present in the prediction motion vector candidate list.

The motion vector to be used to encode the target block may be a motion vector that can be encoded at minimum cost.

Further, the encoding apparatus 100 may determine whether to use the AMVP mode to encode the target block.

### 1-3) Transmission of Inter-Prediction Information

The encoding apparatus 100 may generate a bitstream including inter-prediction information required for inter prediction. The decoding apparatus 200 may perform inter prediction on the target block using the inter-prediction information of the bitstream.

The inter-prediction information may contain 1) mode information indicating whether an AMVP mode is used, 2) a prediction motion vector index, 3) a Motion Vector Difference (MVD), 4) a reference direction, and 5) a reference picture index.

Hereinafter, the terms “prediction motion vector index” and “AMVP index” may be used to have the same meaning, and may be used interchangeably with each other.

Further, the inter-prediction information may contain a residual signal.

The decoding apparatus 200 may acquire a prediction motion vector index, an MVD, a reference direction, and a reference picture index from the bitstream through entropy decoding when mode information indicates that the AMVP mode is used.

The prediction motion vector index may indicate a prediction motion vector candidate to be used for the prediction of a target block, among prediction motion vector candidates included in the prediction motion vector candidate list.

1-4) Inter Prediction in AMVP Mode that Uses Inter-Prediction Information

The decoding apparatus 200 may derive prediction motion vector candidates using a prediction motion vector candidate list, and may determine the motion information of a target block based on the derived prediction motion vector candidates.

The decoding apparatus 200 may determine a motion vector candidate for the target block, among the prediction motion vector candidates included in the prediction motion vector candidate list, using a prediction motion vector index. The decoding apparatus 200 may select a prediction motion vector candidate, indicated by the prediction motion vector index, from among prediction motion vector candidates included in the prediction motion vector candidate list, as the prediction motion vector of the target block.

The encoding apparatus 100 may generate an entropy-encoded prediction motion vector index by applying entropy encoding to a prediction motion vector index, and may generate a bitstream including the entropy-encoded prediction motion vector index. The entropy-encoded prediction motion vector index may be signaled from the encoding apparatus 100 to the decoding apparatus 200 through a bitstream. The decoding apparatus 200 may extract the entropy-encoded prediction motion vector index from the bitstream, and may acquire the prediction motion vector index by applying entropy decoding to the entropy-encoded prediction motion vector index.

The motion vector to be actually used for inter prediction of the target block may not match the prediction motion vector. In order to indicate the difference between the motion vector to be actually used for inter prediction of the target block and the prediction motion vector, an MVD may be used. The encoding apparatus 100 may derive a prediction motion vector similar to the motion vector to be actually used for inter prediction of the target block so as to use an MVD that is as small as possible.

A Motion Vector Difference (MVD) may be the difference between the motion vector of the target block and the prediction motion vector. The encoding apparatus 100 may calculate the MVD, and may generate an entropy-encoded MVD by applying entropy encoding to the MVD. The encoding apparatus 100 may generate a bitstream including the entropy-encoded MVD.

The MVD may be transmitted from the encoding apparatus 100 to the decoding apparatus 200 through the bitstream. The decoding apparatus 200 may extract the entropy-encoded MVD from the bitstream, and may acquire the MVD by applying entropy decoding to the entropy-encoded MVD.

The decoding apparatus 200 may derive the motion vector of the target block by summing the MVD and the prediction motion vector. In other words, the motion vector of the target block derived by the decoding apparatus 200 may be the sum of the MVD and the motion vector candidate.

Also, the encoding apparatus 100 may generate entropy-encoded MVD resolution information by applying entropy encoding to calculated MVD resolution information, and may generate a bitstream including the entropy-encoded MVD resolution information. The decoding apparatus 200 may extract the entropy-encoded MVD resolution information from the bitstream, and may acquire MVD resolution information by applying entropy decoding to the entropy-encoded MVD resolution information. The decoding apparatus 200 may adjust the resolution of the MVD using the MVD resolution information.

Meanwhile, the encoding apparatus 100 may calculate an MVD based on an affine model. The decoding apparatus 200 may derive the affine control motion vector of the target block through the sum of the MVD and an affine control motion vector candidate, and may derive the motion vector of a sub-block using the affine control motion vector.

The reference direction may indicate a list of reference pictures to be used for prediction of the target block. For example, the reference direction may indicate one of a reference picture list L0 and a reference picture list L1.

The reference direction merely indicates the reference picture list to be used for prediction of the target block, and may not mean that the directions of reference pictures are limited to a forward direction or a backward direction. In other words, each of the reference picture list L0 and the reference picture list L1 may include pictures in a forward direction and/or a backward direction.

That the reference direction is unidirectional may mean that a single reference picture list is used. That the reference direction is bidirectional may mean that two reference picture lists are used. In other words, the reference direction may indicate one of the case where only the reference picture list L0 is used, the case where only the reference picture list L1 is used, and the case where two reference picture lists are used.

The reference picture index may indicate a reference picture that is used for prediction of the target block, among reference pictures present in a reference picture list. The encoding apparatus 100 may generate an entropy-encoded reference picture index by applying entropy encoding to the reference picture index, and may generate a bitstream including the entropy-encoded reference picture index. The entropy-encoded reference picture index may be signaled from the encoding apparatus 100 to the decoding apparatus 200 through the bitstream. The decoding apparatus 200 may extract the entropy-encoded reference picture index from the bitstream, and may acquire the reference picture index by applying entropy decoding to the entropy-encoded reference picture index.

When two reference picture lists are used to predict the target block, a single reference picture index and a single motion vector may be used for each of the reference picture lists. Further, when two reference picture lists are used to predict the target block, two prediction blocks may be specified for the target block. For example, the (final) prediction block of the target block may be generated using the average or weighted sum of the two prediction blocks for the target block.

The motion vector of the target block may be derived by the prediction motion vector index, the MVD, the reference direction, and the reference picture index.

The decoding apparatus 200 may generate a prediction block for the target block based on the derived motion vector and the reference picture index. For example, the prediction block may be a reference block, indicated by the derived motion vector, in the reference picture indicated by the reference picture index.

Since the prediction motion vector index and the MVD are encoded without the motion vector itself of the target block being encoded, the number of bits transmitted from the encoding apparatus 100 to the decoding apparatus 200 may be decreased, and encoding efficiency may be improved.

For the target block, the motion information of reconstructed neighbor blocks may be used. In a specific inter-prediction mode, the encoding apparatus 100 may not separately encode the actual motion information of the target block. The motion information of the target block is not encoded, and additional information that enables the motion information of the target block to be derived using the motion information of reconstructed neighbor blocks may be encoded instead. As the additional information is encoded, the number of bits transmitted to the decoding apparatus 200 may be decreased, and encoding efficiency may be improved.

For example, as inter-prediction modes in which the motion information of the target block is not directly encoded, there may be a skip mode and/or a merge mode. Here, each of the encoding apparatus 100 and the decoding apparatus 200 may use an identifier and/or an index that indicates a unit, the motion information of which is to be used as the motion information of the target unit, among reconstructed neighbor units.

### 2) Merge Mode

As a scheme for deriving the motion information of a target block, there is merging. The term “merging” may mean the merging of the motion of multiple blocks. “Merging” may mean that the motion information of one block is also applied to other blocks. In other words, a merge mode may be a mode in which the motion information of the target block is derived from the motion information of a neighbor block.

When a merge mode is used, the encoding apparatus 100 may predict the motion information of a target block using the motion information of a spatial candidate and/or the motion information of a temporal candidate. The spatial candidate may include a reconstructed spatial neighbor block that is spatially adjacent to the target block. The spatial neighbor block may include a left neighbor block and an above neighbor block. The temporal candidate may include a col block. The terms “spatial candidate” and “spatial merge candidate” may be used to have the same meaning, and may be used interchangeably with each other. The terms “temporal candidate” and “temporal merge candidate” may be used to have the same meaning, and may be used interchangeably with each other.

The encoding apparatus 100 may acquire a prediction block via prediction. The encoding apparatus 100 may encode a residual block, which is the difference between the target block and the prediction block.

### 2-1) Creation of Merge Candidate List

When the merge mode is used, each of the encoding apparatus 100 and the decoding apparatus 200 may create a merge candidate list using the motion information of a spatial candidate and/or the motion information of a temporal candidate. The motion information may include 1) a motion vector, 2) a reference picture index, and 3) a reference direction. The reference direction may be unidirectional or bidirectional. The reference direction may mean a inter prediction indicator.

The merge candidate list may include merge candidates. The merge candidates may be motion information. In other words, the merge candidate list may be a list in which pieces of motion information are stored.

The merge candidates may be pieces of motion information of temporal candidates and/or spatial candidates. In other words, the merge candidates list may comprise motion information of a temporal candidates and/or spatial candidates, etc.

Further, the merge candidate list may include new merge candidates generated by a combination of merge candidates that are already present in the merge candidate list. In other words, the merge candidate list may include new motion information generated by a combination of pieces of motion information previously present in the merge candidate list.

Also, a merge candidate list may include history-based merge candidates. The history-based merge candidates may be the motion information of a block which is encoded and/or decoded prior to a target block.

Also, a merge candidate list may include a merge candidate based on an average of two merge candidates.

The merge candidates may be specific modes deriving inter prediction information. The merge candidate may be information indicating a specific mode deriving inter prediction information. Inter prediction information of a target block may be derived according to a specific mode which the merge candidate indicates. Furthermore, the specific mode may include a process of deriving a series of inter prediction information. This specific mode may be an inter prediction information derivation mode or a motion information derivation mode.

The inter prediction information of the target block may be derived according to the mode indicated by the merge candidate selected by the merge index among the merge candidates in the merge candidate list.

For example, the motion information derivation modes in the merge candidate list may be at least one of 1) motion information derivation mode for a sub-block unit and 2) an affine motion information derivation mode.

Furthermore, the merge candidate list may include motion information of a zero vector. The zero vector may also be referred to as a “zero-merge candidate”.

In other words, pieces of motion information in the merge candidate list may be at least one of 1) motion information of a spatial candidate, 2) motion information of a temporal candidate, 3) motion information generated by a combination of pieces of motion information previously present in the merge candidate list, and 4) a zero vector.

Motion information may include 1) a motion vector, 2) a reference picture index, and 3) a reference direction. The reference direction may also be referred to as an “inter-prediction indicator”. The reference direction may be unidirectional or bidirectional. The unidirectional reference direction may indicate L0 prediction or L1 prediction.

The merge candidate list may be created before prediction in the merge mode is performed.

The number of merge candidates in the merge candidate list may be predefined. Each of the encoding apparatus 100 and the decoding apparatus 200 may add merge candidates to the merge candidate list depending on the predefined scheme and predefined priorities so that the merge candidate list has a predefined number of merge candidates. The merge candidate list of the encoding apparatus 100 and the merge candidate list of the decoding apparatus 200 may be made identical to each other using the predefined scheme and the predefined priorities.

Merging may be applied on a CU basis or a PU basis. When merging is performed on a CU basis or a PU basis, the encoding apparatus 100 may transmit a bitstream including predefined information to the decoding apparatus 200. For example, the predefined information may contain 1) information indicating whether to perform merging for individual block partitions, and 2) information about a block with which merging is to be performed, among blocks that are spatial candidates and/or temporal candidates for the target block.

2-2) Search for Motion Vector that Uses Merge Candidate List

The encoding apparatus 100 may determine merge candidates to be used to encode a target block. For example, the encoding apparatus 100 may perform prediction on the target block using merge candidates in the merge candidate list, and may generate residual blocks for the merge candidates. The encoding apparatus 100 may use a merge candidate that incurs the minimum cost in prediction and in the encoding of residual blocks to encode the target block.

Further, the encoding apparatus 100 may determine whether to use a merge mode to encode the target block.

2-3) Transmission of inter-prediction information

The encoding apparatus 100 may generate a bitstream that includes inter-prediction information required for inter prediction. The encoding apparatus 100 may generate entropy-encoded inter-prediction information by performing entropy encoding on inter-prediction information, and may transmit a bitstream including the entropy-encoded inter-prediction information to the decoding apparatus 200. Through the bitstream, the entropy-encoded inter-prediction information may be signaled to the decoding apparatus 200 by the encoding apparatus 100. The decoding apparatus 200 may extract entropy-encoded inter-prediction information from the bitstream, and may acquire inter-prediction information by applying entropy decoding to the entropy-encoded inter-prediction information.

The decoding apparatus 200 may perform inter prediction on the target block using the inter-prediction information of the bitstream.

The inter-prediction information may contain 1) mode information indicating whether a merge mode is used, 2) a merge index and 3) correction information.

Further, the inter-prediction information may contain a residual signal.

The decoding apparatus 200 may acquire the merge index from the bitstream only when the mode information indicates that the merge mode is used.

The mode information may be a merge flag. The unit of the mode information may be a block. Information about the block may include mode information, and the mode information may indicate whether a merge mode is applied to the block.

The merge index may indicate a merge candidate to be used for the prediction of the target block, among merge candidates included in the merge candidate list.

Alternatively, the merge index may indicate a block with which the target block is to be merged, among neighbor blocks spatially or temporally adjacent to the target block.

The encoding apparatus 100 may select a merge candidate having the highest encoding performance among the merge candidates included in the merge candidate list and set a value of the merge index to indicate the selected merge candidate.

Correction information may be information used to correct a motion vector. The encoding apparatus 100 may generate correction information. The decoding apparatus 200 may correct the motion vector of a merge candidate selected by a merge index based on the correction information.

The correction information may include at least one of information indicating whether correction is to be performed, correction direction information, and correction size information. A prediction mode in which the motion vector is corrected based on the signaled correction information may be referred to as a “merge mode having a motion vector difference”.

2-4) Inter Prediction of Merge Mode that Uses Inter-Prediction Information

The decoding apparatus 200 may perform prediction on the target block using the merge candidate indicated by the merge index, among merge candidates included in the merge candidate list.

The motion vector of the target block may be specified by the motion vector, reference picture index, and reference direction of the merge candidate indicated by the merge index.

### 3) Skip Mode

A skip mode may be a mode in which the motion information of a spatial candidate or the motion information of a temporal candidate is applied to the target block without change. Also, the skip mode may be a mode in which a residual signal is not used. In other words, when the skip mode is used, a reconstructed block may be the same as a prediction block.

The difference between the merge mode and the skip mode lies in whether or not a residual signal is transmitted or used. That is, the skip mode may be similar to the merge mode except that a residual signal is not transmitted or used.

When the skip mode is used, the encoding apparatus 100 may transmit information about a block, the motion information of which is to be used as the motion information of the target block, among blocks that are spatial candidates or temporal candidates, to the decoding apparatus 200 through a bitstream. The encoding apparatus 100 may generate entropy-encoded information by performing entropy encoding on the information, and may signal the entropy-encoded information to the decoding apparatus 200 through a bitstream. The decoding apparatus 200 may extract entropy-encoded information from the bitstream, and may acquire information by applying entropy decoding to the entropy-encoded information.

Further, when the skip mode is used, the encoding apparatus 100 may not transmit other syntax information, such as an MVD, to the decoding apparatus 200. For example, when the skip mode is used, the encoding apparatus 100 may not signal a syntax element related to at least one of an MVD, a coded block flag, and a transform coefficient level to the decoding apparatus 200.

### 3-1) Creation of Merge Candidate List

The skip mode may also use a merge candidate list. In other words, a merge candidate list may be used both in the merge mode and in the skip mode. In this aspect, the merge candidate list may also be referred to as a “skip candidate list” or a “merge/skip candidate list”.

Alternatively, the skip mode may use an additional candidate list different from that of the merge mode. In this case, in the following description, a merge candidate list and a merge candidate may be replaced with a skip candidate list and a skip candidate, respectively.

The merge candidate list may be created before prediction in the skip mode is performed.

3-2) Search for Motion Vector that Uses Merge Candidate List

The encoding apparatus 100 may determine the merge candidates to be used to encode a target block. For example, the encoding apparatus 100 may perform prediction on the target block using the merge candidates in a merge candidate list. The encoding apparatus 100 may use a merge candidate that incurs the minimum cost in prediction to encode the target block.

Further, the encoding apparatus 100 may determine whether to use a skip mode to encode the target block.

### 3-3) Transmission of Inter-Prediction Information

The encoding apparatus 100 may generate a bitstream that includes inter-prediction information required for inter prediction. The decoding apparatus 200 may perform inter prediction on the target block using the inter-prediction information of the bitstream.

The inter-prediction information may include 1) mode information indicating whether a skip mode is used, and 2) a skip index.

The skip index may be identical to the above-described merge index.

When the skip mode is used, the target block may be encoded without using a residual signal. The inter-prediction information may not contain a residual signal. Alternatively, the bitstream may not include a residual signal.

The decoding apparatus 200 may acquire a skip index from the bitstream only when the mode information indicates that the skip mode is used. As described above, a merge index and a skip index may be identical to each other. The decoding apparatus 200 may acquire the skip index from the bitstream only when the mode information indicates that the merge mode or the skip mode is used.

The skip index may indicate the merge candidate to be used for the prediction of the target block, among the merge candidates included in the merge candidate list.

3-4) Inter Prediction in Skip Mode that Uses Inter-Prediction Information

The decoding apparatus 200 may perform prediction on the target block using a merge candidate indicated by a skip index, among the merge candidates included in a merge candidate list.

The motion vector of the target block may be specified by the motion vector, reference picture index, and reference direction of the merge candidate indicated by the skip index.

### 4) Current Picture Reference Mode

The current picture reference mode may denote a prediction mode that uses a previously reconstructed region in a target picture to which a target block belongs.

A motion vector for specifying the previously reconstructed region may be used. Whether the target block has been encoded in the current picture reference mode may be determined using the reference picture index of the target block.

A flag or index indicating whether the target block is a block encoded in the current picture reference mode may be signaled by the encoding apparatus 100 to the decoding apparatus 200. Alternatively, whether the target block is a block encoded in the current picture reference mode may be inferred through the reference picture index of the target block.

When the target block is encoded in the current picture reference mode, the target picture may exist at a fixed location or an arbitrary location in a reference picture list for the target block.

For example, the fixed location may be either a location where a value of the reference picture index is 0 or the last location.

When the target picture exists at an arbitrary location in the reference picture list, an additional reference picture index indicating such an arbitrary location may be signaled by the encoding apparatus 100 to the decoding apparatus 200.

### 5) Sub-Block Merge Mode

A sub-block merge mode may be a mode in which motion information is derived from the sub-block of a CU.

When the sub-block merge mode is applied, a sub-block merge candidate list may be generated using the motion information of a co-located sub-block (col-sub-block) of a target sub-block (i.e., a sub-block-based temporal merge candidate) in a reference image and/or an affine control point motion vector merge candidate.

### 6) Triangle Partition Mode

In a triangle partition mode, a target block may be partitioned in a diagonal direction, and sub-target blocks resulting from partitioning may be generated. For each sub-target block, motion information of the corresponding sub-target block may be derived, and a prediction sample for each sub-target block may be derived using the derived motion information. A prediction sample for the target block may be derived through a weighted sum of the prediction samples for the sub-target blocks resulting from the partitioning.

### 7) Combination Inter-Intra Prediction Mode

The combination inter-intra prediction mode may be a mode in which a prediction sample for a target block is derived using a weighted sum of a prediction sample generated via inter-prediction and a prediction sample generated via intra-prediction.

In the above-described modes, the decoding apparatus 200 may autonomously correct derived motion information. For example, the decoding apparatus 200 may search a specific area for motion information having the minimum sum of Absolute Differences (SAD) based on a reference block indicated by the derived motion information, and may derive the found motion information as corrected motion information.

In the above-described modes, the decoding apparatus 200 may compensate for the prediction sample derived via inter prediction using an optical flow.

In the above-described AMVP mode, merge mode, skip mode, etc., motion information to be used for prediction of the target block may be specified among pieces of motion information in a list using the index information of the list.

In order to improve encoding efficiency, the encoding apparatus 100 may signal only the index of an element that incurs the minimum cost in inter prediction of the target block, among elements in the list. The encoding apparatus 100 may encode the index, and may signal the encoded index.

Therefore, the above-described lists (i.e. the prediction motion vector candidate list and the merge candidate list) must be able to be derived by the encoding apparatus 100 and the decoding apparatus 200 using the same scheme based on the same data. Here, the same data may include a reconstructed picture and a reconstructed block.

Further, in order to specify an element using an index, the order of the elements in the list must be fixed.

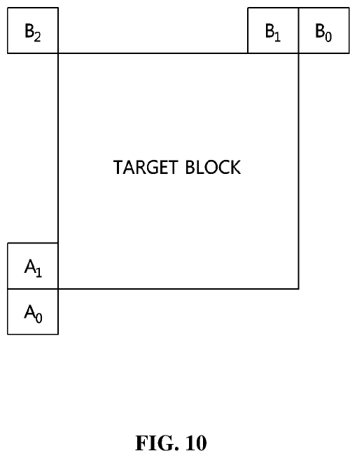

FIG. 10 illustrates spatial candidates according to an embodiment.

In FIG. 10, the locations of spatial candidates are illustrated.

The large block in the center of the drawing may denote a target block. Five small blocks may denote spatial candidates.

The coordinates of the target block may be (xP, yP), and the size of the target block may be represented by (nPSW, nPSH).

Spatial candidate A₀ may be a block adjacent to the below-left corner of the target block. A₀ may be a block that occupies pixels located at coordinates (xP−1, yP+nPSH).

Spatial candidate A₁ may be a block adjacent to the left of the target block. A₁ may be a lowermost block, among blocks adjacent to the left of the target block.

Alternatively, A₁ may be a block adjacent to the top of A₀. A₁ may be a block that occupies pixels located at coordinates (xP−1, yP+nPSH−1).

Spatial candidate B₀ may be a block adjacent to the above-right corner of the target block. B₀ may be a block that occupies pixels located at coordinates (xP+nPSW, yP−1).

Spatial candidate B₁ may be a block adjacent to the top of the target block. B₁ may be a rightmost block, among blocks adjacent to the top of the target block.

Alternatively, B₁ may be a block adjacent to the left of B₀. B₁ may be a block that occupies pixels located at coordinates (xP+nPSW−1, yP−1).

Spatial candidate B₂ may be a block adjacent to the above-left corner of the target block. B₂ may be a block that occupies pixels located at coordinates (xP−1, yP−1).

### Determination of Availability of Spatial Candidate and Temporal Candidate

In order to include the motion information of a spatial candidate or the motion information of a temporal candidate in a list, it must be determined whether the motion information of the spatial candidate or the motion information of the temporal candidate is available.

Hereinafter, a candidate block may include a spatial candidate and a temporal candidate.

For example, the determination may be performed by sequentially applying the following steps 1) to 4).
Step 1) When a PU including a candidate block is out of the boundary of a picture, the availability of the candidate block may be set to “false”. The expression “availability is set to false” may have the same meaning as “set to be unavailable”.
Step 2) When a PU including a candidate block is out of the boundary of a slice, the availability of the candidate block may be set to “false”. When the target block and the candidate block are located in different slices, the availability of the candidate block may be set to “false”.
Step 3) When a PU including a candidate block is out of the boundary of a tile, the availability of the candidate block may be set to “false”. When the target block and the candidate block are located in different tiles, the availability of the candidate block may be set to “false”.
Step 4) When the prediction mode of a PU including a candidate block is an intra-prediction mode, the availability of the candidate block may be set to “false”. When a PU including a candidate block does not use inter prediction, the availability of the candidate block may be set to “false”.

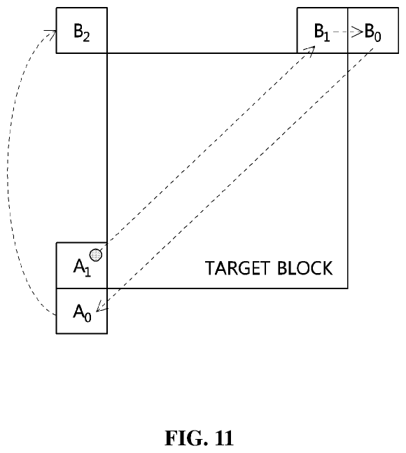

FIG. 11 illustrates the order of addition of motion information of spatial candidates to a merge list according to an embodiment.

As shown in FIG. 11, when pieces of motion information of spatial candidates are added to a merge list, the order of A₁, B₁, B₀, A₀, and B₂ may be used. That is, pieces of motion information of available spatial candidates may be added to the merge list in the order of A₁, B₁, B₀, A₀, and B₂.

### Method for Deriving Merge List in Merge Mode and Skip Mode

As described above, the maximum number of merge candidates in the merge list may be set. The set maximum number is indicated by “N”. The set number may be transmitted from the encoding apparatus 100 to the decoding apparatus 200. The slice header of a slice may include N. In other words, the maximum number of merge candidates in the merge list for the target block of the slice may be set by the slice header. For example, the value of N may be basically 5.

Pieces of motion information (i.e., merge candidates) may be added to the merge list in the order of the following steps 1) to 4).
Step 1) Among spatial candidates, available spatial candidates may be added to the merge list. Pieces of motion information of the available spatial candidates may be added to the merge list in the order illustrated in FIG. 10. Here, when the motion information of an available spatial candidate overlaps other motion information already present in the merge list, the motion information may not be added to the merge list. The operation of checking whether the corresponding motion information overlaps other motion information present in the list may be referred to in brief as an “overlap check”.

The maximum number of pieces of motion information that are added may be N.
Step 2) When the number of pieces of motion information in the merge list is less than N and a temporal candidate is available, the motion information of the temporal candidate may be added to the merge list. Here, when the motion information of the available temporal candidate overlaps other motion information already present in the merge list, the motion information may not be added to the merge list.
Step 3) When the number of pieces of motion information in the merge list is less than N and the type of a target slice is “B”, combined motion information generated by combined bidirectional prediction (bi-prediction) may be added to the merge list.

The target slice may be a slice including a target block.

The combined motion information may be a combination of L0 motion information and L1 motion information. L0 motion information may be motion information that refers only to a reference picture list L0. L1 motion information may be motion information that refers only to a reference picture list L1.

In the merge list, one or more pieces of L0 motion information may be present. Further, in the merge list, one or more pieces of L1 motion information may be present.

The combined motion information may include one or more pieces of combined motion information. When the combined motion information is generated, L0 motion information and L1 motion information, which are to be used for generation, among the one or more pieces of L0 motion information and the one or more pieces of L1 motion information, may be predefined. One or more pieces of combined motion information may be generated in a predefined order via combined bidirectional prediction, which uses a pair of different pieces of motion information in the merge list. One of the pair of different pieces of motion information may be L0 motion information and the other of the pair may be L1 motion information.

For example, combined motion information that is added with the highest priority may be a combination of L0 motion information having a merge index of 0 and L1 motion information having a merge index of 1. When motion information having a merge index of 0 is not L0 motion information or when motion information having a merge index of 1 is not L1 motion information, the combined motion information may be neither generated nor added. Next, the combined motion information that is added with the next priority may be a combination of L0 motion information, having a merge index of 1, and L1 motion information, having a merge index of 0. Subsequent detailed combinations may conform to other combinations of video encoding/decoding fields.

Here, when the combined motion information overlaps other motion information already present in the merge list, the combined motion information may not be added to the merge list.
Step 4) When the number of pieces of motion information in the merge list is less than N, motion information of a zero vector may be added to the merge list.

The zero-vector motion information may be motion information for which the motion vector is a zero vector.

The number of pieces of zero-vector motion information may be one or more.

The reference picture indices of one or more pieces of zero-vector motion information may be different from each other. For example, the value of the reference picture index of first zero-vector motion information may be 0. The value of the reference picture index of second zero-vector motion information may be 1.

The number of pieces of zero-vector motion information may be identical to the number of reference pictures in the reference picture list.

The reference direction of zero-vector motion information may be bidirectional. Both of the motion vectors may be zero vectors. The number of pieces of zero-vector motion information may be the smaller one of the number of reference pictures in the reference picture list L0 and the number of reference pictures in the reference picture list L1. Alternatively, when the number of reference pictures in the reference picture list L0 and the number of reference pictures in the reference picture list L1 are different from each other, a reference direction that is unidirectional may be used for a reference picture index that may be applied only to a single reference picture list.

The encoding apparatus 100 and/or the decoding apparatus 200 may sequentially add the zero-vector motion information to the merge list while changing the reference picture index.

When zero-vector motion information overlaps other motion information already present in the merge list, the zero-vector motion information may not be added to the merge list.

The order of the above-described steps 1) to 4) is merely exemplary, and may be changed. Further, some of the above steps may be omitted depending on predefined conditions.

### Method for Deriving Prediction Motion Vector Candidate List in AMVP Mode

The maximum number of prediction motion vector candidates in a prediction motion vector candidate list may be predefined. The predefined maximum number is indicated by N. For example, the predefined maximum number may be 2.

Pieces of motion information (i.e. prediction motion vector candidates) may be added to the prediction motion vector candidate list in the order of the following steps 1) to 3).
Step 1) Available spatial candidates, among spatial candidates, may be added to the prediction motion vector candidate list. The spatial candidates may include a first spatial candidate and a second spatial candidate.

The first spatial candidate may be one of A₀, A₁, scaled A₀, and scaled A₁. The second spatial candidate may be one of B₀, B₁, B₂, scaled B₀, scaled B₁, and scaled B₂.

Pieces of motion information of available spatial candidates may be added to the prediction motion vector candidate list in the order of the first spatial candidate and the second spatial candidate. In this case, when the motion information of an available spatial candidate overlaps other motion information already present in the prediction motion vector candidate list, the motion information may not be added to the prediction motion vector candidate list. In other words, when the value of N is 2, if the motion information of a second spatial candidate is identical to the motion information of a first spatial candidate, the motion information of the second spatial candidate may not be added to the prediction motion vector candidate list.

The maximum number of pieces of motion information that are added may be N.
Step 2) When the number of pieces of motion information in the prediction motion vector candidate list is less than N and a temporal candidate is available, the motion information of the temporal candidate may be added to the prediction motion vector candidate list. In this case, when the motion information of the available temporal candidate overlaps other motion information already present in the prediction motion vector candidate list, the motion information may not be added to the prediction motion vector candidate list.
Step 3) When the number of pieces of motion information in the prediction motion vector candidate list is less than N, zero-vector motion information may be added to the prediction motion vector candidate list.

The zero-vector motion information may include one or more pieces of zero-vector motion information. The reference picture indices of the one or more pieces of zero-vector motion information may be different from each other.

The encoding apparatus 100 and/or the decoding apparatus 200 may sequentially add pieces of zero-vector motion information to the prediction motion vector candidate list while changing the reference picture index.

When zero-vector motion information overlaps other motion information already present in the prediction motion vector candidate list, the zero-vector motion information may not be added to the prediction motion vector candidate list.

The description of the zero-vector motion information, made above in connection with the merge list, may also be applied to zero-vector motion information. A repeated description thereof will be omitted.

The order of the above-described steps 1) to 3) is merely exemplary, and may be changed. Further, some of the steps may be omitted depending on predefined conditions.

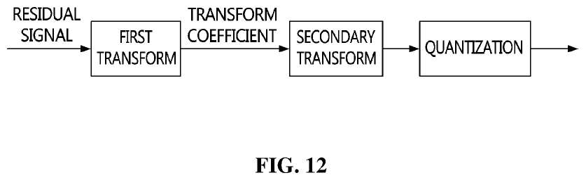

FIG. 12 illustrates a transform and quantization process according to an example.

As illustrated in FIG. 12, quantized levels may be generated by performing a transform and/or quantization process on a residual signal.

A residual signal may be generated as the difference between an original block and a prediction block. Here, the prediction block may be a block generated via intra prediction or inter prediction.

The residual signal may be transformed into a signal in a frequency domain through a transform procedure that is a part of a quantization procedure.

A transform kernel used for a transform may include various DCT kernels, such as Discrete Cosine Transform (DCT) type 2 (DCT-II) and Discrete Sine Transform (DST) kernels.

These transform kernels may perform a separable transform or a two-dimensional (2D) non-separable transform on the residual signal. The separable transform may be a transform indicating that a one-dimensional (1D) transform is performed on the residual signal in each of a horizontal direction and a vertical direction.

The DCT type and the DST type, which are adaptively used for a 1D transform, may include DCT-V, DCT-VIII, DST-I, and DST-VII in addition to DCT-II, as shown in each of the following Table 3 and the following table 4.

TABLE 3

| Transform set | Transform candidates |
|---|---|
| 0 | DST-VII, DCT-VIII |
| 1 | DST-VII, DST-I |
| 2 | DST-VII, DCT-V |

TABLE 4

| Transform set | Transform candidates |
|---|---|
| 0 | DST-VII, DCT-VIII, DST-I |
| 1 | DST-VII, DST-I, DCT-VIII |
| 2 | DST-VII, DCT-V, DST-I |

As shown in Table 3 and Table 4, when a DCT type or a DST type to be used for a transform is derived, transform sets may be used. Each transform set may include multiple transform candidates. Each transform candidate may be a DCT type or a DST type.

The following Table 5 shows examples of a transform set to be applied to a horizontal direction and a transform set to be applied to a vertical direction depending on intra-prediction modes.

TABLE 5

| Intra-prediction | | | | | | | | | | |
|---|---|---|---|---|---|---|---|---|---|---|
| mode | 0 | 1 | 2 | 3 | 4 | 5 | 6 | 7 | 8 | 9 |
| Vertical transform | 2 | 1 | 0 | 1 | 0 | 1 | 0 | 1 | 0 | 1 |
| set | | | | | | | | | | |
| Horizontal | 2 | 1 | 0 | 1 | 0 | 1 | 0 | 1 | 0 | 1 |
| transform set | | | | | | | | | | |
| Intra-prediction | | | | | | | | | | |
| mode | 10 | 11 | 12 | 13 | 14 | 15 | 16 | 17 | 18 | 19 |
| Vertical transform | 0 | 1 | 0 | 1 | 0 | 0 | 0 | 0 | 0 | 0 |
| set | | | | | | | | | | |
| Horizontal | 0 | 1 | 0 | 1 | 2 | 2 | 2 | 2 | 2 | 2 |
| transform set | | | | | | | | | | |
| Intra-prediction | | | | | | | | | | |
| mode | 20 | 21 | 22 | 23 | 24 | 25 | 26 | 27 | 28 | 29 |
| Vertical transform | 0 | 0 | 0 | 1 | 0 | 1 | 0 | 1 | 0 | 1 |
| set | | | | | | | | | | |
| Horizontal | 2 | 2 | 2 | 1 | 0 | 1 | 0 | 1 | 0 | 1 |
| transform set | | | | | | | | | | |
| Intra-prediction | | | | | | | | | | |
| mode | 30 | 31 | 32 | 33 | 34 | 35 | 36 | 37 | 38 | 39 |
| Vertical transform | 0 | 1 | 0 | 1 | 0 | 1 | 0 | 1 | 0 | 1 |
| set | | | | | | | | | | |
| Horizontal | 0 | 1 | 0 | 1 | 0 | 1 | 0 | 1 | 0 | 1 |
| transform set | | | | | | | | | | |
| Intra-prediction | | | | | | | | | | |
| mode | 40 | 41 | 42 | 43 | 44 | 45 | 46 | 47 | 48 | 49 |
| Vertical transform | 0 | 1 | 0 | 1 | 0 | 1 | 2 | 2 | 2 | 2 |
| set | | | | | | | | | | |
| Horizontal | 0 | 1 | 0 | 1 | 0 | 1 | 0 | 0 | 0 | 0 |
| transform set | | | | | | | | | | |
| Intra-prediction | | | | | | | | | | |
| mode | 50 | 51 | 52 | 53 | 54 | 55 | 56 | 57 | 58 | 59 |
| Vertical transform | 2 | 2 | 2 | 2 | 2 | 1 | 0 | 1 | 0 | 1 |
| set | | | | | | | | | | |
| Horizontal | 0 | 0 | 0 | 0 | 0 | 1 | 0 | 1 | 0 | 1 |
| transform set | | | | | | | | | | |
| Intra-prediction | | | | | | | | | | |
| mode | 60 | 61 | 62 | 63 | 64 | 65 | 66 | | | |
| Vertical transform | 0 | 1 | 0 | 1 | 0 | 1 | 0 | | | |
| set | | | | | | | | | | |
| Horizontal | 0 | 1 | 0 | 1 | 0 | 1 | 0 | | | |
| transform set | | | | | | | | | | |

In Table 5, numbers of vertical transform sets and horizontal transform sets that are to be applied to the horizontal direction of a residual signal depending on the intra-prediction modes of the target block are indicated.

As exemplified in FIGS. 4 and 5, transform sets to be applied to the horizontal direction and the vertical direction may be predefined depending on the intra-prediction mode of the target block. The encoding apparatus 100 may perform a transform and an inverse transform on the residual signal using a transform included in the transform set corresponding to the intra-prediction mode of the target block. Further, the decoding apparatus 200 may perform an inverse transform on the residual signal using a transform included in the transform set corresponding to the intra-prediction mode of the target block.

In the transform and inverse transform, transform sets to be applied to the residual signal may be determined, as exemplified in Tables 3, 4, and 5, and may not be signaled. Transform indication information may be signaled from the encoding apparatus 100 to the decoding apparatus 200. The transform indication information may be information indicating which one of multiple transform candidates included in the transform set to be applied to the residual signal is used.

For example, when the size of the target block is 64×64 or less, transform sets, each having three transforms, may be configured depending on the intra-prediction modes.

An optimal transform method may be selected from among a total of nine multiple transform methods resulting from combinations of three transforms in a horizontal direction and three transforms in a vertical direction. Through such an optimal transform method, the residual signal may be encoded and/or decoded, and thus coding efficiency may be improved.

Here, information indicating which one of transforms belonging to each transform set has been used for at least one of a vertical transform and a horizontal transform may be entropy-encoded and/or -decoded. Here, truncated unary binarization may be used to encode and/or decode such information.

As described above, methods using various transforms may be applied to a residual signal generated via intra prediction or inter prediction.

The transform may include at least one of a first transform and a secondary transform. A transform coefficient may be generated by performing the first transform on the residual signal, and a secondary transform coefficient may be generated by performing the secondary transform on the transform coefficient.

The first transform may be referred to as a “primary transform”. Further, the first transform may also be referred to as an “Adaptive Multiple Transform (AMT) scheme”. AMT may mean that, as described above, different transforms are applied to respective 1D directions (i.e. a vertical direction and a horizontal direction).

A secondary transform may be a transform for improving energy concentration on a transform coefficient generated by the first transform. Similar to the first transform, the secondary transform may be a separable transform or a non-separable transform. Such a non-separable transform may be a Non-Separable Secondary Transform (NSST).

The first transform may be performed using at least one of predefined multiple transform methods. For example, the predefined multiple transform methods may include a Discrete Cosine Transform (DCT), a Discrete Sine Transform (DST), a Karhunen-Loeve Transform (KLT), etc.

Further, a first transform may be a transform having various transform types depending on a kernel function that defines a Discrete Cosine Transform (DCT) or a Discrete Sine Transform (DST).

For example, the transform type may be determined based at least one of 1) a prediction mode of a target block (for example, one of an intra prediction and an inter prediction), 2) a size of a target block, 3) a shape of a target block, 4) an intra prediction mode of a target block, 5) a component of a target block (for example, one of a luma component an a chroma component), and 6) a partitioning type applied to a target block (for example, one of a Quad Tree, a Binary Tree and a Ternary Tree).

For example, the first transform may include transforms, such as DCT-2, DCT-5, DCT-7, DST-7, DST-1, DST-8, and DCT-8 depending on the transform kernel presented in the following Table 6. In the following Table 6, various transform types and transform kernel functions for Multiple Transform Selection (MTS) are exemplified.

MTS may refer to the selection of combinations of one or more DCT and/or DST kernels so as to transform a residual signal in a horizontal and/or vertical direction.

TABLE 6

| Transform | |
|---|---|
| type | Transform kernel function Tᵢ(j) |
| DCT-2 | ${T}_{i} ( j ) = {ω}_{0} \cdot \sqrt{\frac{2}{N}} \cdot cos ( \frac{π \cdot i \cdot ( 2 j + 1 )}{2 N} )$ where ${ω}_{0} = \sqrt{\frac{2}{N}} ( i = 0 ) or 1 ( otherwise )$ |
| DST-7 | ${T}_{i} ( j ) = \sqrt{\frac{4}{2 N + 1}} \cdot sin ( \frac{π \cdot ( 2 j + 1 ) \cdot ( j + 1 )}{2 N + 1} )$ |
| DCT-5 | ${T}_{i} ( j ) = {ω}_{0} \cdot {ω}_{1} \cdot \sqrt{\frac{2}{2 N - 1}} \cdot cos ( \frac{2 π i \cdot j}{2 N + 1} )$ where ${ω}_{0 / 1} = \sqrt{\frac{2}{N}} ( i or j = 0 ) or 1 ( otherwise )$ |
| DCT-8 | ${T}_{i} ( j ) = \sqrt{\frac{4}{2 N + 1}} \cdot cos ( \frac{π \cdot ( 2 j + 1 ) \cdot ( 2 j + 1 )}{4 N + 2} )$ |
| DST-1 | ${T}_{i} ( j ) = \sqrt{\frac{2}{N + 1}} \cdot sin ( \frac{π \cdot ( i + 1 ) \cdot ( j + 1 )}{N + 1} )$ |

In Table 6, i and j may be integer values that are equal to or greater than 0 and are less than or equal to N−1.

The secondary transform may be performed on the transform coefficient generated by performing the first transform.

As in the first transform, transform sets may also be defined in a secondary transform. The methods for deriving and/or determining the above-described transform sets may be applied not only to the first transform but also to the secondary transform.

The first transform and the secondary transform may be determined for a specific target.

For example, a first transform and a secondary transform may be applied to signal components corresponding to one or more of a luminance (luma) component and a chrominance (chroma) component. Whether to apply the first transform and/or the secondary transform may be determined depending on at least one of coding parameters for a target block and/or a neighbor block. For example, whether to apply the first transform and/or the secondary transform may be determined depending on the size and/or shape of the target block.

In the encoding apparatus 100 and the decoding apparatus 200, transform information indicating the transform method to be used for the target may be derived by utilizing specified information.

For example, the transform information may include a transform index to be used for a primary transform and/or a secondary transform. Alternatively, the transform information may indicate that a primary transform and/or a secondary transform are not used.

For example, when the target of a primary transform and a secondary transform is a target block, the transform method(s) to be applied to the primary transform and/or the secondary transform indicated by the transform information may be determined depending on at least one of coding parameters for the target block and/or blocks neighbor the target block.

Alternatively, transform information indicating a transform method for a specific target may be signaled from the encoding apparatus 100 to the decoding apparatus 200.

For example, for a single CU, whether to use a primary transform, an index indicating the primary transform, whether to use a secondary transform, and an index indicating the secondary transform may be derived as the transform information by the decoding apparatus 200. Alternatively, for a single CU, the transform information, which indicates whether to use a primary transform, an index indicating the primary transform, whether to use a secondary transform, and an index indicating the secondary transform, may be signaled.

The quantized transform coefficient (i.e. the quantized levels) may be generated by performing quantization on the result, generated by performing the first transform and/or the secondary transform, or on the residual signal.

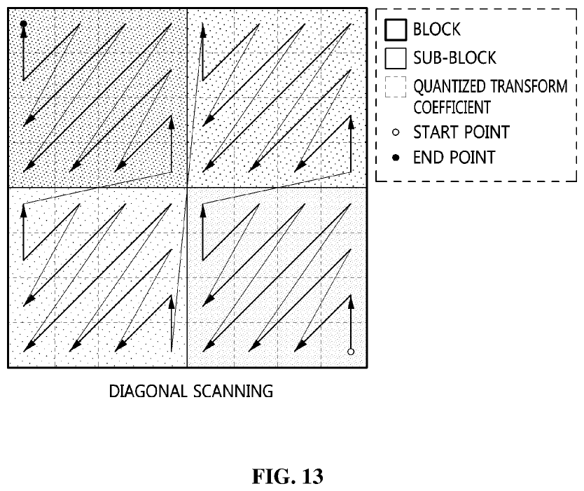

FIG. 13 illustrates diagonal scanning according to an example.

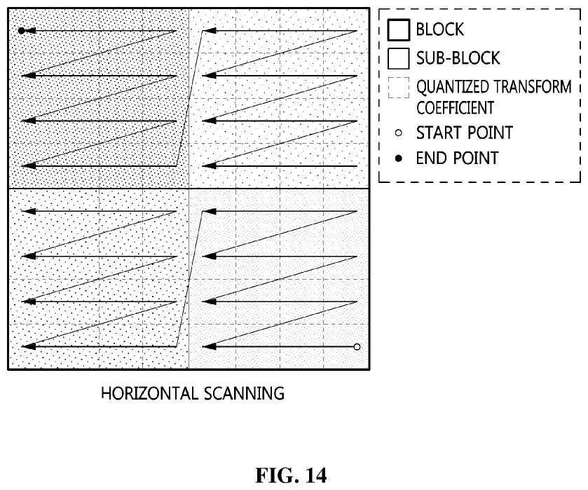

FIG. 14 illustrates horizontal scanning according to an example.

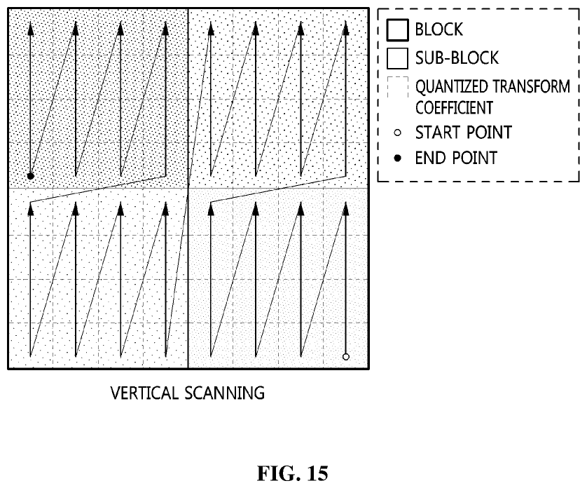

FIG. 15 illustrates vertical scanning according to an example.

Quantized transform coefficients may be scanned via at least one of (up-right) diagonal scanning, vertical scanning, and horizontal scanning depending on at least one of an intra-prediction mode, a block size, and a block shape. The block may be a Transform Unit (TU).

Each scanning may be initiated at a specific start point, and may be terminated at a specific end point.

For example, quantized transform coefficients may be changed to 1D vector forms by scanning the coefficients of a block using diagonal scanning of FIG. 13. Alternatively, horizontal scanning of FIG. 14 or vertical scanning of FIG. 15, instead of diagonal scanning, may be used depending on the size and/or intra-prediction mode of a block.

Vertical scanning may be the operation of scanning 2D block-type coefficients in a column direction. Horizontal scanning may be the operation of scanning 2D block-type coefficients in a row direction.

In other words, which one of diagonal scanning, vertical scanning, and horizontal scanning is to be used may be determined depending on the size and/or inter-prediction mode of the block.

As illustrated in FIGS. 13, 14, and 15, the quantized transform coefficients may be scanned along a diagonal direction, a horizontal direction or a vertical direction.

The quantized transform coefficients may be represented by block shapes. Each block may include multiple sub-blocks. Each sub-block may be defined depending on a minimum block size or a minimum block shape.

In scanning, a scanning sequence depending on the type or direction of scanning may be primarily applied to sub-blocks. Further, a scanning sequence depending on the direction of scanning may be applied to quantized transform coefficients in each sub-block.

For example, as illustrated in FIGS. 13, 14, and 15, when the size of a target block is 8×8, quantized transform coefficients may be generated through a first transform, a secondary transform, and quantization on the residual signal of the target block. Therefore, one of three types of scanning sequences may be applied to four 4×4 sub-blocks, and quantized transform coefficients may also be scanned for each 4×4 sub-block depending on the scanning sequence.

The encoding apparatus 100 may generate entropy-encoded quantized transform coefficients by performing entropy encoding on scanned quantized transform coefficients, and may generate a bitstream including the entropy-encoded quantized transform coefficients.

The decoding apparatus 200 may extract the entropy-encoded quantized transform coefficients from the bitstream, and may generate quantized transform coefficients by performing entropy decoding on the entropy-encoded quantized transform coefficients. The quantized transform coefficients may be aligned in the form of a 2D block via inverse scanning. Here, as the method of inverse scanning, at least one of up-right diagonal scanning, vertical scanning, and horizontal scanning may be performed.

In the decoding apparatus 200, dequantization may be performed on the quantized transform coefficients. A secondary inverse transform may be performed on the result generated by performing dequantization depending on whether to perform the secondary inverse transform. Further, a first inverse transform may be performed on the result generated by performing the secondary inverse transform depending on whether the first inverse transform is to be performed. A reconstructed residual signal may be generated by performing the first inverse transform on the result generated by performing the secondary inverse transform.

For a luma component which is reconstructed via intra prediction or inter prediction, inverse mapping having a dynamic range may be performed before in-loop filtering.

The dynamic range may be divided into 16 equal pieces, and mapping functions for respective pieces may be signaled. Such a mapping function may be signaled at a slice level or a tile group level.

An inverse mapping function for performing inverse mapping may be derived based on the mapping function.

In-loop filtering, the storage of a reference picture, and motion compensation may be performed in an inverse mapping area.

A prediction block generated via inter prediction may be changed to a mapped area through mapping using a mapping function, and the changed prediction block may be used to generate a reconstructed block. However, since intra prediction is performed in the mapped area, a prediction block generated via intra prediction may be used to generate a reconstructed block without requiring mapping and/or inverse mapping.

For example, when the target block is a residual block of a chroma component, the residual block may be changed to an inversely mapped area by scaling the chroma component of the mapped area.

Whether scaling is available may be signaled at a slice level or a tile group level.

For example, scaling may be applied only to the case where mapping is available for a luma component and where the partitioning of the luma component and the partitioning of the chroma component follow the same tree structure.

Scaling may be performed based on the average of the values of samples in a luma prediction block, which corresponds to a chroma prediction block. Here, when the target block uses inter prediction, the luma prediction block may mean a mapped luma prediction block.

A value required for scaling may be derived by referring to a look-up table using the index of a piece to which the average of sample values of the luma prediction block belongs.

The residual block may be changed to an inversely mapped area by scaling the residual block using a finally derived value. Thereafter, for the block of a chroma component, reconstruction, intra prediction, inter prediction, in-loop filtering, and the storage of a reference picture may be performed in the inversely mapped area.

For example, information indicating whether the mapping and/or inverse mapping of a luma component and a chroma component are available may be signaled through a sequence parameter set.

A prediction block for the target block may be generated based on a block vector. The block vector may indicate displacement between the target block and a reference block. The reference block may be a block in a target image.

In this way, a prediction mode in which the prediction block is generated by referring to the target image may be referred to as an “Intra-Block Copy (IBC) mode”.

An IBC mode may be applied to a CU having a specific size. For example, the IBC mode may be applied to an M×N CU. Here, M and N may be less than or equal to 64.

The IBC mode may include a skip mode, a merge mode, an AMVP mode, etc. In the case of the skip mode or the merge mode, a merge candidate list may be configured, and a merge index is signaled, and thus a single merge candidate may be specified among merge candidates present in the merge candidate list. The block vector of the specified merge candidate may be used as the block vector of the target block.

In the case of the AMVP mode, a differential block vector may be signaled. Also, a prediction block vector may be derived from the left neighbor block and the above neighbor block of the target block. Further, an index indicating which neighbor block is to be used may be signaled.

A prediction block in the IBC mode may be included in a target CTU or a left CTU, and may be limited to a block within a previously reconstructed area. For example, the value of a block vector may be limited so that a prediction block for a target block is located in a specific area. The specific area may be an area defined by three 64×64 blocks that are encoded and/or decoded prior to a 64×64 block including the target block. The value of the block vector is limited in this way, and thus memory consumption and device complexity caused by the implementation of the IBC mode may be decreased.

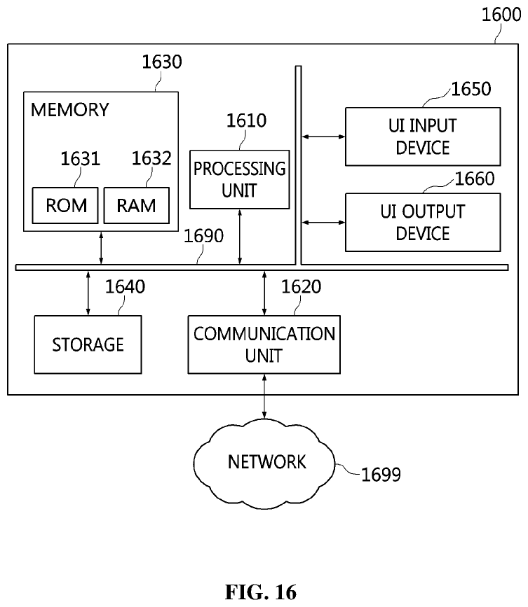

FIG. 16 is a configuration diagram of an encoding apparatus according to an embodiment.

An encoding apparatus 1600 may correspond to the above-described encoding apparatus 100.

The encoding apparatus 1600 may include a processing unit 1610, memory 1630, a user interface (UI) input device 1650, a UI output device 1660, and storage 1640, which communicate with each other through a bus 1690. The encoding apparatus 1600 may further include a communication unit 1620 coupled to a network 1699.

The processing unit 1610 may be a Central Processing Unit (CPU) or a semiconductor device for executing processing instructions stored in the memory 1630 or the storage 1640. The processing unit 1610 may be at least one hardware processor.

The processing unit 1610 may generate and process signals, data or information that are input to the encoding apparatus 1600, are output from the encoding apparatus 1600, or are used in the encoding apparatus 1600, and may perform examination, comparison, determination, etc. related to the signals, data or information. In other words, in embodiments, the generation and processing of data or information and examination, comparison and determination related to data or information may be performed by the processing unit 1610.

The processing unit 1610 may include an inter-prediction unit 110, an intra-prediction unit 120, a switch 115, a subtractor 125, a transform unit 130, a quantization unit 140, an entropy encoding unit 150, a dequantization unit 160, an inverse transform unit 170, an adder 175, a filter unit 180, and a reference picture buffer 190.

At least some of the inter-prediction unit 110, the intra-prediction unit 120, the switch 115, the subtractor 125, the transform unit 130, the quantization unit 140, the entropy encoding unit 150, the dequantization unit 160, the inverse transform unit 170, the adder 175, the filter unit 180, and the reference picture buffer 190 may be program modules, and may communicate with an external device or system. The program modules may be included in the encoding apparatus 1600 in the form of an operating system, an application program module, or other program modules.

The program modules may be physically stored in various types of well-known storage devices. Further, at least some of the program modules may also be stored in a remote storage device that is capable of communicating with the encoding apparatus 1200.

The program modules may include, but are not limited to, a routine, a subroutine, a program, an object, a component, and a data structure for performing functions or operations according to an embodiment or for implementing abstract data types according to an embodiment.

The program modules may be implemented using instructions or code executed by at least one processor of the encoding apparatus 1600.

The processing unit 1610 may execute instructions or code in the inter-prediction unit 110, the intra-prediction unit 120, the switch 115, the subtractor 125, the transform unit 130, the quantization unit 140, the entropy encoding unit 150, the dequantization unit 160, the inverse transform unit 170, the adder 175, the filter unit 180, and the reference picture buffer 190.

A storage unit may denote the memory 1630 and/or the storage 1640. Each of the memory 1630 and the storage 1640 may be any of various types of volatile or nonvolatile storage media. For example, the memory 1630 may include at least one of Read-Only Memory (ROM) 1631 and Random Access Memory (RAM) 1632.

The storage unit may store data or information used for the operation of the encoding apparatus 1600. In an embodiment, the data or information of the encoding apparatus 1600 may be stored in the storage unit.

For example, the storage unit may store pictures, blocks, lists, motion information, inter-prediction information, bitstreams, etc.

The encoding apparatus 1600 may be implemented in a computer system including a computer-readable storage medium.

The storage medium may store at least one module required for the operation of the encoding apparatus 1600. The memory 1630 may store at least one module, and may be configured such that the at least one module is executed by the processing unit 1610.

Functions related to communication of the data or information of the encoding apparatus 1600 may be performed through the communication unit 1620.

For example, the communication unit 1620 may transmit a bitstream to a decoding apparatus 1600, which will be described later.

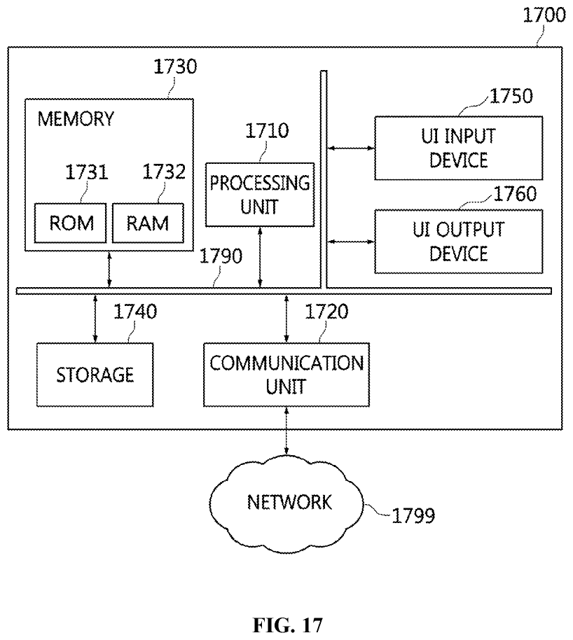

FIG. 17 is a configuration diagram of a decoding apparatus according to an embodiment.

The decoding apparatus 1700 may correspond to the above-described decoding apparatus 200.

The decoding apparatus 1700 may include a processing unit 1710, memory 1730, a user interface (UI) input device 1750, a UI output device 1760, and storage 1740, which communicate with each other through a bus 1790. The decoding apparatus 1700 may further include a communication unit 1720 coupled to a network 1799.

The processing unit 1710 may be a Central Processing Unit (CPU) or a semiconductor device for executing processing instructions stored in the memory 1730 or the storage 1740. The processing unit 1710 may be at least one hardware processor.

The processing unit 1710 may generate and process signals, data or information that are input to the decoding apparatus 1700, are output from the decoding apparatus 1700, or are used in the decoding apparatus 1700, and may perform examination, comparison, determination, etc. related to the signals, data or information. In other words, in embodiments, the generation and processing of data or information and examination, comparison and determination related to data or information may be performed by the processing unit 1710.

The processing unit 1710 may include an entropy decoding unit 210, a dequantization unit 220, an inverse transform unit 230, an intra-prediction unit 240, an inter-prediction unit 250, a switch 245, an adder 255, a filter unit 260, and a reference picture buffer 270.

At least some of the entropy decoding unit 210, the dequantization unit 220, the inverse transform unit 230, the intra-prediction unit 240, the inter-prediction unit 250, the adder 255, the switch 245, the filter unit 260, and the reference picture buffer 270 of the decoding apparatus 200 may be program modules, and may communicate with an external device or system. The program modules may be included in the decoding apparatus 1700 in the form of an operating system, an application program module, or other program modules.

The program modules may be physically stored in various types of well-known storage devices. Further, at least some of the program modules may also be stored in a remote storage device that is capable of communicating with the decoding apparatus 1700.

The program modules may include, but are not limited to, a routine, a subroutine, a program, an object, a component, and a data structure for performing functions or operations according to an embodiment or for implementing abstract data types according to an embodiment.

The program modules may be implemented using instructions or code executed by at least one processor of the decoding apparatus 1700.

The processing unit 1710 may execute instructions or code in the entropy decoding unit 210, the dequantization unit 220, the inverse transform unit 230, the intra-prediction unit 240, the inter-prediction unit 250, the switch 245, the adder 255, the filter unit 260, and the reference picture buffer 270.

A storage unit may denote the memory 1730 and/or the storage 1740. Each of the memory 1730 and the storage 1740 may be any of various types of volatile or nonvolatile storage media. For example, the memory 1730 may include at least one of ROM 1731 and RAM 1732.

The storage unit may store data or information used for the operation of the decoding apparatus 1700. In an embodiment, the data or information of the decoding apparatus 1700 may be stored in the storage unit.

For example, the storage unit may store pictures, blocks, lists, motion information, inter-prediction information, bitstreams, etc.

The decoding apparatus 1700 may be implemented in a computer system including a computer-readable storage medium.

The storage medium may store at least one module required for the operation of the decoding apparatus 1700. The memory 1730 may store at least one module, and may be configured such that the at least one module is executed by the processing unit 1710.

Functions related to communication of the data or information of the decoding apparatus 1700 may be performed through the communication unit 1720.

For example, the communication unit 1720 may receive a bitstream from the encoding apparatus 1700.

Hereinafter, a processing unit may represent the processing unit 1610 of the encoding apparatus 1600 and/or the processing unit 1710 of the decoding apparatus 1700. For example, as to functions relating to prediction, the processing unit may represent the switch 115 and/or the switch 245. As to functions relating to inter prediction, the processing unit may represent the inter-prediction unit 110, the subtractor 125 and the adder 175, and may represent the inter prediction unit 250 and the adder 255. As to functions relating to intra prediction, the processing unit may represent the intra prediction unit 120, the subtractor 125, and the adder 175, and may represent the intra prediction unit 240 and the adder 255. As to functions related to transform, the processing unit may represent the transform unit 130 and the inverse transform unit 170, and may represent the inverse transform unit 230. As to functions relating quantization, the processing unit may represent the quantization unit 140 and the inverse quantization unit 160, and may indicate the inverse quantization unit 220. As to functions relating to entropy encoding and/or entropy decoding, the processing unit may represent the entropy encoding unit 150 and/or the entropy decoding unit 210. As to functions relating filtering, the processing unit may represent the filter unit 180 and/or the filter unit 260. As to functions relating a reference picture, the processing unit may indicate the reference picture buffer 190 and/or the reference picture buffer 270.

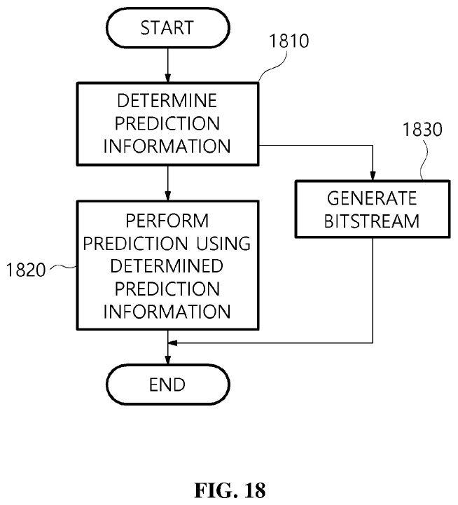

FIG. 18 is a flowchart illustrating a target block prediction method and a bitstream generation method according to an embodiment.

The target block prediction method and the bitstream generation method according to the embodiment may be performed by the encoding apparatus 1600. The embodiment may be a part of a target block encoding method or a video encoding method.

At step 1810, the processing unit 1610 may determine prediction information to be applied to the encoding of the target block.

The prediction information may include information used for the above-described prediction. For example, the prediction information may include inter-prediction information. For example, the prediction information may include intra-prediction information.

The prediction information may include a list and multiple candidates in the list.

The processing unit 1610 may generate a list for the target block. The list may include multiple candidates.

At step 1820, the processing unit 1610 may perform prediction for the target block using information about the target block and the determined prediction information.

The processing unit 1610 may perform prediction for the target block using the candidates in the list. The processing unit 1610 may perform prediction for the target block using a candidate selected from among the candidates in the list.

A prediction block may be generated by prediction for the target block.

A residual block that is the difference between the target block and the prediction block may be generated. Information about the target block may be generated by applying a transform and quantization to the residual block.

The information about the target block may include transformed and quantized coefficients for the target block. The information about the target block may include prediction information.

Further, a reconstructed block that is the sum of the prediction block and the reconstructed residual block may be generated.

At step 1830, the processing unit 1610 may generate a bitstream.

The bitstream may include information about the target block. Also, the bitstream may include the information described above in the embodiments. For example, the bitstream may include coding parameters related to the target block and/or the attributes of the target block.

The information included in the bitstream may be generated at step 1830, or may be at least partially generated at steps 1810 and 1820.

The processing unit 1610 may store the generated bitstream in the storage 1640. Alternatively, the communication unit 1620 may transmit the bitstream to the decoding apparatus 1700.

The bitstream may include information about an encoded target block. The processing unit 1610 may generate the information about the encoded target block by performing entropy encoding on the information about the target block.

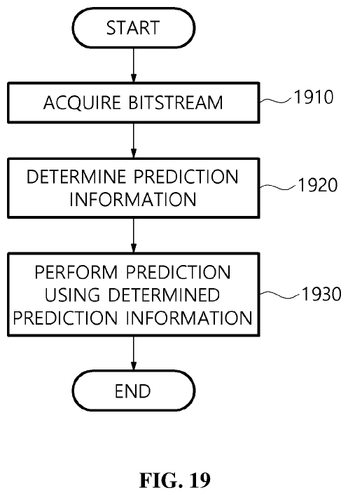

FIG. 19 is a flowchart illustrating a target block prediction method using a bitstream according to an embodiment.

The target block prediction method using a bitstream according to the present embodiment may be performed by the decoding apparatus 1700. The embodiment may be a part of a target block decoding method or a video decoding method.

At step 1910, the communication unit 1720 may acquire a bitstream. The communication unit 1720 may receive the bitstream from the encoding apparatus 1600.

The bitstream may include information about the target block.

The information about the target block may include transformed and quantized coefficients for the target block. The information about the target block may include prediction information.

Also, the bitstream may include the information described above in the embodiments. For example, the bitstream may include coding parameters related to the target block and/or the attributes of the target block.

A computer-readable storage medium may include the bitstream, and prediction and decoding on the target block may be performed using the information about the target block included in the bitstream.

The bitstream may include information about an encoded target block. The processing unit 1710 may generate the information about the target block by performing entropy decoding on the information about the encoded target block.

The processing unit 1710 may store the acquired bitstream in the storage 1740.

At step 1920, the processing unit 1710 may determine prediction information to be applied to the decoding of the target block.

The processing unit 1710 may determine the prediction information using the method used in the above-described embodiment.

The processing unit 1710 may determine the prediction information for the target block based on prediction method-related information acquired from the bitstream.

The prediction information may include inter-prediction information. The prediction information may include intra-prediction information.

The prediction information may include a list and multiple candidates in the list.

The processing unit 1710 may generate a list for the target block. The list may include multiple candidates.

At step 1930, the processing unit 1710 may perform prediction for the target block using the information about the target block and the determined prediction information.

The processing unit 1710 may perform prediction for the target block using the candidates in the list. The processing unit 1710 may perform prediction for the target block using a candidate selected from among the candidates in the list.

At step 1930, a prediction block may be generated by performing prediction for the target block using the prediction information.

Further, a reconstructed block that is the sum of the prediction block and a reconstructed residual block may be generated.

### Geometric Partitioning

A Geometric Partitioning Mode (GPM) may be a mode in which the target block is partitioned into two subblocks using geometric partitioning and (different) predictions are respectively applied to the two partitioned subblocks.

Each prediction may be intra-prediction and/or inter-prediction. Each prediction may be a combination of inter-prediction and intra-prediction. Inter-prediction may be unidirectional inter-prediction or bidirectional inter-prediction. Inter-prediction may be applied to one of the two subblocks, and intra-prediction may be applied to the other subblock.

In an embodiment, the types of predictions applied to two subblocks may be determined according to the type of slice, picture, or tile.

For example, when slice is I slice, intra-predictions may be applied to the two subblocks.

For example, when a slice is P slice, inter-prediction may be applied to one of the two subblocks, and intra-prediction may be applied to the other subblock.

For example, when a slice is B slice, inter-prediction may be applied to one of the two subblocks, and intra-prediction may be applied to the other subblock. Alternatively, when a slice is B slice, inter-predictions may be applied to the two subblocks. Alternatively, when a slice is B slice, intra-predictions may be applied to the two subblocks.

Two sub-prediction blocks may be generated for the two subblocks. A prediction block for the target block may be generated using the two sub-prediction blocks.

The relationships between the above-described slice types and prediction types may be combined with each other. Further, limitation in the prediction types depending on the above-described slice types may also be applied to the specific type of picture or the specific type of tile.

In an embodiment, the subblocks may be partitioned regions of the target block.

The regions of the block may denote pixels in the block or the locations of the pixels.

Here, the target block may have a square shape, a rectangular shape, or a non-square rectangular shape. Here, the non-square rectangle may refer to a rectangle having a horizontal length and a vertical length that are different from each other.

Here, each subblock may have a square shape, a rectangular shape, a non-square rectangular shape, a triangular shape, or a trapezoidal shape.

The target block may be partitioned into two or more subblocks, each having a rectangular shape. In GPM, the target block may be partitioned into 1) two rectangular subblocks, 2) a trapezoidal subblock and a triangular subblock, or 3) two trapezoidal subblocks depending on the partitioning mode of the GPM.

The partitioning mode may be a mode in which geometric partitioning for the target block is to be performed.

The target block may be partitioned along a partition boundary.

The partition boundary of geometric partitioning may refer to a partition line for partitioning the target block into two subblocks. Alternatively, the partition boundary of geometric partitioning may refer to a boundary between two subblocks of the target block.

Alternatively, the partition boundary or the partition line may be a portion in which the subblocks overlap each other. Hereinafter, the terms “partition boundary” and “partition line” may be used interchangeably with each other.

The target block may be partitioned into two subblocks along the partition boundary. Alternatively, a partition boundary between two subblocks may define partitioning.

The two subblocks may include a first subblock and a second subblock.

The two partitioned blocks may be specified by partitioning the target block along the partition boundary. Alternatively, the two partitioned blocks in the target block may be distinguished from each other along the partition boundary.

For example, the first subblock may be a block located above the partition boundary between the two partitioned blocks. The second subblock may be a block located below the partition boundary between the two partitioned blocks.

For example, the first subblock may be a block located to the right of the partition boundary between the two partitioned blocks. The second subblock may be a block located to the left of the partition boundary between the two partitioned blocks.

For example, the first subblock may be a block including the uppermost-rightmost pixel of the target block between the two partitioned blocks. The second subblock may be a block including the lowermost-leftmost pixel of the target block between the two partitioned blocks.

Two different sub-prediction blocks may be generated for two subblocks, respectively. The two sub-prediction blocks may be generated using different pieces of motion information, respectively. The prediction block for the target block may be generated through the weighted sum of the two sub-prediction blocks.

For example, as described above in the foregoing intra-prediction mode, merge mode, AMVP mode, etc., each sub-prediction block may be generated using the neighboring block of the target block and/or a reference block for the target block.

For example, as described above in the foregoing intra-prediction mode, merge mode, AMVP mode, etc., each sub-prediction block may refer to an intermediate (or a temporary) prediction block generated using a neighboring block of the target block and/or a reference block for the target block.

A predictor may refer to information used to generate a sub-prediction block for such a subblock. Alternatively, the predictor may be information for specifying a target used to generate a sub-prediction block for a subblock. For example, the target may be another block, the neighboring block of the target block, an intra-prediction mode, a candidate in a list, or the like. Alternatively, the predictor may refer to a subblock.

The two sub-prediction blocks for target blocks may be generated using different predictions, respectively. The two sub-prediction blocks may be a first sub-prediction block and a second sub-prediction block. The two predictors may be a first predictor and a second predictor.

For example, of the two predictors, the first predictor may be generated using intra-prediction. To perform intra-prediction for the first predictor, an intra-prediction mode for the first predictor may be determined. Information required for determining the intra-prediction mode for the first predictor may be signaled through a bitstream.

For example, for each of the two predictors, information for specifying the type of prediction used for the corresponding predictor (e.g., a flag indicating one of intra-prediction and inter-prediction) may be signaled through the bitstream.

In an embodiment, when intra-prediction is used for each subblock, intra-prediction modes usable for intra-prediction may be predefined. For example, predefined intra-prediction modes that can be used for intra-prediction for the subblock may be limited depending on the type of geometric partitioning of the target block.

For example, the predefined intra-prediction modes may be determined depending on the shape of geometric partitioning. Alternatively, the predefined intra-prediction modes may be determined depending on the partition boundary of geometric partitioning.

For example, the predefined intra-prediction modes may include 1) a mode horizontal to the partition boundary of geometric partitioning, and 2) a mode vertical to the partition boundary. Alternatively, the predefined intra-prediction modes may include 1) a mode parallel to the partition boundary of geometric partitioning, 2) a mode vertical to the partition boundary, and 3) a planar mode.

In an embodiment, when one of intra-prediction modes predefined for a subblock is used, information for specifying the intra-prediction mode of the subblock, among the predefined intra-prediction modes, may be signaled through the bitstream.

Of the two sub-prediction blocks, the second sub-prediction block may be generated using inter-prediction. To perform inter-prediction for the second subblock, an inter-prediction mode (e.g., a merge mode, an AMVP mode, etc.) for the second subblock may be determined. Information for determining the inter-prediction mode for the second subblock may be signaled through the bitstream.

Alternatively, the two sub-prediction blocks may be respectively generated using intra-predictions.

Alternatively, the two sub-prediction blocks may be respectively generated using inter-predictions.

### Angle and Distance of Geometric Partitioning

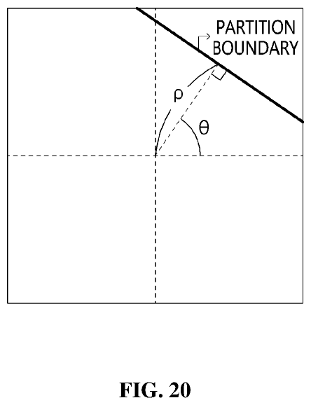

FIG. 20 illustrates the angle and distance of geometric partitioning according to an example.

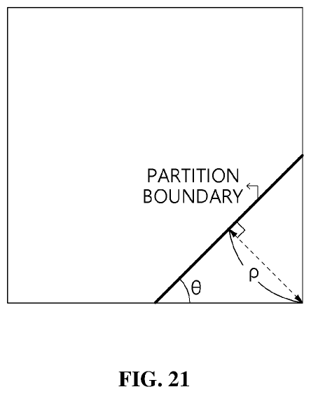

FIG. 21 illustrates the angle and distance of geometric partitioning according to another example.

Geometric partitioning of GPM may be specified by θ (Theta) and ρ (Rho).

As illustrated in FIG. 20, θ may be an angle. θ may be an angle between a line that passes through the center of the target block and that is perpendicular to the partition boundary and a horizontal line passing though the center of the target block. Below, the term “angle” may refer to θ. ρ may be the (shortest) distance between the center of the target block and the partition boundary. Alternatively, ρ may be the distance between two points in the line that passes through the center of the target block and that is perpendicular to the partition boundary. The two points may be the center point of the target block and a point on the partition boundary. Below, the term “distance” may refer to ρ.

As illustrated in FIG. 21, θ may be an angle between the bottom line of the target block and the partition boundary. Alternatively, θ may be an angle between the partition boundary and an X axis.

ρ may be the (shortest) distance between a specific location of the target block and the partition boundary.

For example, the specific location may be a bottom-right corner of the target block. The specific location may be the lowermost-rightmost pixel of the target block.

For example, the specific location may be the bottom-left corner of the target block. The specific location may be the lowermost-leftmost pixel of the target block.

Alternatively, ρ may be the distance between two points in a line that passes through the specific location of the target block and that is perpendicular to the partition boundary. The two points may be the specific point of the target block and a point on the partition boundary.

Hereinafter, the term “angle” may refer to θ of FIG. 20 or θ of FIG. 21. The term “distance” may refer to ρ of FIG. 20 or ρ of FIG. 21.

θ may be limited to predefined values. For example, θ may be one of 20 predefined angles.

ρ may be limited to predefined values. For example, ρ may be one of four predefined distances.

The predefined distances may be changed by θ. Alternatively, the predefined distances may be determined based on θ.

The predefined distances may be changed by the size of the target block. Alternatively, the predefined distances may be determined based on the size of the target block.

θ and ρ may be implemented as fixed point values, and may be represented by integers.

### Limitation to Angles and Distances of Geometric Partitioning

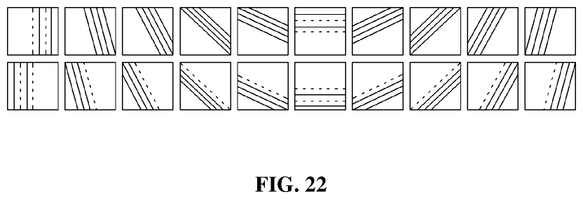

FIG. 22 illustrates the angles and distances of geometric partitioning according to an example.

In FIG. 22, rectangles may refer to blocks. Solid lines or dotted lines in respective rectangles may refer to partition boundaries of geometric partitioning.

In FIG. 22, 20 square blocks for 20 predefined angles are illustrated. In other words, one block may indicate one angle. In each square block, four partition boundaries corresponding to four distances are illustrated as solid lines or dotted lines.

In FIG. 22, the partition boundaries illustrated in one block may represent partition boundaries of partitioning modes for geometric partitioning that can be selected by specific angle θ and ρ to the angle θ.

Each partitioning mode may be a value indicating a partition boundary. Each partitioning mode may be a mode for performing geometric partitioning.

The value of the partitioning mode may indicate a combination of θ and ρ. The specific value of the partitioning mode may indicate a combination of specific θ and specific ρ.

The partitioning mode may be an integer value. In other words, the combination of the specific θ and the specific ρ may be represented by the value of one partitioning mode, and may be signaled between the encoding apparatus 1600 and the decoding apparatus 1700.

A predefined number of partitioning modes of GPM may be determined depending on a limitation of θ and ρ. For example, 80 partitioning modes of GPM may be defined and used depending on 20 predefined angles for the above-described θ and four predefined distances for ρ.

The combination of the specific θ and the specific ρ may be excluded from the partitioning modes of geometric partitioning. For example, such an excluded combination may be a combination overlapping other combinations. Alternatively, such an excluded combination may refer to the same partitioning method as another partitioning method for the target block.

In FIG. 22, each dotted line may indicate the combination of θ and ρ, which is excluded from the partitioning modes of geometric partitioning. By such exclusion, 64 partitioning modes of GPM may be defined and used.

The partitioning modes of GPM may specify the shape of GPM and the partition boundary of GPM. Due to these characteristics, hereinafter, the term “partitioning mode” of GPM may have the same meaning as “shape” of GPM or “partition boundary” of GPM, and the terms “mode”, “partitioning mode”, “shape”, and “partition boundary” may be used interchangeably with each other.

Each partitioning mode of GPM may be indicated by an integer value or an index. Hereinafter, the partitioning mode of GPM may refer to an integer value and/or an index for determining and/or identifying the shape of GPM and/or the partition boundary of GPM.

When representing the combinations of θ and ρ by the values of partitioning modes, which combinations are represented by the values of partitioning modes may be determined based on the distance between the specific point of the target block and the partition boundary.

In an embodiment, when representing the combinations of θ and ρ by the values of partitioning modes, which combinations are represented by the values of partitioning modes may be determined in ascending order of the distance between the specific point of the target block and the partition boundary.

In an embodiment, the ascending order may be replaced with a descending order.

For example, the distance between the specific point of the target block and the partition boundary may refer to ρ.

For example, the specific point may be the center of the target block. The specific point may be the center pixel of the target block.

For example, the specific point may be the bottom-right corner of the target block. The specific point may be the lowermost-rightmost pixel of the target block.

For example, the specific point may be the bottom-left corner of the target block. The specific point may be the lowermost-leftmost pixel of the target block.

For example, as the distance from the specific point of the target block to the partition boundary determined depending on the specific θ and the specific ρ is shorter, the value of the partitioning mode corresponding to the combination of the specific θ and the specific ρ may be smaller.

When the values of ρ in specific combinations are equal to each other, the order of the specific combinations may be determined by the values of 0 in the specific combinations. Here, when 0 of a specific combination is a specific angle, the specific combination may have the lowest order. As the θ of the specific combination is farther away from the specific angle in a specific direction, the specific combination may have a higher order. For example, the specific angle may be 90 degrees. The specific direction may be a counterclockwise or clockwise direction.

In an embodiment, the order of the partitioning modes may be determined based on the distance between a specific boundary and the specific point of the target block.

For example, the specific boundary may be a boundary passing through the center of the target block.

For example, the specific point may be the bottom-right corner of the target block. The specific point may be the lowermost-rightmost pixel of the target block.

For example, the specific point may be the bottom-left corner of the target block. The specific point may be the lowermost-leftmost pixel of the target block.

A center partitioning mode may refer to a partitioning mode in which the boundary corresponding to the partitioning mode passes through the center of the target block.

The parallel partitioning modes of the center partitioning mode may refer to partitioning modes parallel to the center partitioning mode. For example, in FIG. 22, one center partitioning mode and three parallel partitioning modes are depicted in one target block.

For example, the angles θ of the center partitioning mode and the parallel partitioning modes of the center partitioning mode may be identical to each other. The ρ values of the central partitioning mode and the parallel partitioning modes of the central partitioning mode may be different from each other.

The orders of the partitioning modes may start from a set of a center partitioning mode closest to the specific point of the target block and parallel partitioning modes of the center partitioning mode, and may end at a set of a center partitioning mode farthest away from the specific point of the target block and parallel partitioning modes of the center partitioning mode.

For example, as the distance between the specific center partitioning mode and the specific point of the target block is shorter, smaller values may be assigned to the specific center partitioning mode and the parallel partitioning modes of the specific center partitioning mode.

For example, as the distance between the specific center partitioning mode and the specific point of the target block is longer, larger values may be assigned to the specific center partitioning mode and the parallel partitioning modes of the specific center partitioning mode.

For example, when the orders of the specific center partitioning mode and the parallel partitioning modes of the specific center partitioning mode are determined, the smallest value may be assigned to the specific center partitioning mode. A smaller value may be assigned to a parallel partitioning mode closer to the specific center partitioning mode. A larger value may be assigned to a parallel partitioning mode farther from the specific center partitioning mode.

Here, no values may be assigned to partitioning modes indicated by dotted lines in FIG. 22. That is, the partitioning modes indicated by the dotted lines in FIG. 22 are used only to determine the order of the partitioning modes, and may not be actually used in GPM.

### Overlapping Between Subblocks of GPM and Weights of Subblocks

Partitioning in GPM may be conceptual. At least some of regions of subblocks in GPM may overlap each other. Alternatively, the size of the subblocks in GPM may be the same as a target block, but values of 0 may be assigned to some of the total regions of the subblocks.

In an embodiment, in processing procedures by the encoding apparatus 1600 and the decoding apparatus 1700, the sizes of a target block and each subblock may be equal to each other. In this aspect, in embodiments, the terms “subblock”, “intermediate block” and “partitioned region” may be used as the same meaning, and may be used interchangeably with each other.

In an embodiment, a prediction block may be coupling or a combination of a first subblock and a second subblock. The prediction block may be generated by coupling or combining the first subblock and the second subblock.

In an embodiment, when at least a portion of the region of the first subblock and at least a portion of the region of the second subblock overlap each other, a (final) prediction block for the target block may be a weighted sum of the first subblock and the second subblock. The prediction block may be generated by deriving the weighted sum of the first subblock and the second subblock.

The region of the target block may include a first exclusion region and a second exclusion region. For example, the first exclusion region may be a region located to the right of, below, or below-and-to-the-right of the partition boundary. The first exclusion region may be a region including the lowermost-rightmost pixel of the target block. The first exclusion region may include pixels which are located to the right of, below, or below-and-to-the-right of the partition boundary and to which distances from the partition boundary are equal to or greater than a reference value. For example, the second exclusion region may be a region located to the left of, above, or above-and-to-the-left of the partition boundary. The first exclusion region may be a region including the uppermost-leftmost pixel of the target block. The second exclusion region may include pixels which are located to the left of, above, or above-and-to-the-left of the partition boundary and to which distances from the partition boundary are equal to or greater than a reference value.

The weight of the first subblock for the first exclusion region may be 0. In contrast, the weight of the second subblock for the first exclusion region may be 1. Therefore, only the values of the second subblock may be reflected in the first exclusion region in the target block without the values of the first subblock being reflected therein. In this regard, the first subblock may be regarded as being partitioned from the target block so that the first block does not include the first exclusion region.

On the other hand, the weight of the second subblock for the second exclusion region may be 0. In contrast, the weight of the first subblock for the second exclusion region may be 1. Therefore, only the values of the first subblock may be reflected in the second exclusion region in the target block without the values of the second subblock being reflected therein. In this regard, the second block may be regarded as being partitioned from the target block so that the second subblock does not include the second exclusion region.

In a specific pixel of the target block, a first weight of the first subblock for the specific pixel may be k. k may be a natural number that is equal to or greater than 0 and less than or equal to 1. A second weight of the second subblock for the specific pixel may be 1-k.

Alternatively, in the specific pixel of the target block, the sum of the first weight of the first subblock for the specific pixel and the second weight of the second subblock for the specific pixel may be 1.

The first weight and the second weight for each pixel in the target block may be determined based on the partition boundary of GPM. For example, the first weight and the second weight for each pixel in the target block may be determined depending on the distance from the partition boundary of GPM to the corresponding pixel. For example, when the specific pixel of the target block is located at the partition boundary, the first weight and the second weight may be ½.

The partition boundary of GPM may be a basis for determining the first and second weights for each pixel in the target block. The partition boundary of GPM may include pixels for which the weight for the first subblock is ½ and the weight for the second subblock is ½.

When the distance between the specific pixel of the target block and the partition boundary of GPM is equal to or greater than a reference value, one of the first weight and the second weight may be 1, and the other thereof may be 0. In other words, the partition boundary may indicate points at which the value of the first subblock and the value of the second subblock are mixed with each other. The pixel value of the first subblock or the pixel value of the second subblock may be applied to each pixel of the target block to which the distance from the partition boundary is equal to or greater than the reference value.

When the distance between the specific pixel in the target block and the partition boundary of GPM is less than the reference value, the first weight and the second weight may be equal to or greater than 0, and the sum of the first weight and the second weight may be 1. A weighted average of the pixel value of the first subblock and the pixel value of the second subblock may be applied to each pixel of the target block to which the distance from the partition boundary is less than the reference value.

Such GPM and partitioning of the target block depending on GPM may provide more precise prediction for various angles of a partition boundary of an object within an actual image.

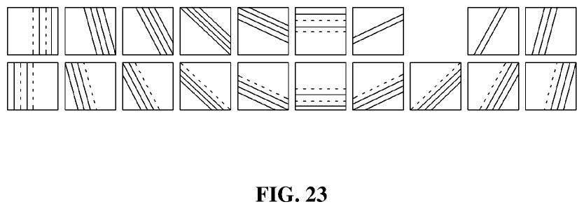

FIG. 23 illustrates a first partitioning mode set according to an example.

Two points at which a partition boundary for partitioning a target block intersects the block boundary of the target block may be referred to as intersection points.

In FIG. 23, partitioning modes in which at least one of the two intersection points is located at the bottom boundary or right boundary of the target block are illustrated.

In other words, in FIG. 23, partitioning modes in which each of the two intersection points is located at one of the left boundary, the top boundary, and four corners of the target block are excluded from all partitioning modes of FIG. 22.

In GPM, a partitioning mode available for specific processing may be limited to one of partitioning modes in which at least one of two intersection points is located at the bottom boundary or the right boundary of the target block.

The first partitioning mode set may indicate partitioning modes in which at least one of two intersection points is located at the bottom boundary or the right boundary of the target block. The first partitioning mode set may indicate the remaining partitioning modes in which partitioning modes, in which each of the two intersection points is located at one of the left boundary, the top boundary, and four corners of the target block, are excluded from all partitioning modes.

The first partitioning mode set may indicate partition boundaries indicated by solid lines in FIG. 23.

The fact that the partitioning modes of the target block are limited to the first partitioning mode set may mean that at least one of the partitioning modes included in the first partitioning mode set is used as the partitioning mode of the target block. Description of the order of the above-described partitioning modes may also be applied to the first partitioning mode set. However, the explained value may not be assigned to partitioning modes that are not included in the first partitioning mode set, and the above-described value may be assigned to the following partitioning modes included in the first partitioning mode set.

In an embodiment, the orders of the partitioning modes in the first partitioning mode set may start from a set of a center partitioning mode closest to the specific point of the target block and parallel partitioning modes of the center partitioning mode, and may end at a set of a center partitioning mode farthest from the specific point of the target block and parallel partitioning modes of the center partitioning mode.

For example, as the distance between the specific center partitioning mode and the specific point of the target block is shorter, smaller values may be assigned to the specific center partitioning mode and the parallel partitioning modes of the specific center partitioning mode.

For example, as the distance between the specific center partitioning mode and the specific point of the target block is longer, larger values may be assigned to the specific center partitioning mode and the parallel partitioning modes of the specific center partitioning mode.

For example, when the orders of the specific center partitioning mode and the parallel partitioning modes of the specific center partitioning mode are determined, the smallest value may be assigned to the specific center partitioning mode. A smaller value may be assigned to a parallel partitioning mode closer to the specific center partitioning mode. A larger value may be assigned to a parallel partitioning mode farther from the specific center partitioning mode.

Here, no values may be assigned to partitioning modes, not illustrated in FIG. 23, and partitioning modes indicated by dotted lines. That is, the partitioning modes (especially, the center partitioning mode), not illustrated in FIG. 23, may also be used to determine the order of the partitioning modes, but the partitioning modes, not illustrated in the drawing, may not be included in the first partitioning mode set. The partitioning modes indicated by the dotted lines in FIG. 23 are used only to determine the order of the partitioning modes, and may not be included in the first partitioning mode set.

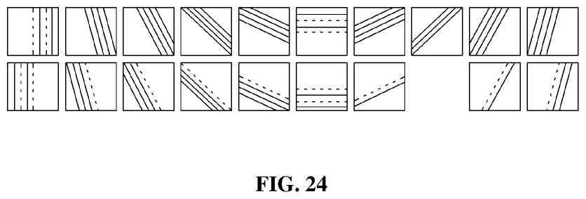

FIG. 24 illustrates a second partitioning mode set according to an example;

In FIG. 24, partitioning modes in which at least one of the two intersection points is located at the top boundary or the left boundary of a target block are illustrated. In other words, in FIG. 24, partitioning modes in which each of the two intersection points is located at one of the right boundary, the bottom boundary, and four corners of the target block are excluded from all partitioning modes of FIG. 22.

In GPM, a partitioning mode available for specific processing may be limited to one of partitioning modes in which at least one of two intersection points is located at the top boundary or the left boundary of the target block.

The second partitioning mode set may indicate partitioning modes in which at least one of two intersection points is located at the bottom boundary or the right boundary of the target block. The second partitioning mode set may indicate the remaining partitioning modes in which partitioning modes, in which each of the two intersection points is located at one of the right boundary, the bottom boundary, and four corners of the target block, are excluded from all partitioning modes.

The second partitioning mode set may indicate partition boundaries indicated by solid lines in FIG. 24.

The fact that the partitioning modes of the target block are limited to the second partitioning mode set may mean that at least one of the partitioning modes included in the second partitioning mode set is used as the partitioning mode of the target block.

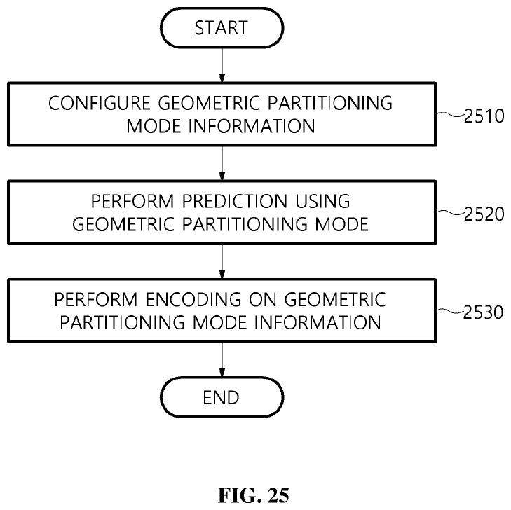

FIG. 25 is a flowchart of an encoding method based on geometric partitioning according to an embodiment.

At step 2510, the processing unit 1610 may configure GPM information about a target block.

The GPM information may include a GPM flag.

The GPM flag may be information indicating whether prediction using GPM is to be performed.

When the GPM flag indicates that prediction using GPM is not to be performed, the remaining processes, excluding a process related to encoding of the GPM information including the GPM flag, among processes at steps 2510, 2520, and 2530, which will be described below, may not be performed.

When the GPM flag indicates that prediction using GPM is to be performed, processes at steps 2510, 2520, and 2530, which will be described below, may be performed.

The processing unit 1610 may determine a first partitioned region and a second partitioned region for the target block.

The first partitioned region may correspond to a first subblock. The first partitioned region may be a region to which prediction using a first predictor is applied.

The second partitioned region may correspond to a second subblock. The second partitioned region may be a region to which prediction using a second predictor is applied.

The prediction information may include the GPM information.

The GPM information may include boundary information. The boundary information may refer to a partitioning mode or a partition boundary of GPM. For example, the boundary information may specify the angle and distance of GPM.

The GPM information may include first partitioned region prediction mode information indicating the prediction mode of the first partitioned region and second partitioned region prediction mode information indicating the prediction mode of a second partitioned region.

The prediction mode of each partitioned region may be intra-prediction, inter-prediction or another prediction described in embodiments.

The first partitioned region prediction mode information may indicate a prediction method for the first partitioned region that is partitioned depending on GPM.

The second partitioned region prediction mode information may indicate a prediction method for second first partitioned region that is partitioned depending on GPM.

The GPM information may include a first prediction mode list for the first partitioned region and a second prediction mode list for the second partitioned region.

The GPM information may include a first index for the first prediction mode list and a second index for the second prediction mode list.

The first prediction mode list may be a list used to perform prediction for the first partitioned region. The second prediction mode list may be a list used to perform prediction for the second partitioned region.

The processing unit 1610 may construct the first prediction mode list and the second prediction mode list for GPM.

The first prediction mode list may include one or more candidates. The second prediction mode list may include one or more candidates. The one or more candidates in the first prediction mode list may be further limited to multiple candidates. The one or more candidates in the second prediction mode list may be further limited to multiple candidates. When intra-prediction is used for the first partitioned region, one or more candidates in the first prediction mode list may be one or more intra-prediction modes.

For example, when intra-prediction is used for the first partitioned region, the processing unit 1610 may determine one or more intra-prediction modes of the first prediction mode list using information about the neighboring block of the target block. The information about the neighboring block may include the intra-prediction mode of the neighboring block.

In embodiments, the terms “neighboring block” and “adjacent block” may be used interchangeably with each other. The neighboring block may be a previously decoded block adjacent to the target block. Also, the neighboring block may be a previously decoded region adjacent to the target block.

For example, the one or more intra-prediction modes of the first prediction mode list may include one or more of intra-prediction modes of one or more neighboring blocks of the target block.

For example, the one or more intra-prediction modes of the first prediction mode list may be determined by a direction derived by changes in the brightness values of pixels in the previously decoded region adjacent to the target block. For example, the one or more intra-prediction modes of the first prediction mode list may include an intra-prediction mode having the same direction as the direction derived by changes in the brightness values of pixels in the previously decoded region adjacent to the target block. For example, the one or more intra-prediction modes of the first prediction mode list may include an intra-prediction mode having a direction similar to the direction derived by changes in the brightness values of pixels in the previously decoded region adjacent to the target block.

In embodiments, the change may denote variation or a gradient.

For example, the one or more intra-prediction modes of the first prediction mode list may be determined based on a correlation degree between the previously decoded region adjacent to the target block and a prediction signal (i.e., a prediction block) generated depending on a specific intra-prediction mode. The one or more intra-prediction modes of the first prediction mode list may include one or more intra-prediction modes in which a prediction signal having a higher correlation degree with the previously decoded region adjacent to the target block is generated.

The intra-prediction mode for the first partitioned region may be the above-described mode related to intra-prediction such as a Most Probable Mode (MPM).

For example, when MPM for the first partitioned region is used, the first prediction mode list may be an MPM list, and candidates in the first prediction mode list may be MPMs in the MPM list.

Alternatively, the first prediction mode list may be the above-described list related to intra-prediction. The candidates in the first prediction mode list may be candidates or elements in the above-described list.

When an inter-prediction mode is used for the first partitioned region, the one or more candidates of the first prediction mode list may be one or more pieces of motion information.

For example, when the inter-prediction mode is used for the first partitioned region, the processing unit 1610 may determine one or more pieces of motion information of the first prediction mode list using information about the neighboring block of the target block. The information about the neighboring block may include motion information of the neighboring block. The motion information may include a motion vector. The motion vector may include multiple motion vectors.

The one or more pieces of motion information of the first prediction mode list may include one or more of pieces of motion information determined for inter-predictions for the neighboring blocks of the target block.

The motion vector of the first prediction mode list may be corrected by the pixel value of a decoded pixel adjacent to the target block and multiple motion vectors. The multiple motion vectors may be the motion vectors of the neighboring blocks of the target block.

A corrected motion vector for the motion vector of the first prediction mode list may indicate a corrected location.

The corrected location may be a location searched from a location referenced by the target block using the motion vector. The search for the corrected location may be performed using a correlation degree at a specific location. The correlation degree at the specific location may be a correlation degree between some of the pixel values of decoded pixels adjacent to the target block and some of the pixel values of decoded pixels adjacent to the specific location.

For example, a location having a higher correlation degree with the target block may be selected from among locations neighboring the location referenced by the target block using the specific motion vector. The corrected motion vector may indicate the selected location. The correlation degree between the target block and the location may be a correlation degree between some of the pixel values of decoded pixels adjacent to the target block and some of the pixel values of decoded pixels adjacent to the specific location.

The corrected motion vector may be determined using a weighted average of the multiple motion vectors of neighboring blocks of the target block.

The inter-prediction mode for the first partitioned region may be the above-described mode related to inter-prediction, such as a merge mode and an Advanced Motion Vector Prediction (AMVP) mode.

For example, when the merge mode is used for the first partitioned region, the first prediction mode list may be a merge list for the merge mode, and candidates in the first prediction mode list may be merge candidates in the merge list.

For example, when the AMVP mode is used for the first partitioned region, the first prediction mode list may be a predictive motion vector candidate list for the AMVP mode, and candidates in the first prediction mode list may be predictive motion vector candidates in the predictive motion vector candidate list.

Alternatively, the first prediction mode list may be the above-described list related to inter-prediction, and candidates in the first prediction mode list may be candidates or elements in the above-described list.

When intra-prediction is used for the second partitioned region, one or more candidates in the second prediction mode list may be one or more intra-prediction modes.

For example, when intra-prediction is used for the second partitioned region, the processing unit 1610 may determine one or more intra-prediction modes of the second prediction mode list using information about the neighboring block of the target block. The information about the neighboring block may include the intra-prediction mode of the neighboring block.

For example, the one or more intra-prediction modes of the second prediction mode list may include one or more of intra-prediction modes of one or more neighboring blocks of the target block.

For example, the one or more intra-prediction modes of the second prediction mode list may be determined by a direction derived by changes in the brightness values of pixels in the previously decoded region adjacent to the target block. For example, the one or more intra-prediction modes of the second prediction mode list may include an intra-prediction mode having the same direction as the direction derived by changes in the brightness values of pixels in the previously decoded region adjacent to the target block. For example, the one or more intra-prediction modes of the second prediction mode list may include an intra-prediction mode having a direction similar to the direction derived by change in the brightness values of pixels in the previously decoded region adjacent to the target block.

For example, the one or more intra-prediction modes of the second prediction mode list may be determined based on a correlation degree between the previously decoded region adjacent to the target block and a prediction signal (i.e., a prediction block) generated depending on a specific intra-prediction mode. The one or more intra-prediction modes of the second prediction mode list may include one or more intra-prediction modes in which a prediction signal having a higher correlation degree with the previously decoded region adjacent to the target block is generated.

The intra-prediction mode for the second partitioned region may be the above-described mode related to intra-prediction, such as an MPM mode.

For example, when MPM for the second partitioned region is used, the second prediction mode list may be an MPM list, and candidates in the second prediction mode list may be MPMs in the MPM list.

Alternatively, the second prediction mode list may be the above-described list related to intra-prediction, and candidates in the second prediction mode list may be candidates or elements in the above-described list.

When an inter-prediction mode is used for the second partitioned region, the one or more candidates of the second prediction mode list may be one or more pieces of motion information.

For example, when the inter-prediction mode is used for the second partitioned region, the processing unit 1610 may determine multiple pieces of motion information of the second prediction mode list using information about the neighboring block of the target block. The information about the neighboring block may include motion information of the neighboring block. The motion information may include a motion vector. The motion vector may include multiple motion vectors.

The one or more pieces of motion information of the second prediction mode list may include one or more of pieces of motion information determined for inter-predictions for the neighboring blocks of the target block.

The motion vector of the second prediction mode list may be corrected by the pixel value of a decoded pixel adjacent to the target block and multiple motion vectors. The multiple motion vectors may be the motion vectors of the neighboring blocks of the target block.

A corrected motion vector for the motion vector of the second prediction mode list may indicate a corrected location.

The corrected location may be a location searched in the location referenced by the target block using the motion vector. The search for the corrected location may be performed using a correlation degree at a specific location. The correlation degree at the specific location may be a correlation degree between some of the pixel values of decoded pixels adjacent to the target block and some of the pixel values of decoded pixels adjacent to the specific location.

For example, a location having a higher correlation degree with the target block may be selected from among locations neighboring the location referenced by the target block using the specific motion vector. The corrected motion vector may indicate the selected location. The correlation degree between the target block and the location may be a correlation degree between some of the pixel values of decoded pixels adjacent to the target block and some of the pixel values of decoded pixels adjacent to the specific location.

The corrected motion vector may be determined using a weighted average of the multiple motion vectors of neighboring blocks of the target block.

The inter-prediction mode for the second partitioned region may be the above-described mode related to inter-prediction, such as a merge mode and an AMVP mode.

For example, when the merge mode is used for the second partitioned region, the second prediction mode list may be a merge list for the merge mode, and candidates in the second prediction mode list may be merge candidates in the merge list.

For example, when the AMVP mode is used for the second partitioned region, the second prediction mode list may be a predictive motion vector candidate list for the AMVP mode, and candidates in the second prediction mode list may be predictive motion vector candidates in the predictive motion vector candidate list.

Alternatively, the second prediction mode list may be the above-described list related to intra-prediction, and candidates in the second prediction mode list may be candidates or elements in the above-described list.

The processing unit 1610 may determine a first index for the first prediction mode list and a second index for the second prediction mode list.

The first index may indicate a candidate to be used for the first partitioned region among one or more candidates in the first prediction mode list.

For example, when MPM is used for the first partitioned region, the first index may be an MPM indicator.

For example, when the merge mode is used for the first partitioned region, the first index may be a merge index.

For example, when the AMVP mode is used for the first partitioned region, the first index may be a predictive motion vector index.

The second index may indicate a candidate to be used for the second partitioned region among one or more candidates in the second prediction mode list.

For example, when MPM is used for the second partitioned region, the second index may be an MPM indicator.

For example, when the merge mode is used for the second partitioned region, the second index may be a merge index.

For example, when the AMVP mode is used for the second partitioned region, the second index may be a predictive motion vector index.

At step 2520, the processing unit 1610 may perform GPM prediction for the target block using GPM information.

The processing unit 1610 may generate a first sub-prediction block by performing first prediction for the first partitioned region.

The first prediction may be inter-prediction or intra-prediction. The first prediction may be prediction in the specific mode, described above in the embodiments.

The information used in the first prediction may correspond to the GPM information.

For example, when the prediction mode for the first prediction is MPM, the intra-prediction mode for the first prediction may be identical to an MPM candidate indicated by the MPM indicator among MPM candidates in the MPM list.

For example, when the prediction mode for the first prediction is a merge mode, the motion information for the first prediction may be identical to a merge candidate indicated by the merge index among merge candidates in the merge list.

For example, when the prediction mode for the first prediction is an AMVP mode, the motion information of the first prediction may be identical to the sum of a predictive motion vector candidate and a Motion Vector Difference (MVD). Here, the predictive motion vector candidate may be indicated by a predictive motion vector index among predictive motion vector candidates in the predictive motion vector candidate list.

The processing unit 1610 may generate a second sub-prediction block by performing second prediction for the second partitioned region.

The second prediction may be inter-prediction or intra-prediction. The second prediction may be prediction in the specific mode, described above in the embodiments.

The information used in the second prediction may correspond to the GPM information.

For example, when the prediction mode for the second prediction is MPM, the intra-prediction mode for the second prediction may be identical to an MPM candidate indicated by the MPM indicator among MPM candidates in the MPM list.

For example, when the prediction mode for the second prediction is a merge mode, the motion information for the second prediction may be identical to a merge candidate indicated by the merge index among merge candidates in the merge list.

For example, when the prediction mode for the second prediction is an AMVP mode, the motion information of the second prediction may be identical to the sum of a predictive motion vector candidate and a Motion Vector Difference (MVD). Here, the predictive motion vector candidate may be indicated by a predictive motion vector index among predictive motion vector candidates in the predictive motion vector candidate list.

The processing unit 1610 may generate a (final) prediction block for the target block using the first sub-prediction block and the second sub-prediction block.

At step 2530, the processing unit 1610 may generate encoded GPM information by performing encoding on the GPM information. Encoding may be entropy encoding.

For example, the GPM information may include prediction mode information. The encoded GPM information may include encoded prediction mode information.

For example, the GPM information may include a prediction mode difference. The encoded GPM information may include an encoded prediction mode difference.

The prediction mode difference may be the difference between the prediction mode for the target block and a derived prediction mode. The derived prediction mode may be determined based on the blocks adjacent to the target block, specific coding parameters of the adjacent blocks, and/or a partition boundary. In other words, the prediction mode for the target block may be the sum of the derived prediction mode and the prediction mode difference.

For example, the encoded GPM information may include encoded first partitioned region prediction mode information and encoded second partitioned region prediction mode information. The GPM information may include first partitioned region prediction mode information and second partitioned region prediction mode information.

For example, the encoded GPM information may include an encoded first partitioned region prediction mode difference and an encoded second partitioned region prediction mode difference. The GPM information may include a first partitioned region prediction mode difference and a second partitioned region prediction mode difference.

The first partitioned region prediction mode difference may be the difference between a first partitioned region prediction mode and the derived prediction mode. The derived prediction mode may be determined based on blocks adjacent to the target block (or the first partitioned region), specific coding parameters of the adjacent blocks, and/or a partition boundary. In other words, the first partitioned region prediction mode may be the sum of the derived prediction mode and the first partitioned region prediction mode difference.

The second partitioned region prediction mode difference may be the difference between a second partitioned region prediction mode and the derived prediction mode. The derived prediction mode may be determined based on blocks adjacent to the target block (or the second partitioned region), specific coding parameters of the adjacent blocks, and/or a partition boundary. In other words, the second partitioned region prediction mode may be the sum of the derived prediction mode and the second partitioned region prediction mode difference.

For example, the encoded GPM information may include encoded first partitioned region prediction mode information and an encoded partitioned region prediction mode difference. The GPM information may include first partitioned region prediction mode information and a partitioned region prediction mode difference.

The partitioned region prediction mode difference may be the difference between the first partitioned region prediction mode information and the second partitioned region prediction mode information. In other words, the second partitioned region prediction mode information may be the sum of the first partitioned region prediction mode information and the partitioned region prediction mode difference.

For example, the GPM information may include an index for the prediction mode list. The encoded GPM information may include an encoded index for the prediction mode list.

For example, the GPM information may include an index difference. The encoded GPM information may include an encoded index difference.

The index difference may be the difference between the index for the target block and a derived index. The derived index may be determined based on the blocks adjacent to the target block, specific coding parameters of the adjacent blocks, and/or the partition boundary. In other words, the index for the target block may be the sum of the derived index and the index difference.

For example, the GPM information may include a first partitioned region index and a second partitioned region index. The encoded GPM information may include an encoded first index and an encoded second partitioned region index.

For example, the GPM information may include a first partitioned region index difference and a second partitioned region index difference. The encoded GPM information may include an encoded first partitioned region index difference and an encoded second partitioned region index difference.

The first partitioned region index difference may be the difference between a first index for a first prediction mode list and a derived index. The derived index may be determined based on the blocks adjacent to the target block (or the first partitioned region), specific coding parameters of the adjacent blocks, and/or a partition boundary. In other words, the first index for the first prediction mode list may be the sum of the derived index and the first partitioned region index difference.

The second partitioned region index difference may be the difference between a second index for a second prediction mode list and a derived index. The derived index may be determined based on the blocks adjacent to the target block (or the second partitioned region), specific coding parameters of the adjacent blocks, and/or a partition boundary. In other words, the second index for the second prediction mode list may be the sum of the derived index and the second partitioned region index difference.

For example, the GPM information may include a first partitioned region index and an index difference. The encoded GPM information may include an encoded first partitioned region index and an encoded index difference.

The index difference may be the difference between the first index for the first prediction mode list and the second index for the second prediction mode list. In other words, the second index for the second prediction mode list may be the sum of the first index for the first prediction mode list and the index difference.

As described above, the GPM information may include the prediction mode for the first partitioned region and the first index for the first prediction mode list.

When the prediction mode for the first partitioned region is intra-prediction and the intra-prediction mode for the first partitioned region is a directional intra-prediction mode, the GPM information may include an offset. The encoded GPM information may include an encoded offset.

In an embodiment, a partition boundary of the target block may be perpendicular to the direction of the intra-prediction mode for the first partitioned region. Further, the partition boundary of the target block may be a straight line passing through a location spaced apart from the specific point of the target block by the number of pixels corresponding to the offset. In other words, the offset may represent the distance between the specific point of the target block and the partition boundary by the unit of pixels.

For example, the specific point may be the center, the top-left, the top-right, the bottom-left or the bottom-right of the block. Alternatively, the specific point may be the center pixel, the uppermost-leftmost pixel, the uppermost-rightmost pixel, the lowermost-leftmost pixel, or the lowermost-rightmost pixel of the block.

In an embodiment, the partition boundary of the target block may be parallel to the direction of the intra-prediction mode for the first partitioned region. Further, the partition boundary of the target block may be a straight line passing through a location spaced apart from the specific point of the target block by the number of pixels corresponding to the offset. In other words, the offset may represent the distance between the specific point of the target block and the partition boundary by the unit of pixels.

For example, the specific point may be the center, the top-left, the top-right, the bottom-left or the bottom-right of the block. Alternatively, the specific point may be the center pixel, the uppermost-leftmost pixel, the uppermost-rightmost pixel, the lowermost-leftmost pixel, or the lowermost-rightmost pixel of the block.

When the prediction mode of the first partitioned region is intra-prediction and the prediction mode of the second partitioned region is intra-prediction, an intra-prediction mode difference may be used to determine the second intra-prediction mode for the second partitioned region. Here, the GPM information may include a first intra-prediction mode and the intra-prediction mode difference. The encoded GPM information may include an encoded first intra-prediction mode and an encoded intra-prediction mode difference.

The first intra-prediction mode may be an intra-prediction mode for the first partitioned region. The second intra-prediction mode may be an intra-prediction mode for the second partitioned region.

The intra-prediction mode difference may be the difference between the first intra-prediction mode and the second intra-prediction mode. In other words, the second intra-prediction mode may be the sum of the first intra-prediction mode and the intra-prediction mode difference.

In other words, when the prediction mode of the first partitioned region is intra-prediction and the prediction mode of the second partitioned region is intra-prediction, the intra-prediction mode difference may be signaled instead of the second intra-prediction mode of the second partitioned region.

The first intra-prediction mode and the second intra-prediction mode may be derived from a reconstructed region adjacent to the target block. The reconstructed region may refer to a neighboring block.

The first intra-prediction mode and the second intra-prediction mode may be two intra-prediction modes derived from the reference region of the reconstructed region adjacent to the target block. The reference region may be composed of n reference lines. n may be an integer of 1 or more.

The intra-prediction modes derived from the reference region may be determined based on the direction in which the brightness values of pixels are changed in the reference region. For example, the directions of the intra-prediction modes derived from the reference region may be horizontal to the direction in which the brightness values of the pixels are changed in the reference region. The directions of the intra-prediction modes derived from the reference region may be vertical to the direction in which the brightness values of the pixels are changed in the reference region.

The intra-prediction mode derived from the reference region may be an intra-prediction mode in which a block most similar to the reference region is generated among intra-prediction modes derived from a reconstructed uppermost pixel line or a reconstructed rightmost pixel line of the reference region. Here, the block may be a reconstructed block or a prediction block.

The reference region of the reconstructed region may be a region in the neighboring block. Alternatively, the reference region of the reconstructed region may refer to reference lines of the neighboring block. The reconstructed pixel lines of the reference region may refer to reference lines of the neighboring block.

The above-described first intra-prediction mode may be included in a first prediction mode list. For example, the first prediction mode list may be constructed to include the first intra-prediction mode.

The above-described second intra-prediction mode may be included in a second prediction mode list. For example, the second prediction mode list may be constructed to include the second intra-prediction mode.

In order to perform entropy encoding, a fixed-length binarization method may be applied to the characteristic information of the GPM information.

In order to perform entropy encoding, a truncated-unary binarization method may be applied to the characteristic information of the GPM information.

In order to perform entropy encoding, an n-th exponential-Golomb binarization method may be applied to the characteristic information of the GPM information. n may be an integer of 0 or more. The processing unit 1610 may perform encoding on at least a part of the GPM information. In embodiments, the above-described lists may be generated by the encoding apparatus 1600 and the decoding apparatus 1700 in the same manner. Therefore, the above-described lists and candidates in the lists may not be the target of encoding.

A bitstream generated by the encoding apparatus 1600 may include the encoded GPM information.

The processing unit 1610 may store the bitstream in the memory 1630.

The communication unit 1620 may transmit the bitstream to the decoding apparatus 1700.

Step 2510 may include a part of step 1810. Step 2520 may include a part of step 1820. Step 2530 may include a part of step 1830.

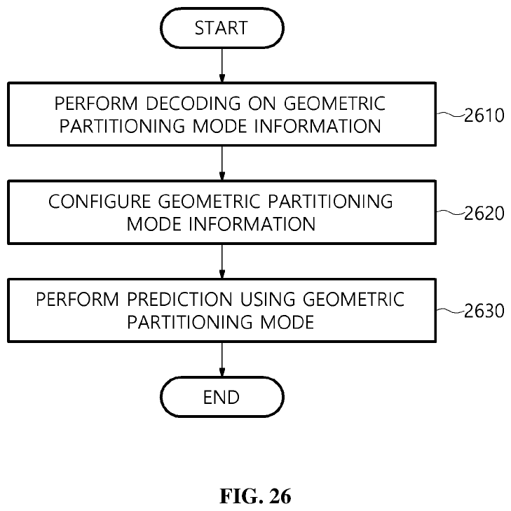

FIG. 26 is a flowchart of a decoding method based on geometric partitioning according to an embodiment.

At step 2610, the processing unit 1710 may acquire a bitstream.

The processing unit 1710 may read the bitstream from the memory 1730.

The communication unit 1720 may receive the bitstream from the encoding apparatus 1600.

The bitstream may include encoded GPM information.

The processing unit 1710 may generate GPM information by performing decoding on the encoded GPM information. Decoding may be entropy decoding.

For example, the encoded GPM information may include encoded prediction mode information. The GPM information may include prediction mode information.

For example, the encoded GPM information may include an encoded prediction mode difference. The GPM information may include a prediction mode difference.

The prediction mode difference may be the difference between a prediction mode for a target block and a derived prediction mode. The derived prediction mode may be determined based on blocks adjacent to the target block, specific coding parameters of the adjacent blocks, and/or a partition boundary. In other words, the prediction mode for the target block may be the sum of the derived prediction mode and the prediction mode difference.

For example, the encoded GPM information may include encoded first partitioned region prediction mode information and encoded second partitioned region prediction mode information. The GPM information may include first partitioned region prediction mode information and second partitioned region prediction mode information.

For example, the encoded GPM information may include an encoded first partitioned region prediction mode difference and an encoded second partitioned region prediction mode difference. The GPM information may include a first partitioned region prediction mode difference and a second partitioned region prediction mode difference.

The first partitioned region prediction mode difference may be the difference between a first partitioned region prediction mode and the derived prediction mode. The derived prediction mode may be determined based on blocks adjacent to the target block (or the first partitioned region), specific coding parameters of the adjacent blocks, and/or a partition boundary. In other words, the first partitioned region prediction mode may be the sum of the derived prediction mode and the first partitioned region prediction mode difference.

The second partitioned region prediction mode difference may be the difference between a second partitioned region prediction mode and the derived prediction mode. The derived prediction mode may be determined based on blocks adjacent to the target block (or the second partitioned region), specific coding parameters of the adjacent blocks, and/or a partition boundary. In other words, the second partitioned region prediction mode may be the sum of the derived prediction mode and the second partitioned region prediction mode difference.

For example, the encoded GPM information may include encoded first partitioned region prediction mode information and an encoded partitioned region prediction mode difference. The GPM information may include first partitioned region prediction mode information and a partitioned region prediction mode difference.

The partitioned region prediction mode difference may be the difference between the first partitioned region prediction mode information and the second partitioned region prediction mode information. In other words, the second partitioned region prediction mode information may be the sum of the first partitioned region prediction mode information and the partitioned region prediction mode difference.

For example, the encoded GPM information may include an encoded index for the prediction mode list. The GPM information may include an index for the prediction mode list.

For example, the encoded GPM information may include an encoded index difference. The GPM information may include an index difference.

The index difference may be the difference between the index for the target block and the derived index. The derived index may be determined based on the blocks adjacent to the target block, specific coding parameters of the adjacent blocks, and/or the partition boundary. In other words, the index for the target block may be the sum of the derived index and the index difference.

For example, the encoded GPM information may include an encoded first index and an encoded second partitioned region index. The GPM information may include a first partitioned region index and a second partitioned region index.

For example, the encoded GPM information may include an encoded first partitioned region index difference and an encoded second partitioned region index difference. The GPM information may include a first partitioned region index difference and a second partitioned region index difference.

The first partitioned region index difference may be the difference between a first index for a first prediction mode list and a derived index. The derived index may be determined based on the blocks adjacent to the target block (or the first partitioned region), specific coding parameters of the adjacent blocks, and/or a partition boundary. In other words, the first index for the first prediction mode list may be the sum of the derived index and the first partitioned region index difference.

The second partitioned region index difference may be the difference between a second index for a second prediction mode list and a derived index. The derived index may be determined based on the blocks adjacent to the target block (or the second partitioned region), specific coding parameters of the adjacent blocks, and/or a partition boundary. In other words, the second index for the second prediction mode list may be the sum of the derived index and the second partitioned region index difference.

For example, the encoded GPM information may include an encoded first partitioned region index and an encoded index difference. The GPM information may include a first partitioned region index and an index difference.

The index difference may be the difference between the first index for the first prediction mode list and the second index for the second prediction mode list. In other words, the second index for the second prediction mode list may be the sum of the first index for the first prediction mode list and the index difference.

As described above, the GPM information may include the prediction mode for the first partitioned region and the first index for the first prediction mode list.

When the prediction mode for the first partitioned region is intra-prediction and the intra-prediction mode for the first partitioned region is a directional intra-prediction mode, the encoded GPM information may include an encoded offset. The GPM information may include an offset.

In an embodiment, a partition boundary of the target block may be perpendicular to the direction of the intra-prediction mode for the first partitioned region.

Further, the partition boundary of the target block may be a straight line passing through a location spaced apart from the specific point of the target block by the number of pixels corresponding to the offset. In other words, the offset may represent the distance between the specific point of the target block and the partition boundary by the unit of pixels.

For example, the specific point may be the center, the top-left, the top-right, the bottom-left or the bottom-right of the block. Alternatively, the specific point may be the center pixel, the uppermost-leftmost pixel, the uppermost-rightmost pixel, the lowermost-leftmost pixel, or the lowermost-rightmost pixel of the block.

In an embodiment, the partition boundary of the target block may be parallel to the direction of the intra-prediction mode for the first partitioned region. Further, the partition boundary of the target block may be a straight line passing through a location spaced apart from the specific point of the target block by the number of pixels corresponding to the offset. In other words, the offset may represent the distance between the specific point of the target block and the partition boundary by the unit of pixels.

For example, the specific point may be the center, the top-left, the top-right, the bottom-left or the bottom-right of the block. Alternatively, the specific point may be the center pixel, the uppermost-leftmost pixel, the uppermost-rightmost pixel, the lowermost-leftmost pixel, or the lowermost-rightmost pixel of the block.

When the prediction mode for the first partitioned region is intra-prediction and the prediction mode for the second partitioned region is intra-prediction, an intra-prediction mode difference may be used to determine the second intra-prediction mode for the second partitioned region. Here, the encoded GPM information may include an encoded first intra-prediction mode and an encoded intra-prediction mode difference. The GPM information may include a first intra-prediction mode and the intra-prediction mode difference.

The first intra-prediction mode may be an intra-prediction mode for the first partitioned region. The second intra-prediction mode may be an intra-prediction mode for the second partitioned region.

The intra-prediction mode difference may be the difference between the first intra-prediction mode and the second intra-prediction mode. In other words, the second intra-prediction mode may be the sum of the first intra-prediction mode and the intra-prediction mode difference.

In other words, when the prediction mode of the first partitioned region is intra-prediction and the prediction mode of the second partitioned region is intra-prediction, the intra-prediction mode difference may be signaled instead of the second intra-prediction mode of the second partitioned region.

The first intra-prediction mode and the second intra-prediction mode may be derived from a reconstructed region adjacent to the target block. The reconstructed region may refer to a neighboring block.

The first intra-prediction mode and the second intra-prediction mode may be two intra-prediction modes derived from the reference region of the reconstructed region adjacent to the target block. The reference region may be composed of n reference lines. n may be an integer of 1 or more.

The intra-prediction modes derived from the reference region may be determined based on the direction in which the brightness values of pixels are changed in the reference region. For example, the directions of the intra-prediction modes derived from the reference region may be horizontal to the direction in which the brightness values of the pixels are changed in the reference region. The directions of the intra-prediction modes derived from the reference region may be vertical to the direction in which the brightness values of the pixels are changed in the reference region.

The intra-prediction mode derived from the reference region may be an intra-prediction mode in which a block most similar to the reference region is generated among intra-prediction modes derived from the uppermost reconstructed pixel line or the rightmost reconstructed pixel line of the reference region. Here, the block may be a reconstructed block or a prediction block.

The reference region of the reconstructed region may be a region in the neighboring block. Alternatively, the reference region of the reconstructed region may refer to reference lines of the neighboring block. The reconstructed pixel lines of the reference region may refer to reference lines of the neighboring block.

The above-described first intra-prediction mode may be included in a first prediction mode list. For example, the first prediction mode list may be constructed to include the first intra-prediction mode.

The above-described second intra-prediction mode may be included in a second prediction mode list. For example, the second prediction mode list may be constructed to include the second intra-prediction mode.

In order to perform entropy decoding, a fixed-length binarization method may be applied to the characteristic information of the GPM information.

In order to perform entropy decoding, a truncated-unary binarization method may be applied to the characteristic information of the GPM information.

In order to perform entropy decoding, an n-th exponential-Golomb binarization method may be applied to the characteristic information of the GPM information. n may be an integer of 0 or more.

The processing unit 1710 may perform decoding on at least a part of encoded GPM information. In embodiments, the above-described lists may be generated by the encoding apparatus 1600 and the decoding apparatus 1700 in the same manner. Therefore, the above-described lists and candidates in the lists may not be the target of decoding.

The GPM information may include a GPM flag.

The GPM flag may be information indicating whether prediction using GPM is to be performed.

When the GPM flag indicates that prediction using GPM is not to be performed, processes at steps 2620 and 2630, which will be described below, may not be performed.

When the GPM flag indicates that prediction using GPM is to be performed, processes at steps 2620 and 2630, which will be described below, may be performed.

At step 2620, the processing unit 1710 may configure GPM information about the target block.

Description made with reference to step 2510 may also be applied to step 2620. Repetitive descriptions will be omitted here.

The prediction information may include the GPM information.

The GPM information may include boundary information. The boundary information may refer to a partitioning mode or a partition boundary of GPM. For example, the boundary information may specify the angle and distance of GPM.

The GPM information may include first partitioned region prediction mode information indicating the prediction mode of the first partitioned region and second partitioned region prediction mode information indicating the prediction mode of a second partitioned region.

The prediction mode for each partitioned region may be intra-prediction, inter-prediction or another prediction mode described in embodiments.

The first partitioned region prediction mode information may indicate a prediction method for the first partitioned region that is partitioned depending on GPM.

The second partitioned region prediction mode information may indicate a prediction method for second first partitioned region that is partitioned depending on GPM.

The processing unit 1710 may determine the first partitioned region and the second partitioned region for the target block using boundary information of the GPM information.

The processing unit 1710 may construct the first prediction mode list and the second prediction mode list for GPM.

When an inter-prediction mode is used for the first partitioned region, the one or more candidates of the first prediction mode list may be one or more pieces of motion information.

For example, when the inter-prediction mode is used for the first partitioned region, the processing unit 1710 may determine one or more pieces of motion information of the first prediction mode list using information about the neighboring block of the target block. The information about the neighboring block may include motion information of the neighboring block. The motion information may include a motion vector. The motion vector may include multiple motion vectors.

When intra-prediction is used for the second partitioned region, one or more candidates in the second prediction mode list may be one or more intra-prediction modes.

For example, when intra-prediction is used for the second partitioned region, the processing unit 1710 may determine one or more intra-prediction modes of the second prediction mode list using information about the neighboring block of the target block. The information about the neighboring block may include the intra-prediction mode of the neighboring block.

When an inter-prediction mode is used for the second partitioned region, the one or more candidates of the second prediction mode list may be one or more pieces of motion information.

For example, when the inter-prediction mode is used for the second partitioned region, the processing unit 1710 may determine one or more pieces of motion information of the second prediction mode list using information about the neighboring block of the target block. The information about the neighboring block may include motion information of the neighboring block. The motion information may include a motion vector. The motion vector may include multiple motion vectors.

The one or more pieces of motion information of the second prediction mode list may include one or more of pieces of motion information determined for inter-predictions for the neighboring blocks of the target block.

The processing unit 1710 may determine a first index for the first prediction mode list and a second index for the second prediction mode list using the GSM information.

For example, the GPM information may include a first index for the first prediction mode list and a second index for the second prediction mode list.

At step 2630, the processing unit 1710 may perform GPM prediction for the target block using GPM information.

Description made with reference to step 2520 may also be applied to step 2630. Repetitive descriptions will be omitted here.

The processing unit 1710 may generate a first sub-prediction block by performing first prediction for the first partitioned region using the GPM information.

The first prediction may be inter-prediction or intra-prediction. The first prediction may be prediction in the specific mode, described above in the embodiments.

The processing unit 1710 may generate a first sub-prediction block by performing first prediction using a candidate indicated by the first index among the candidates in the first prediction mode list.

The processing unit 1710 may generate a second sub-prediction block by performing second prediction for the second partitioned region using the GPM information.

The second prediction may be inter-prediction or intra-prediction. The second prediction may be prediction in the specific mode, described above in the embodiments.

The processing unit 1710 may generate a second sub-prediction block by performing second prediction using a candidate indicated by the second index among the candidates in the second prediction mode list.

The processing unit 1710 may generate a (final) prediction block for the target block using the first sub-prediction block and the second sub-prediction block.

Step 2610 may include a part of step 1910. Step 2620 may include a part of step 1920. Step 2630 may include a part of step 1930.

### Selective Performance of GPM

In an embodiment, prediction using GPM described in embodiments may be selectively used only when a specific condition is satisfied. When the specific condition is not satisfied, prediction using GPM, described in embodiments, may not be used.

In an embodiment, prediction using GPM may refer to prediction using at least some of steps 2510 to 2530. Further, prediction using GPM may refer to prediction using at least some of steps 2610 to 2630.

For example, prediction using GPM may refer to encoding of the GPM information at step 2530 or decoding of the GPM information at step 2610.

In an embodiment, prediction using GPM may be selectively performed only when a specific condition related to the target block is satisfied.

For example, the specific condition may be a condition related to the coding parameter of the target block.

For example, whether prediction using GPM is to be performed may be determined depending on whether the value of the specific coding parameter of the target block is a specific value.

For example, whether prediction using GPM is to be performed may be determined depending on a combination of the values of specific coding parameters of the target block.

Here, prediction using GPM may be limited to prediction that uses intra-prediction for at least one of the first sub-prediction block and the second sub-prediction block. Hereinafter, GPM for intra-prediction may refer to GPM that uses intra-prediction for at least one of the first sub-prediction block and the second sub-prediction block.

For example, prediction using GPM for intra-prediction may be performed only when the horizontal length or the vertical length of the target block is equal to or greater than a first reference value. The first reference value may be 8.

For example, prediction using GPM for intra-prediction may be performed only when the horizontal length or the vertical length of the target block is less than or equal to a second reference value. The second reference value may be 128.

### Entropy Encoding for Geometric Partitioning Mode Information and Geometric Partitioning Mode

A partitioning mode for the target block may be determined by a GPM index indicating one of multiple candidate partitioning modes.

GPM information may include the GPM index. The GPM index may indicate one of multiple candidate partitioning modes as the partitioning mode for the target block.

The number of multiple candidate partitioning modes may be N. N may be a positive integer. For example, N may be 4, 8, 16 or 32.

A partitioning mode list including multiple candidate partitioning modes may be constructed. The partitioning mode list may be constructed by selecting N partitioning modes from among multiple available partitioning modes as multiple candidate partitioning modes. The number of multiple available partitioning modes may be greater than N.

At least some of multiple candidate partitioning modes stored in the partitioning mode list may be determined based on 1) an intra-prediction mode for a block or a region adjacent to the target block, 2) the direction of the intra-prediction mode, or 3) the pixel values of pixels in the block or region. At least some of the multiple candidate modes stored in the partitioning mode list may be determined based on changes in the pixel values of the pixels in the block or region adjacent to the target block.

In embodiments, the block or the region may be a reconstructed block or a reconstructed region.

For example, partitioning modes having an angle identical or similar to the direction of the intra-prediction mode of a block adjacent to the target block may be added to the partitioning mode list.

In embodiments, the fact that the direction of the intra-prediction mode and the angle of the partitioning mode are similar to each other may mean that the difference between the angle of the direction of the intra-prediction mode and the angle of the partition boundary of the partitioning mode is within a reference value.

In embodiments, the angle of the specific direction may be an angle between the specific direction and a horizontal axis of an image coordinate system.

In embodiments, the angle of the specific partitioning mode may be the angle of the partition boundary of the specific partitioning mode.

In embodiments, the angle of a specific partition boundary may be an angle between the angle of the specific partition boundary determined by GPM and the horizontal axis of the image coordinate system.

In embodiments, the fact that the specific direction is identical to the angle of the specific partition boundary may mean that a first angle with respect to the specific direction and a second angle with respect to the specific partition boundary are identical to each other. The first angle may be an angle between the specific direction and the horizontal axis of the image coordinate system. The second angle may be an angle between the angle of the specific partition boundary determined by GPM and the horizontal axis of the image coordinate system.

In embodiments, the fact that the specific direction is similar to the angle of the specific partition boundary may mean that a first angle in the specific direction and a second angle of the specific partition boundary are similar to each other. The first angle may be an angle between the specific direction and the horizontal axis of the image coordinate system. The second angle may be an angle between the angle of the specific partition boundary determined by GPM and the horizontal axis of the image coordinate system.

A value indicating the angle corresponding to the partitioning mode of GPM may be predefined in a data structure such as a table, an array, and a list.

Multiple partition boundaries of multiple partitioning modes and the angles of the multiple partition boundaries may be determined by GPM.

The data structure may include multiple elements. The element values of the elements may indicate angles corresponding to the partitioning modes of GPM. A value indicating an angle corresponding to each of the multiple partitioning modes may be predefined as the element value of an element in the data structure.

The first value may indicate a first angle of the specific target. A second element in the data structure may have a predefined second element value indicating a second angle. When the first value is mapped to the second element in the data structure, it may be considered that the first angle indicated by the first value is equal to the second angle.

In other words, an angle equal to the second angle indicated by the second element value may denote values mapped to the second element in the data structure.

The first value may indicate the first angle of the specific target. The second element in the data structure may have a predefined second value indicating the second angle.

When the first value is mapped to element(s) adjacent to the second element in the data structure, it may be considered that the first angle indicated by the first value is similar to the second angle.

In other words, an angle similar to the second angle indicated by the second element value may denote values mapped to element(s) adjacent to the second element in the data structure.

A third value may indicate a third angle of a third target. A fourth value may indicate a fourth angle of a fourth target. When the third value and the fourth value are mapped to the same element in the data structure, the third angle indicated by the third value and the fourth angle indicated by the fourth value may be equal to each other.

The third value may indicate the third angle of the third target. The fourth value may indicate the fourth angle of the fourth target. When the third value and the fourth value are mapped to adjacent elements in the data structure, the third angle indicated by the third value and the fourth angle indicated by the fourth value may be similar to each other.

For example, partitioning modes having an angle identical or similar to a direction vertical to the direction of the intra-prediction mode of a block adjacent to the target block may be added to a partitioning mode list.

For example, one or more partitioning modes having an angle identical or similar to a brightness change direction may be added to the partitioning mode list. The brightness change direction may be defined by the difference between the pixel values of pixels in the block or the region.

For example, one or more partitioning modes having an angle identical or similar to a direction vertical to the brightness change direction may be added to the partitioning mode list.

One or more partitioning modes may be added to the partitioning mode list using a template region. The template region may be a specific region adjacent to the target block.

The template region of the target block may also be called a target template.

For the template region, error cost for a specific partitioning mode of GPM may be calculated.

The template region may be partitioned depending on the specific partitioning mode. The template region may be partitioned by the extended partition boundary of the specific partitioning mode of GPM. The extended partition boundary may be a partition boundary extending to the template region. The fact that the template region is partitioned depending on the specific partitioning mode of GPM may mean that the template region is partitioned along the extended partition boundary of the specific partitioning mode.

The template region is partitioned depending on the specific partitioning mode, whereby two partitioned template regions may be determined.

The error cost for the specific partitioning mode may be determined by applying predictions to the partitioned template regions which are determined by partitioning the template region depending on the specific partitioning mode. The predictions may include inter-prediction and intra-prediction.

When the template region is partitioned using multiple available partitioning modes of GPM, M partitioning modes may be added to the partitioning mode list in ascending order of error cost among the multiple available partitioning modes. In other words, M partitioning modes having the lowest error cost among the multiple available partitioning modes may be added to the partitioning mode list. M may be an integer that is equal to or greater than 1 and less than or equal to N.

In embodiments, the error cost may be a value derived by the difference between one or more pixel values in comparison targets. The pixel value difference may be the difference between the pixel values of corresponding pixels in the comparison targets.

For example, the corresponding pixels may be pixels having the same coordinates in the comparison targets.

For example, the error cost may be calculated using a method, such as the Sum of Absolute Difference (SAD), the Sum of Absolute Error (SAE), the Sum of Squared Difference (SSD), the Sum of Squared Error (SSE), the Mean Absolute Difference (MAD), the Mean Absolute Error (MAD), the Mean Squared Difference (MSD), the Mean Squared Error (MSE), the Mean Removed Sum of Absolute Difference (MR-SAD), or the Sum of Absolute Transformed Difference (SATD).

Each of the SAD and SAE may be the sum of absolute differences. Each of the absolute differences may be the absolute difference between corresponding pixels.

Each of the MAD and MAE may be the mean of absolute differences. Each of the absolute differences may be the absolute difference between corresponding pixels.

Each of the SSD and SSE may be the sum of squares of the differences. Each of the differences may be the difference between corresponding pixels.

Each of the MSD and MSE may be the mean of squares of the differences. Each of the differences may be the difference between corresponding pixels.

The MR-SAD may be the sum of absolute differences from which mean values are removed. Each of the absolute differences may be the absolute difference between corresponding pixels.

The SATD may be the sum of the differences in a transform domain. Each of the differences may be the difference between corresponding pixels.

In embodiments, the differences or the absolute differences may be the differences or absolute differences between all pixel pairs in the comparison targets. The pixel pairs may be corresponding pixels in the comparison targets.

### Prediction for Template Region

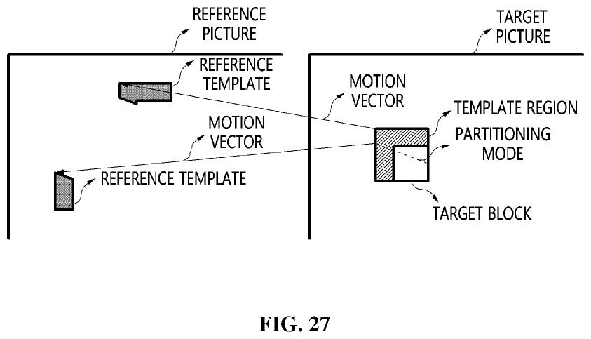

FIG. 27 illustrates inter-prediction for a template region according to an example.

The template region may be a specific region adjacent to a target block. The template region may be a portion of a reconstructed region adjacent to the target block.

For example, the template region may include 1) a first block adjacent to the top of the target block, 2) a second block diagonally adjacent to the top-left of the target block, and 3) a third block adjacent to the right of the target block. When the coordinates of the top-left of the target block are (xₜ, yₜ), the horizontal length of the target block is w, and the vertical length of the target block is h, the coordinates of the top-left of the first block may be (xₜ, yₜ-n₁). The width of the first block may be w. The height of the first block may be n₁. The coordinates of the top-left of the second block may be (xₜ-n₂, yₜ-n₁). The width of the second block may be n. The height of the second block may be n. The coordinates of the top-left of the third block may be (xₜ-n₂, yₜ). The width of the third block may be n. The height of the third block may be h. n may be an integer of 1 or more. n₂ may be an integer of 1 or more. n₁ and n₂ may be equal to each other.

For example, the template region may be the remaining region excluding the region of the target block from the region of a rectangle including the target block. The coordinates of the bottom-right of the rectangular region may be identical to the coordinates of the bottom-right of the target block. Respective pixels of the remaining region may be located above the target block, located above-and-to-the-left of the target block, or located to the left of the target block. The rectangle including the target block may be a square.

For example, when the coordinates of the top-left of the target block are (xₜ, yₜ), the horizontal length of the target block is w, and the vertical length of the target block is h, the x coordinate of a pixel in the template region may be equal to or greater than xₜ-n₁ and less than or equal to xₜ+h. The y coordinate of the pixel may be equal to or greater than yₜ-n₂ and less than or equal to yₜ+h. When the x coordinate of the pixel is equal to or greater than xₜ, the y coordinate thereof may be equal to or greater than yₜ-n₂ and less than or equal to yₜ. When the y coordinate of the pixel is equal to or greater than yₜ, the x coordinate thereof may be equal to or greater than xₜ-n₁ and less than or equal to xₜ. n₁ may be an integer of 1 or more. n₂ may be an integer of 1 or more. n₁ and n₂ may be equal to each other.

For example, the template region may be a line having a thickness of n, which encloses the top and left of the target block. n may be an integer of 1 or more.

The partition boundary of the partitioning mode in GPM may extend to the template region. The extended partition boundary may be a partition boundary extending to the template region.

The template region may be partitioned into multiple partial template regions by the partition boundary.

The multiple partial template regions may include a first partial template region and a second partial template region.

The template region is partitioned along the extended partition boundary, whereby two partitioned template regions may be specified. Alternatively, the two partitioned template regions in the template region may be distinguished from each other along the extended partition boundary.

For example, the first partial template region may be a region adjacent to the first subblock (or the first partitioned region) between the two partitioned template regions.

The second partial template region may be a region adjacent to the second subblock (or the second partitioned region) between the two partitioned template regions.

For example, the first partial template region may be a region located above the extended partition boundary between the two partitioned template regions. The second partial template region may be a region located below the extended partition boundary between the two partitioned template regions.

For example, the first partial template region may be a region located to the right of the extended partition boundary between the two partitioned template regions. The second partial template region may be a region located to the left of the extended partition boundary between the two partitioned template regions.

For example, the first partial template region may be a region including the uppermost-rightmost pixel in the corresponding template region between the two partitioned template regions. The second partial template region may be a region including the lowermost-leftmost pixel in the corresponding template region between the two partitioned template regions.

Error costs for multiple partitioning modes may be calculated by partitioning the template region depending on multiple partitioning modes available in GPM.

The error cost for the corresponding partitioning mode may be determined based on multiple partial error costs calculated for multiple partial template regions determined by the partitioning mode. Alternatively, the final error cost for the corresponding partitioning mode may be determined based on multiple error costs calculated for multiple template regions determined by the partitioning mode.

For example, the error cost for the partitioning mode may be the sum of multiple partial error costs for the multiple partial template regions determined by the partitioning mode.

The multiple partial error costs may include first partial error cost calculated for the first partial template region and second partial error cost calculated for the second partial template region.

For example, the first partial template region and the second partial template region may be determined by the partitioning mode. The error cost for the partitioning mode may be determined based on the first partial error cost for the first partial template region and the second partial error cost for the second partial template region.

For example, the error cost for the partitioning mode may be the sum of the first partial error cost for the first partial template region and the second partial error cost for the second partial template region.

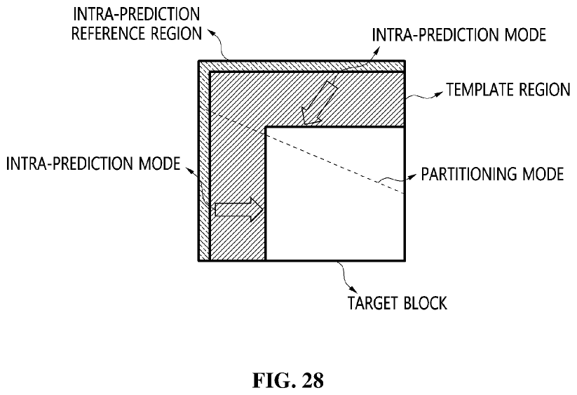

The error cost for the partitioning mode of GSM may be determined by applying predictions to multiple partial template regions which are determined by partitioning the template region depending on the partitioning mode. The predictions may include inter-prediction and intra-prediction. In FIG. 28, inter-prediction is exemplified.

Multiple reference templates for multiple partial template regions may be determined using pieces of motion information of the multiple partial template regions.

A first reference template may be specified by applying the motion information of the first partitioned region to the first partial template region.

For example, the location of the first reference template may be a location to which the first partial template region is moved by the motion vector of the first partitioned region. A first reference picture including the first reference template may be a picture indicated by a reference picture index for the first partitioned region.

A second reference template may be specified by applying the motion information of the second partitioned region to the second partial template region.

For example, the location of the second reference template may be a location to which the second partial template region is moved by the motion vector of the second partitioned region. A second reference picture including the second reference template may be a picture indicated by a reference picture index for the second partitioned region.

Multiple partial error costs for the multiple partial template regions may be calculated for multiple reference templates corresponding to multiple partial templates.

The first partial error cost for the first partial template region may be a value derived by the difference between one or more pixel values of the first partial template region and the first reference template. The pixel value difference may be the difference between the pixel values of corresponding pixels in the first partial template region and the first reference template. For example, the corresponding pixels may be pixels having the same coordinates in the first partial template region and the first reference template.

The second partial error cost for the second partial template region may be a value derived by the difference between one or more pixel values of the second partial template region and the second reference template. The pixel value difference may be the difference between the pixel values of the corresponding pixels in the second partial template region and the second reference template. For example, the corresponding pixels may be pixels having the same coordinates in the second partial template region and the second reference template.

As illustrated in FIG. 27, the template region may be partitioned into the first partial template region and the second partial template region by applying any one of available partitioning modes of GPM to a template region adjacent to the target block. Through inter-predictions, the first reference template for the first partial template region and the second reference template for the second partial template region may be derived. The first partial error cost for the first partial template region may be calculated based on the difference between the pixel values of corresponding pixels in the first partial template region and the first reference template, and the second partial error cost for the second partial template region may be calculated based on the difference between the pixel values of corresponding pixels in the second partial template region and the second reference template. Based on the first partial error cost and the second partial error cost, error cost for the applied partitioning mode may be calculated.

FIG. 28 illustrates intra-prediction for a template region according to an example.

Error cost for a partitioning mode of GSM may be determined by applying predictions to multiple partial template regions which are determined by partitioning the template region depending on the partitioning mode. The predictions may include inter-prediction and intra-prediction. In FIG. 27, intra-prediction is exemplified.

Multiple reference templates for multiple partial template regions may be determined by applying intra-predictions to the multiple partial template regions.

The reference templates for the partial template regions may be prediction values generated by intra-predictions for the partial template regions.

A first reference template may be configured by performing first intra-prediction on a first partial template region. A first intra-prediction mode of the first intra-prediction may be an intra-prediction mode for a first partitioned region.

First prediction values for pixels in the first partial template region may be generated by performing first intra-prediction for the first partial template region. The first reference template may include the first prediction values. The pixels in the first reference template may include the first prediction values, respectively.

A reference line used for the first intra-prediction may be an intra-prediction reference region or at least a part of the intra-prediction reference region. The reference pixels used for the first intra-prediction may be pixels in the intra-prediction reference region. Alternatively, the reference pixels used for the first intra-prediction may be at least some of the pixels in the intra-prediction reference region.

The intra-prediction reference region may be a line of reconstructed pixels adjacent to the template region. The intra-prediction reference region may include one or more reconstructed pixels adjacent to the template region.

Alternatively, the intra-prediction reference region may include the uppermost line and the leftmost line in the template region. The intra-prediction reference region may include one or more reconstructed pixels in the template region. Each reconstructed pixel may be located in the uppermost or leftmost portion in the template region.

For example, the intra-prediction reference region may include one or more reconstructed pixels adjacent to the top, top-left or left of the template region.

For example, when the top-left coordinates of the template region are (xₜ, yₜ), the intra-prediction reference region may include pixels, the x coordinate of which is xₜ-1 or the y coordinate of which is yₜ-1.

A second reference template may be configured by performing second intra-prediction on a second partial template region. A second intra-prediction mode of the second intra-prediction may be an intra-prediction mode for a second partitioned region.

Second prediction values for pixels in the second partial template region may be generated by performing second intra-prediction for the second partial template region. The second reference template may include the second prediction values. The pixels in the second reference template may include the second prediction values, respectively.

A reference line used for the second intra-prediction may be an intra-prediction reference region or at least a part of the intra-prediction reference region. The reference pixels used for the second intra-prediction may be pixels in the intra-prediction reference region. Alternatively, the reference pixels used for the second intra-prediction may be at least some of the pixels in the intra-prediction reference region.

First partial error cost for the first partial template region may be a value derived by the difference between one or more pixel values of the first partial template region and the first reference template. The pixel value difference may be the difference between the pixel values of corresponding pixels in the first partial template region and the first reference template. For example, the corresponding pixels may be pixels having the same coordinates in the first partial template region and the first reference template.

Alternatively, the first partial error cost for the first partial template region may be a value derived by the difference between one or more pixel values of one or more pixels in the first partial template. The difference between the pixel values of each pixel may be the difference between the reconstructed value of the pixel and a prediction value for of the pixel. The reconstructed value of each pixel may be the value of the corresponding pixel in the first partial template region. The prediction value for each pixel may be the value of the corresponding pixel in the first reference template. In other words, the reconstructed value of the pixel may be the value of the corresponding pixel in a reconstructed block. The prediction value for the pixel may be the value of the pixel in the first reference template generated by performing first intra-prediction on the above-described first partial template region.

Second partial error cost for the second partial template region may be a value derived by the difference between one or more pixel values of the second partial template region and the second reference template. The pixel value difference may be the difference between the pixel values of corresponding pixels in the second partial template region and the second reference template. For example, the corresponding pixels may be pixels having the same coordinates in the second partial template region and the second reference template.

Alternatively, the second partial error cost for the second partial template region may be a value derived by the difference between one or more pixel values of one or more pixels in the second partial template. The difference between the pixel values of each pixel may be the difference between the reconstructed value of the pixel and a prediction value for of the pixel. The reconstructed value of each pixel may be the value of the corresponding pixel in the second partial template region. The prediction value of each pixel may be the value of the corresponding pixel in the second reference template. In other words, the reconstructed value of the pixel may be the value of the corresponding pixel in a reconstructed block. The prediction value of each pixel may be the value of the corresponding pixel in the second reference template generated by performing second intra-prediction on the above-described second partial template region.

As illustrated in FIG. 28, the template region may be partitioned into the first partial template region and the second partial template region by applying any one of available partitioning modes of GPM to a template region adjacent to the target block.

Through intra-predictions, the first reference template for the first partial template region and the second reference template for the second partial template region may be derived. The first partial error cost for the first partial template region may be calculated based on the difference between the pixel values of corresponding pixels in the first partial template region and the first reference template, and the second partial error cost for the second partial template region may be calculated based on the difference between the pixel values of corresponding pixels in the second partial template region and the second reference template. Based on the first partial error cost and the second partial error cost, error cost for the applied partitioning mode may be calculated.

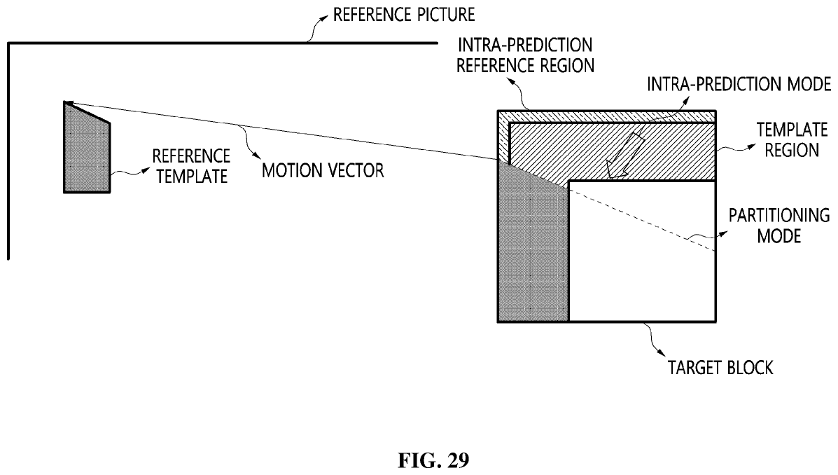

FIG. 29 illustrates prediction for a template region using inter-prediction and intra-prediction according to an example.

Error cost for each partitioning mode of GSM may be determined by applying different predictions to multiple partial template regions determined by partitioning the template region depending on a partitioning mode. The different predictions may include inter-prediction and intra-prediction.

Multiple reference templates for multiple partial template regions may be derived by respectively applying different predictions to the multiple partial template regions.

For example, as illustrated in FIG. 29, intra-prediction may be applied to the first partial template region, and inter-prediction may be applied to the second partial template region.

For example, inter-prediction may be applied to the first partial template region, and intra-prediction may be applied to the second partial template region.

A first reference template may be specified by applying the motion information of a first partitioned region to the first partial template region.

For example, the location of the first reference template may be a location to which the first partial template region is moved by the motion vector of the first partitioned region. A first reference picture including the first reference template may be a picture indicated by a reference picture index for the first partitioned region.

A second reference template may be configured by performing second intra-prediction on the second partial template region. A second intra-prediction mode for the second intra-prediction may be an intra-prediction mode for a second partitioned region.

Second prediction values for pixels in the second partial template region may be generated by performing second intra-prediction for the second partial template region.

The second reference template may include the second prediction values. The pixels in the second reference template may include the second prediction values, respectively.

A reference line used for the second intra-prediction may be an intra-prediction reference region or at least a part of the intra-prediction reference region. The reference pixels used for the second intra-prediction may be pixels in the intra-prediction reference region. Alternatively, the reference pixels used for the second intra-prediction may be at least some of the pixels in the intra-prediction reference region.

Multiple partial error costs for the multiple partial template regions may be calculated for multiple reference templates corresponding to multiple partial templates.

First partial error cost for the first partial template region may be a value derived by the difference between one or more pixel values of the first partial template region and the first reference template. The pixel value difference may be the difference between the pixel values of corresponding pixels in the first partial template region and the first reference template. For example, the corresponding pixels may be pixels having the same coordinates in the first partial template region and the first reference template.

Second partial error cost for the second partial template region may be a value derived by the difference between one or more pixel values of the second partial template region and the second reference template. The pixel value difference may be the difference between the pixel values of corresponding pixels in the second partial template region and the second reference template. For example, the corresponding pixels may be pixels having the same coordinates in the second partial template region and the second reference template.

Alternatively, the second partial error cost for the second partial template region may be a value derived by the difference between one or more pixel values of one or more pixels in the second partial template. The difference between the pixel values of pixels may be the difference between the reconstructed values of the pixels and prediction values of the pixels. The reconstructed value of each pixel may be the value of the corresponding pixel in the second partial template region. The prediction value for each pixel may be the value of the corresponding pixel in the second reference template. In other words, the reconstructed value of the pixel may be the value of the corresponding pixel in a reconstructed block. The prediction value for the pixel may be the value of the pixel in the second reference template generated by performing second intra-prediction on the above-described second partial template region.

As illustrated in FIG. 29, the template region may be partitioned into the first partial template region and the second partial template region by applying any one of available partitioning modes of GPM to a template region adjacent to the target block. Through intra-prediction and inter-prediction, the first reference template for the first partial template region and the second reference template for the second partial template region may be derived. The first partial error cost for the first partial template region may be calculated based on the difference between the pixel values of corresponding pixels in the first partial template region and the first reference template, and the second partial error cost for the second partial template region may be calculated based on the difference between the pixel values of corresponding pixels in the second partial template region and the second reference template. Based on the first partial error cost and the second partial error cost, error cost for the applied partitioning mode may be calculated.

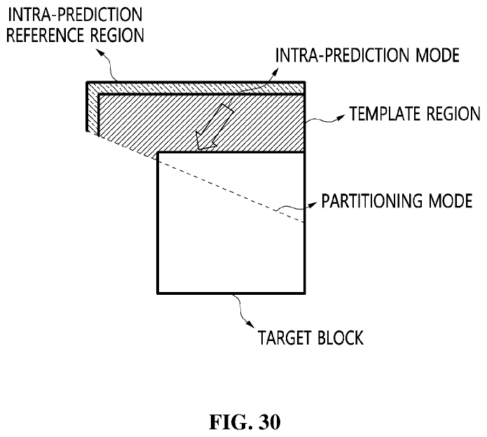

FIG. 30 illustrates intra-prediction for one of multiple partial template regions according to an example.

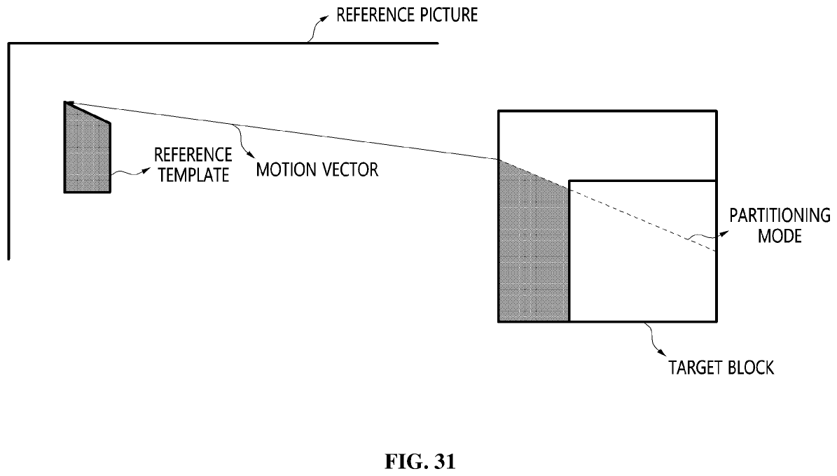

FIG. 31 illustrates inter-prediction for one of multiple partial template regions according to an example.

Error cost for each partitioning mode of GPM may be determined by applying inter-prediction or intra-prediction to each of the multiple partial template regions which are determined by partitioning a template region depending on the partitioning mode.

Hereinafter, each partial template region may refer to one of multiple partial template regions.

When inter-prediction is applied to the partial template region, a reference template may be specified by applying motion information to the partial template region. The motion information may be motion information of a partitioned region corresponding to a partial template.

For example, the location of the reference template may be a location to which the partial template region is moved by a motion vector. A reference picture including the reference template may be a picture indicated by a reference picture index for the partitioned region corresponding to the partial template.

A second reference template may be configured by performing second intra-prediction on the second partial template region. A second intra-prediction mode for the second intra-prediction may be an intra-prediction mode for a second partitioned region.

When intra-prediction is applied to the partial template region, prediction values for pixels in the partial template region may be generated by performing intra-prediction for the partial template region. The reference template may include the prediction values. The pixels in the reference template may have the prediction values, respectively.

A reference line used for intra-prediction may be an intra-prediction reference region or at least a part of the intra-prediction reference region. The reference pixels used for intra-prediction may be pixels in the intra-prediction reference region. Alternatively, the reference pixels used for intra-prediction may be at least some of the pixels in the intra-prediction reference region.

Partial error cost for the partial template region may be a value derived by the difference between one or more pixel values in the partial template region and the reference template. The pixel value difference may be the difference between the pixel values of corresponding pixels of the partial template region and the reference template. For example, the corresponding pixels may be pixels having the same coordinates in the partial template region and the reference template.

When intra-prediction is applied to the partial template region, partial error cost for the partial template region may be a value derived by the difference between one or more pixel values of one or more pixels in the partial template. The difference between the pixel values of each pixel may be the difference between the reconstructed value of the pixel and a prediction value for the pixel. The reconstructed value of the pixel may be the value of the corresponding pixel in the partial template region. The prediction value for the pixel may be the value of the corresponding pixel in the reference template. In other words, the reconstructed value of the pixel may be the value of the corresponding pixel in a reconstructed block. The prediction value for the pixel may be the value of the corresponding pixel in the reference template generated by performing intra-prediction for the above-described partial template region.

As illustrated in FIGS. 30 and 31, the template region may be partitioned into multiple partial template regions by applying any one of available partitioning modes of GSM to the template region adjacent to the target block. Reference templates for partial template regions may be derived through prediction for each of the multiple partial template regions. Partial error costs for the partial template regions may be calculated based on the differences between the pixel values of corresponding pixels in the partial template regions and the reference templates. The error cost for the applied partitioning mode may be calculated based on the partial error costs calculated for the partial template regions.

### Partitioning Mode List Including Prediction Mode or the Like

A partitioning mode list may include multiple elements.

Each element may include partitioning mode information indicating a partitioning mode.

Pieces of partitioning mode information of the multiple elements may indicate M partitioning modes having the lowest error cost among multiple available partitioning modes. M partitioning modes selected in ascending order of error cost from among the multiple available partitioning modes may be added, as the partitioning mode information of multiple elements, to the partitioning mode list.

Each element may include prediction method information indicating a prediction method. For example, the prediction method information may be a flag. The prediction method information may indicate one of intra-prediction and inter-prediction.

When the prediction method information of each element indicates intra-prediction, the element may include intra-prediction information used for intra-prediction. The intra-prediction information may include an intra-prediction mode.

When the prediction method information of each element indicates inter-prediction, the element may include inter-prediction information used for inter-prediction. The inter-prediction information may include motion information.

A GPM index may indicate an element used for prediction for the target block among multiple elements in the partitioning mode list. Prediction that uses GPM for the target block may be performed using the element indicated by the GPM index. Alternatively, the element indicated by the GPM index may represent prediction that uses GPM applied to the target block.

The GPM information may include partitioning mode list usage information.

The list usage information may indicate whether prediction using the partitioning mode list, described above in embodiments, is to be used.

Alternatively, the list usage information may indicate whether prediction using the partitioning mode list, described above in embodiments, has been used.

Prediction using the partitioning mode list may include 1) construction of the partitioning mode list and 2) encoding/decoding of the GPM index.

For example, when the list usage information indicates that prediction using the partitioning mode list is to be used, the partitioning mode list may be constructed, the GPM index may be encoded/decoded, and prediction for the target block may be performed using the element indicated by the GPM index among the elements in the partitioning mode list.

The list usage information may be included in high-level syntax such as a parameter set and a header. The list usage information may be encoded/decoded in the high-level syntax such as the parameter set and the header.

The GPM information may include list maximum size information.

The list maximum size information may indicate the maximum value of the maximum size of the partitioning mode list. The size of the partitioning mode list may be the number of multiple elements in the partitioning mode list.

The list maximum size information may be included in the high-level syntax such as the parameter set and the header. The list maximum size information may be encoded/decoded in the high-level syntax such as the parameter set and the header.

The list size information may indicate the size of the partitioning mode list. The list size information may indicate the number of multiple elements in the partitioning mode list.

The list size information may be included in the high-level syntax such as the parameter set and the header. The list size information may be encoded/decoded in the high-level syntax such as the parameter set and the header.

### Prediction Using Template Matching

Prediction for a target block may be performed using template matching.

An initial reference template may be determined using the target template for the target block. The target template may refer to the above-described template region. Description of the above-described template region may also be applied to the target template.

An initial reference template may be specified by applying motion information of the target block to the target template.

For example, the location of the initial reference template may be a location to which the target template is moved by the motion vector of the target block. A reference picture including the initial reference template may be a picture indicated by a reference picture index for the target block.

When the initial reference template is determined, a search area may be defined. The search area may be an area including the initial reference template in the reference picture.

For example, the search area may be defined based on the region of the initial reference template.

For example, the initial reference template may be located at the center of the search area.

For example, the search area may have a specific size.

For example, the search area may be an area including the initial reference template among multiple regions in the reference picture.

When the search area is defined, a minimum cost reference template may be determined while the location of the initial reference template is adjusted in the search area.

The minimum cost reference template may be a candidate reference template having minimum error cost with the target template among candidate reference templates in the search area. In other words, error costs with the target template may be calculated with respect to the candidate reference templates in the search area, and the candidate reference template having the minimum error cost among the calculated error costs may be selected as the minimum cost reference template.

The candidate reference template may be determined by moving the initial reference template within the search area. The form of the candidate reference template may be identical to that of the initial reference template. The candidate reference template may not deviate from the search area.

The locations of the candidate reference templates may be different from each other. The candidate reference templates may be all reference templates having different locations, which can be derived from the search area.

When the minimum cost reference template is determined, the reference block for the target block may be determined. The relative location of the reference block to the minimum cost reference template may be identical to the relative location of the target block to the target template. For example, the reference block may be a block in the reference picture, and may be a block corresponding to the current block based on the location of the target template and the location of the minimum cost reference template.

The minimum cost reference template may be used as the reference template for the target block.

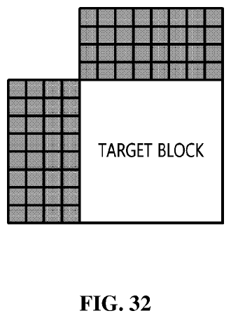

FIG. 32 illustrates a target template for a target block according to an example.

The target template may be a specific region adjacent to the target block. The target template may be a portion of a reconstructed region adjacent to the target block.

The target template for the target block may be configured using pixels adjacent to the target block. When the target template is configured, a reference picture and a search area may be determined. When the reference picture and the search area are determined, the reference template for the target block may be configured. A reference template matching the target template may be configured using the pixels in the search area of the reference picture.

For example, the target template may include 1) a first block adjacent to the top of the target block and 2) a second block adjacent to the left of the target block. When the coordinates of the top-left of the target block are (xₜ, yₜ), the horizontal length of the target block is w, and the vertical length of the target block is h, the coordinates of the top-left of the first block may be (xₜ, yₜ-n₁). The width of the first block may be w. The height of the first block may be n₁. The top-left coordinates of the second block may be (xₜ-n₂, yₜ). The width of the second block may be n. The height of the second block may be h.

n₁ may be an integer of 1 or more. n₂ may be an integer of 1 or more. n₁ and n₂ may be equal to each other. In FIG. 30, the case where n₁ is 4 and n₂ is 4 is exemplified.

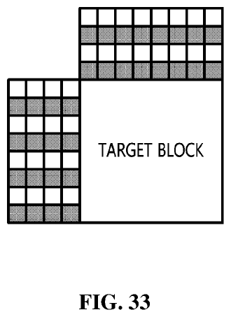

FIG. 33 illustrates a target template in which one or more horizontal lines are emptied according to an example.

In the configuration of the target template, described above with reference to FIG. 32, one or more lines may not be included in the target template.

For example, the target template may include pixels having a y coordinate of yₜ-1+2m among the pixels in the first block and the second block, described above with reference to FIG. 32. yₜ may be the y coordinate of the target block. m may be an integer.

For example, the target template may include pixels having a y coordinate of yₜ+2m among the pixels in the first block and the second block, described above with reference to FIG. 32. yₜ may be the y coordinate of the target block. m may be an integer.

For example, when a specific horizontal line, among horizontal lines in the first block and the second block, described above with reference to FIG. 32, is included in the target template, horizontal lines adjacent to the specific horizontal line may not be included in the target template.

For example, the target template may include pixels having an x coordinate of xₜ-1+2m among the pixels in the first block and the second block, described above with reference to FIG. 32. xₜ may be the x coordinate of the target block. m may be an integer.

For example, the target template may include pixels having an x coordinate of xₜ+2m among the pixels in the first block and the second block, described above with reference to FIG. 32. xₜ may be the x coordinate of the target block. m may be an integer.

For example, when a specific vertical line, among vertical lines in the first block and the second block, described above with reference to FIG. 32, is included in the target template, vertical lines adjacent to the specific vertical line may not be included in the target template.

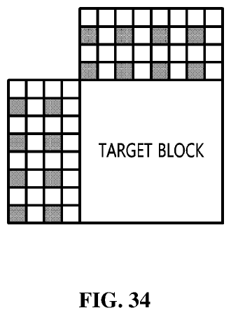

FIG. 34 illustrates a target template in which one or more horizontal lines and vertical lines are emptied according to an example.

In the configuration of the target template, described above with reference to FIG. 32, one or more pixels may not be included in the target template.

For example, the target template may include pixels having an x coordinate of xₜ+2m and a y coordinate of yₜ-1+2 among the pixels in the first block and the second block, described above with reference to FIG. 32. xₜ may be the x coordinate of the target block. yₜ may be the y coordinate of the target block. m may be an integer. n may be an integer.

For example, when a specific pixel, among the pixels in the first block and the second block, described above with reference to FIG. 32, is included in the target template, pixels adjacent to the specific pixel may not be included in the target template.

For example, each of the first block and the second block may be divided into multiple subblocks. Among multiple pixels in each of the multiple subblocks, only pixels at a specific location may be included in the target template.

For example, each subblock may have a square shape. The size of each subblock may be 2×2. The pixel at the specific location may be the lowermost-leftmost pixel in the corresponding subblock.

The pixels forming the target template may be determined based on coding parameters.

The number of pixels forming the target template, the number of lines forming the target blocks, and the form of the target template may be determined based on the coding parameters.

For example, the target template may be configured based on at least one of the partition shape of the target block or a neighboring block, the size thereof, the statistical value for the partition shape, and the statistical value for the size.

The configuration of the target template may include determination of the form of the target template.

For example, when a first side of the target template is adjacent to a second side of the target block or the neighboring block, the target template may be configured to have a side, the size of which is equal to that of the second side.

For example, when the first side of the target template is adjacent to the second side of the target block or the neighboring block, the target template may be configured to have a side, the size of which is smaller than that of the second side.

For example, when the first side of the target template is adjacent to the second side of the target block or the neighboring block, the target template may be configured to have a side, the size of which is greater than that of the second side.

For example, the size of the side of the target template may be determined based on the maximum value, the minimum value, the median value, or the statistical value for the sizes of the sides of the target block and the neighboring block.

For example, when the size of the target block or the neighboring block is less than a first threshold value, a line or a pixel may be excluded from the target template.

Alternatively, the line or pixel of the target template may be reduced. Alternatively, the target template may be further reduced.

For example, when the size of the target block or the neighboring block is less than the first threshold value, a line or a pixel may be added to the target block. Alternatively, the line or the pixel of the target block may be expanded. Alternatively, the target template may be further expanded.

For example, when the size of the target block or the neighboring block is greater than the first threshold value, a line or a pixel may be excluded from the target template. Alternatively, the line or pixel of the target template may be reduced. Alternatively, the target template may be further reduced.

For example, when the size of the target block or the neighboring block is greater than the first threshold value, a line or a pixel may be added to the target block. Alternatively, the line or the pixel of the target block may be expanded. Alternatively, the target template may be further expanded.

The first threshold value may be a value predefined by the encoding apparatus 1600 and the decoding apparatus 1700. Alternatively, GPM information may include the first threshold value.

For example, the target template may be configured based on at least one of motion information of the neighboring block and the statistical value of the motion information.

The configuration of the target template may include determination of the form of the target template.

For example, when at least one of the statistical values of the motion vector of the neighboring block is less than a second threshold value, a line or a pixel may be excluded from the target template. Alternatively, the line or pixel of the target template may be reduced. Alternatively, the target template may be further reduced.

For example, when at least one of the statistical values of the motion vector of the neighboring block is less than the second threshold value, a line or a pixel may be added to the target block. Alternatively, the line or the pixel of the target block may be expanded. Alternatively, the target template may be further expanded.

For example, when at least one of the statistical values of the motion vector of the neighboring block is greater than the second threshold value, a line or a pixel may be excluded from the target template. Alternatively, the line or pixel of the target template may be reduced. Alternatively, the target template may be further reduced.

For example, when at least one of the statistical values of the motion vector of the neighboring block is greater than the second threshold value, a line or a pixel may be added to the target block. Alternatively, the line or the pixel of the target block may be expanded. Alternatively, the target template may be further expanded.

The second threshold value may be a value predefined by the encoding apparatus 1600 and the decoding apparatus 1700. Alternatively, GPM information may include the second threshold value.

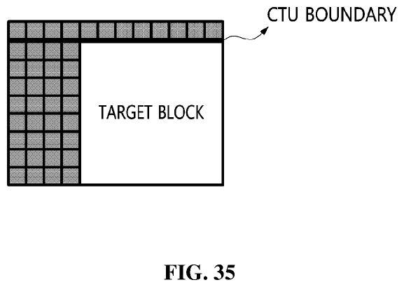

FIG. 35 illustrates a target template for a target block adjacent to a CTU boundary according to an example.

The target template for the target block may be configured using pixels adjacent to the target block. When the target template is configured, a reference picture and a search area may be determined. When the reference picture and the search area are determined, the reference template for the target block may be configured. A reference template matching the target template may be configured using the pixels in the search area of the reference picture.

The target template may be determined based on whether the boundary of the target block is a CTU boundary. The CTU boundary may be a boundary between different CTUs.

In the case where the target template to which template matching is to be applied is configured, when the top boundary of the target block is a CTU boundary, the number of above-target template lines may be less than the number of left-target template lines.

The above-target template lines may be horizontal lines in a target template located above the target block. Left target template lines may be vertical lines in a target template located to the left of the target block.

In FIG. 35, the case where the number of above-target template lines is 1 and the number of left-target template lines is 4 is exemplified. In other words, as the top boundary of the target block is the CTU boundary, the number of above-target template lines used to configure the target template may be reduced from 4 to 1.

For example, when the top boundary of the target block is the CTU boundary, the number of above-target template lines may be 2 or 1.

For example, when the top boundary of the target block is the CTU boundary, an adjacent horizontal line adjacent to the top of the target block may be included in the target template, and horizontal lines located above the adjacent horizontal line may not be included in the target template. The pixels in the horizontal lines located above the adjacent horizontal line may not be included in the target template.

In the case where the target template to which template matching is to be applied is configured, when the left boundary of the target block is a CTU boundary, the number of left-target template lines may be less than the number of above-target template lines.

For example, when the left boundary of the target block is a CTU boundary, the number of left-target template lines may be 2 or 1.

For example, when the left boundary of the target block is the CTU boundary, an adjacent vertical line adjacent to the left of the target block may be included in the target template, and vertical lines located to the left of the adjacent vertical line may not be included in the target template. The pixels in the vertical lines located to the left of the adjacent vertical line may not be included in the target template.

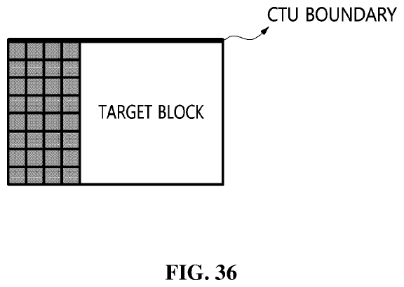

FIG. 36 illustrates a target template for a target block adjacent to a CTU boundary according to an example.

The target template may be determined based on whether the boundary of the target block is a CTU boundary. The CTU boundary may be a boundary between different CTUs.

In the case where a target template to which template matching is to be applied is configured, when the top boundary of the target block is a CTU boundary, above-target template lines may not be included in the target template. Alternatively, when the top boundary of the target block is a CTU boundary, the target template may include the second block, described above with reference to FIG. 32, and may not include the first block.

The above-target template lines may be horizontal lines in the target template located above the target block. Left-target template lines may be vertical lines in a target template located to the left of the target block.

In FIG. 36, the case where the number of above-target template lines is 0 and the number of left-target template lines is 4 is exemplified. In other words, as the top boundary of the target block is the CTU boundary, the above-target template lines may not be used to configure the target template. As the top boundary of the target block is the CTU boundary, pixels in the above-target template lines may not be used to configure the target template.

In the case where a target template to which template matching is to be applied is configured, when the left boundary of the target block is a CTU boundary, left-target template lines may not be included in the target template. Alternatively, when the left boundary of the target block is a CTU boundary, the target template may include the first block, described above with reference to FIG. 32, and may not include the second block.

When the target template to which template matching is to be applied is configured, pixels beyond the CTU boundary may not be included in the target template. Alternatively, the pixels forming the target template may be limited to the pixels within the CTU boundary of the CTU including the target block.

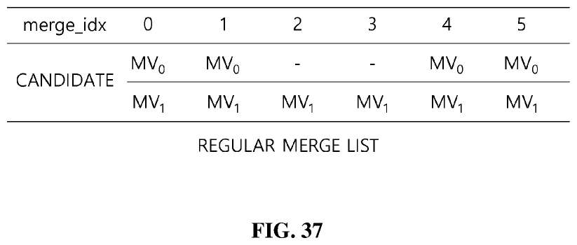

FIG. 37 illustrates a regular merge list according to an example.

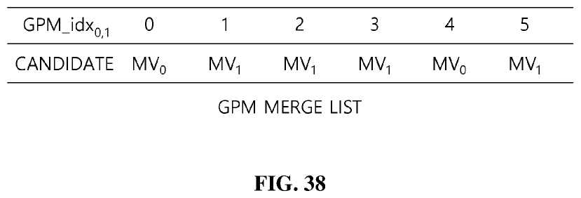

FIG. 38 illustrates a merge list for GPM according to an example.

In FIGS. 37 and 38, construction of a merge list for GPM is exemplified. The merge list may refer to a motion vector candidate list.

The merge list for GPM may be generated in a manner different from that of a regular merge list.

When the regular merge list is constructed, as shown in FIG. 37, the merge list for GPM may be generated based on the regular merge list.

An i-th candidate in the GPM merge list may be generated using an i-th candidate in the regular merge list. i may be an integer of 0 or more.

When the location of a merge index is an even number, MV₀ at a merge index location in the regular merge list may be stored at the merge index location in the GPM merge list. When MV₀ is not present at the merge index location in the regular merge list, MV₁ at the merge index location in the regular merge list may be stored at the merge index location in the GPM merge list.

When the location of a merge index is an odd number, MV₁ at the merge index location in the regular merge list may be stored at the merge index location in the GPM merge list. When MV₁ is not present at the merge index location in the regular merge list, MV₀ at the merge index location in the regular merge list may be stored at the merge index location in the GPM merge list.

In other words, when the motion vector of the regular merge list, selected depending on whether the merge index location is an even number or an odd number, is not present, an available motion vector may be stored at the merge index location in the GPM merge list.

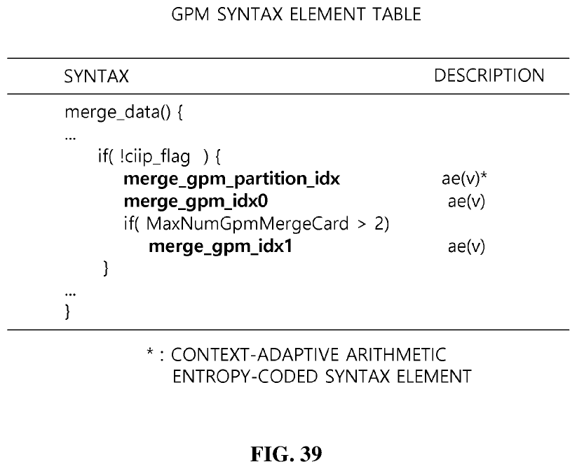

FIG. 39 illustrates a GPM syntax element table according to an example.

As illustrated in FIG. 39, an index (=merge_gpm_partition_idx) indicating a partitioning mode may be signaled.

As illustrated in FIG. 39, in a merge mode using GPM, two pieces of index information may be signaled.

Second index information (=merge_gpm_idx1) may be explicitly signaled only when the maximum number of candidates in the GPM merge list (=MaxNumGpmMergeCand) is greater than 2.

For example, when the GPM merge list includes two candidates, the second index information (=merge_gpm_idx1) may indicate the remaining candidate, other than a candidate indicated by first index information (=merge_gpm_idx0), between two candidates in the merge list.

For efficient signaling of GPM indices, the first index and the second index may be determined using the following Equations 1 and 2.

$${GPM\_idx}_{0} = merge\_gpm {\_idx}_{0} \qquad [ Equation 1 ]$$

$${GPM\_idx}_{1} = merge\_gpm {\_idx}_{1} + ( merge\_gpm {\_idx}_{1} \geq {GP\_idx}_{0} ) ? 1 : 0 \qquad [ Equation 2 ]$$

GPM_idx₀ may be the first index for the first prediction mode list.

GPM_idx₁ may be the second index for the second prediction mode list.

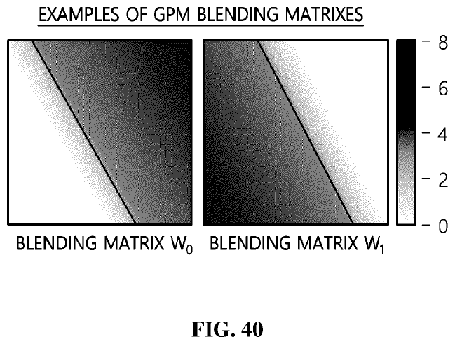

FIG. 40 illustrates GPM blending matrixes according to an example.

In FIG. 40, a blending matrix W0 for a first partitioned region and a blending matrix W₁ for a second partitioned region are illustrated.

As described above, the weight of a specific pixel in the first partitioned region may be determined based on the distance between the specific pixel and a partition boundary. The weight of a specific pixel in the second partitioned region may be determined based on the distance between the specific pixel and the partition boundary.

The weights indicated by the blending matrix W0 for the first partitioned region may be determined depending on the distance from the partition boundary. The weights indicated by the blending matrix W₁ for the second partitioned region may be determined depending on the distance from the partition boundary.

The following Equation 3 indicates the generation of GPM prediction signals corresponding to the weights illustrated in FIG. 40.

$${P}_{G} = ( {W}_{0} \cdot {P}_{0} + {W}_{1} \cdot {P}_{1} + 4 ) ≫ 3 \qquad [ Equation 3 ]$$

P₀ may be the pixel value of a pixel at a specific location in a first sub-prediction block. For example, P₀ may be a prediction signal referenced by motion information indicated by the first index, among pieces of motion information in the first prediction mode list for the first partitioned region. Here, the prediction signal may be the pixel value of a pixel at a specific location in a reference block.

W₀ may be a weight for the specific location in the first sub-prediction block.

P₁ may be the pixel value of a pixel at a specific location in a second sub-prediction block. For example, P₁ may be a prediction signal referenced by motion information indicated by a second index, among pieces of motion information in the second prediction mode list for the second partitioned region. Here, the prediction signal may be the pixel value of a pixel at a specific location in a reference block.

W₁ may be a weight for the specific location in the second sub-prediction block.

P_{G} may be the pixel value of a pixel at a specific location in a (final) prediction block.

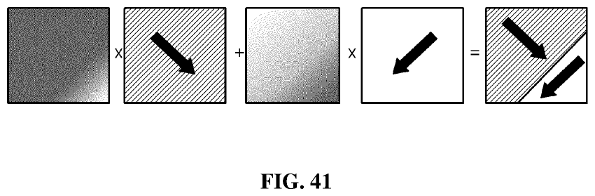

FIG. 41 illustrates GPM prediction using intra-predictions according to an example.

A prediction block for a target block to which GPM is applied may be generated using prediction blocks which are derived from prediction modes determined for a first subblock and a second subblock, and weights which are determined by a partition boundary.

In FIG. 41, GPM prediction for the case where intra-prediction is applied to the first subblock and intra-prediction is applied to the second subblock is illustrated.

In FIG. 41, the leftmost rectangle may indicate a weight for the first subblock.

An arrow in a rectangle on the second from the left may indicate the direction of an intra-prediction mode for the first subblock. Through the intra-prediction mode, the values of the first subblock may be generated.

A rectangle on the third from the left may indicate a weight for the second subblock.

An arrow in a rectangle on the fourth from the left may indicate the direction of the intra-prediction mode for the second subblock. Through the intra-prediction mode, the values of the second subblock may be generated.

The rightmost rectangle may indicate a (final) prediction block generated using GPM.

Based on the partition boundary, the values of the first subblock may be reflected in a region of the prediction block above the partition boundary, and the values of the second subblock may be reflected in a region of the prediction block below the partition boundary.

Based on the partition boundary, the values of the first subblock generated using the first intra-prediction may be reflected in a region of the prediction block to the left of the partition boundary, and the values of the second subblock generated using the second intra-prediction may be reflected in a region of the prediction block to the right of the partition boundary.

The first intra-prediction and the second intra-prediction may be different from each other. For example, the intra-prediction mode for the first intra-prediction and the intra-prediction mode for the second intra-prediction may be different from each other.

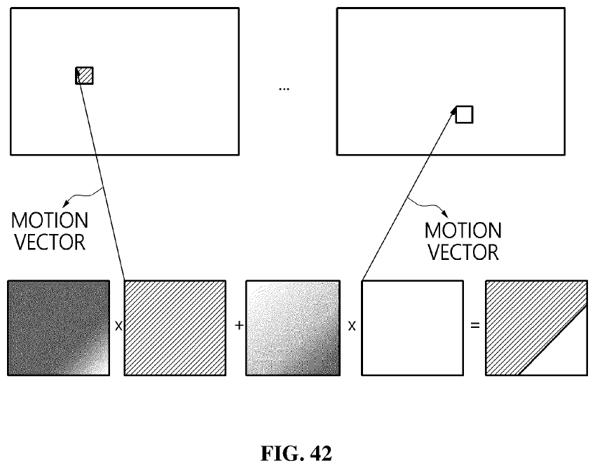

FIG. 42 illustrates GPM prediction using inter-predictions according to an example.

In FIG. 42, GPM prediction for the case where inter-prediction is applied to a first subblock and inter-prediction is applied to a second subblock is illustrated.

In FIG. 42, the leftmost rectangle may indicate a weight for the first subblock.

An arrow starting from a rectangle on the second from the left may indicate a reference block indicated by the motion vector of the first subblock. By the reference block, the values of the first subblock may be generated.

A rectangle on the third from the left may indicate a weight for the second subblock.

An arrow starting from a rectangle on the fourth from the left may indicate a reference block indicated by the motion vector of the second subblock. By the reference block, the values of the second subblock may be generated.

The rightmost rectangle may indicate a (final) prediction block generated using GPM.

Based on the partition boundary, the values of the first subblock may be reflected in a region of the prediction block above the partition boundary, and the values of the second subblock may be reflected in a region of the prediction block below the partition boundary.

Based on the partition boundary, the values of the first subblock generated using the first inter-prediction may be reflected in a region of the prediction block to the left of the partition boundary, and the values of the second subblock generated using the second inter-prediction may be reflected in a region of the prediction block to the right of the partition boundary.

The first inter-prediction and the second inter-prediction may be different from each other.

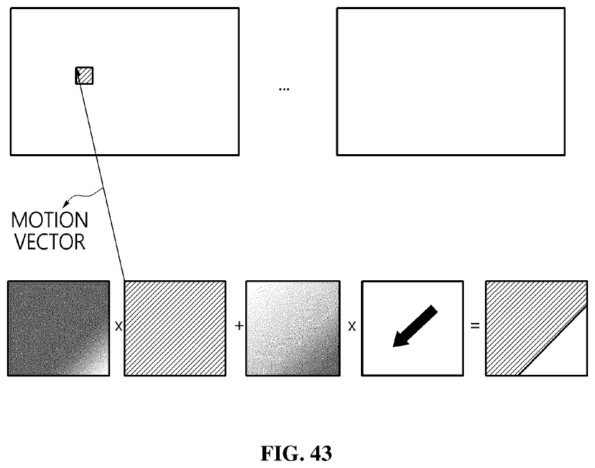

FIG. 43 illustrates GPM prediction using intra-prediction and inter-prediction according to an example.

In FIG. 43, GPM prediction for the case where inter-prediction is applied to the first subblock and intra-prediction is applied to the second subblock is illustrated.

In FIG. 43, the leftmost rectangle may indicate a weight for the first subblock.

An arrow starting from a rectangle on the second from the left may indicate a reference block indicated by the motion vector of the first subblock. By the reference block, the values of the first subblock may be generated.

A rectangle on the third from the left may indicate a weight for the second subblock.

An arrow in a rectangle on the fourth from the left may indicate the direction of the intra-prediction mode for the second subblock. Through the intra-prediction mode, the values of the second subblock may be generated.

The rightmost rectangle may indicate a (final) prediction block generated using GPM.

Based on the partition boundary, the values of the first subblock may be reflected in a region of the prediction block above the partition boundary, and the values of the second subblock may be reflected in a region of the prediction block below the partition boundary.

Based on the partition boundary, the values of the first subblock generated using inter-prediction may be reflected in a region of the prediction block to the left of the partition boundary, and the values of the second subblock generated using the intra-prediction may be reflected in a region of the prediction block to the right of the partition boundary.

### GPM Reference Region for Intra-Prediction

A region referenced for intra-prediction in GPM, described in embodiments, may indicate one or more pixel lines in a decoded region adjacent to a target block.

The referenced region may be a region of reference pixels.

For example, one or more pixel lines may be reference lines of the target block.

### Intra-Prediction Mode Applicable to GPM Partitioned Region

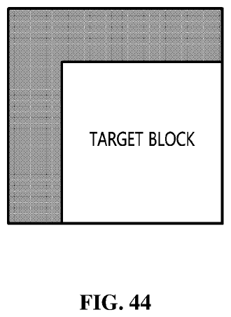

FIG. 44 illustrates a target block and a reference region of the target block according to an example.

Intra-prediction modes applicable to a GPM partitioned region may include a planar mode, a DC mode, a directional mode, a Position Dependent intra Prediction Combination (PDPC), a Matrix-weighted Intra Prediction (MIP), Intra Block Copy (IBC), etc.

The intra-prediction modes applicable to the GPM partitioned region may include various prediction modes that can be derived from 1) a decoded region adjacent to the target block or 2) a decoded region within a specific region including the target block (e.g., a slice, a tile, a picture, or the like).

The intra-prediction mode derived from the decoded region adjacent to the target block may be the intra-prediction mode of a neighboring block including all or part of the corresponding region.

The intra-prediction mode derived from the decoded region adjacent to the target block may be an intra-prediction mode derived from a template region configured using reconstructed pixels in the corresponding region.

A Histogram of Gradient (HoG) may be derived based on the gradients of the pixel values of the reconstructed pixels in the region. The intra-prediction mode derived from the decoded region adjacent to the target block may be an intra-prediction mode derived from HoG.

The reference region for intra-prediction using GPM may include n reference lines.

The reference region may be used as a template region. In other words, the reference region may be determined to be the template region.

An intra-prediction mode for the template region may be additionally derived, and the intra-prediction mode derived for the template region may be used as prediction for the intra-prediction mode of the target block.

Hereinafter, the intra-prediction mode for the template region may be abbreviated as a template intra-prediction mode.

The template reference region for the template region may be defined. The template reference region may indicate one or more reference sample lines adjacent to the template region.

Description of the relationship between the target block and the reference region may also be applied to the relationship between the template region and the reference region.

The template intra-prediction mode derived based on the template reference region may include a planar mode, a DC mode, a directional mode, a Matrix-weighted Intra Prediction (MIP), Intra Block Copy (IBC), etc.

A template prediction block may be configured using the template intra-prediction mode. The template prediction block may be configured by performing intra-prediction that uses the template reference region and the template intra-prediction mode.

Description of the relationship among the target block, the prediction block, the reference region, and the intra-prediction mode of the target block may also be applied to the relationship among the template region, the template prediction block, the template reference region, and a template intra-prediction mode.

When the template prediction block is generated, error cost between the template region and the template prediction block may be calculated.

The error cost between the template region and the template prediction block may be a value derived by the difference between one or more pixel values in the template region and the template prediction block. The pixel value difference may be the difference between the pixel values of corresponding pixels in the template region and the template prediction block. For example, the corresponding pixels may be pixels having the same coordinates in the template region and the template prediction block.

Error cost for the template intra-prediction mode may refer to error cost between the template region and a template prediction block generated using the template intra-prediction mode.

Error costs for available template intra-prediction modes may be calculated.

Among the available template intra-prediction modes, a minimum error cost template intra-prediction mode may be determined. The minimum error cost template intra-prediction mode may be a template intra-prediction mode having the minimum error cost among the available template intra-prediction modes.

The minimum error cost template intra-prediction mode may be used to predict an intra-prediction mode for the target block.

When the reference region includes multiple pixel lines, the template intra-prediction mode may be derived.

Based on the target block, an available above region and an available left region may be used as template regions, respectively.

For example, the above region may be a first block, described above with reference to FIG. 27. The above region may include the first block, described above with reference to FIG. 27. Alternatively, the above region may include one or more available pixels located above the target block.

For example, the left region may be a third block, described above with reference to FIG. 27. The left region may include the third block, described above with reference to FIG. 27. Alternatively, the left region may include one or more available pixels located to the left of the target block.

Intra-prediction may be applied to each template.

Error costs for multiple intra-prediction modes available for the template region may be calculated. Among the multiple intra-prediction modes, an intra-prediction mode having the lowest error cost may be determined to be the intra-prediction mode for the template region.

The intra-prediction mode for the template region may be added to an MPM list.

The size of the MPM list may be n. The size of the MPM list may refer to the number of one or more intra-prediction modes in the MPM list. n may be a positive integer.

For example, n may be 3.

When the reference region includes multiple pixel lines, the template intra-prediction mode may be derived based on changes in the pixel values of the pixels in the reference region.

Based on the target block, an available above region and an available left region may be used as template regions, respectively.

The differences between the pixel values of neighboring pixels in the template region (i.e., the gradients) may be stored in the form of a histogram. The differences are stored in the form of a histogram, whereby HoG may be configured.

In HoG, a value having the highest frequency among the difference values may be derived. An intra-prediction mode corresponding to the direction indicated by the value having the highest frequency may be determined to the intra-prediction mode for the template region.

The intra-prediction mode corresponding to the direction indicated by the value having the highest frequency may be added to the MPM list.

The size of the MPM list may be n. The size of the MPM list may refer to the number of one or more intra-prediction modes in the MPM list. n may be a positive integer. For example, n may be 3.

When a number of intra-prediction modes smaller than the size of the MPM list are stored in the MPM list, a planar mode may be added to the MPM list. Alternatively, the planar mode may be stored in the remaining space of the MPM list.

When a number of intra-prediction modes smaller than the size of the MPM list are stored in the MPM list, at least one of a DC mode, a horizontal mode, and a vertical mode may be added to the MPM list. Alternatively, at least one of a DC mode, a horizontal mode, and a vertical mode may be stored in the remaining space of the MPM list.

### Prediction Method for Intra-Prediction Mode Applicable to GPM

The intra-prediction mode applicable to each partitioned region determined by GPM may be predicted using 1) the intra-prediction mode of a neighboring block adjacent to the target block or 2) an intra-prediction mode derived from an adjacent region adjacent to the target block. Here, the neighboring block may be a decoded block. The adjacent region may be a decoded region.

For prediction for the intra-prediction mode, an MPM list may be constructed using the intra-prediction mode of the neighboring block or intra-prediction modes derived from the adjacent region.

In an embodiment, one MPM list may be constructed for the entire target block to which GPM is applied.

In an embodiment, two MPM lists may be respectively constructed for two partitioned regions generated by GSM. In other words, an MPM list may be constructed for each of the two partitioned regions.

When intra-prediction is applied to at least one of two partitioned regions of the target block to which GPM is applied, GPM information may include an MPM usage indicator for the MPM list.

The MPM usage indicator may indicate whether the intra-prediction mode of the corresponding partitioned region is one of intra-prediction modes present in the MPM list.

The MPM usage indicator may be a flag.

When intra-prediction is applied to at least one of the two partitioned regions of the target block to which GPM is applied, and one of the intra-prediction modes present in the MPM list needs to be determined to be the intra-prediction mode of the partitioned region to which intra-prediction is applied, signaling of the MPM usage indicator may be skipped.

Alternatively, when the intra-prediction mode of the partitioned region to which intra-prediction is applied is limited to one of the intra-prediction modes present in the MPM list, signaling of the MPM usage indicator may be skipped.

The GPM information may include an MPM indicator for the MPM list. The MPM indicator may indicate an intra-prediction mode applied to the target block or the partitioned region among the intra-prediction modes in the MPM list. The MPM indicator may be an index for elements in the MPM list.

When intra-prediction is applied both to the first partitioned region and to the second partitioned region generated by GPM, a first MPM indicator for the first partitioned region and a second MPM indicator for the second partitioned region may be used.

Here, the value of the first MPM indicator and the value of the second MPM indicator may be set, as described below.
The first index may indicate a first intra-prediction mode for the first partitioned region among the intra-prediction modes in the MPM list. The value of the first index may be equal to or greater than 0 and less than or equal to p−1. ρ may be the number of intra-prediction modes in the MPM list. For example, when the first intra-prediction mode for the first partitioned region is a q-th intra-prediction mode in the MPM list, the value of the first index may be q−1.
The second index may indicate a second intra-prediction mode for the second partitioned region among the intra-prediction modes in the MPM list. The value of the second index may be equal to or greater than 0 and less than or equal to p−1. ρ may be the number of intra-prediction modes in the MPM list. For example, when the second intra-prediction mode for the second partitioned region is a q-th intra-prediction mode in the MPM list, the value of the second index may be q−1.
When the value of the first index is a positive integer m, the value of the first MPM indicator may be m. Further, when the value of the first index is the positive integer m and the value n of the second MPM indicator is equal to or greater than m, the value of the second index may be n+1.
When the value of the first index is the positive integer m, the value of the first MPM indicator may be m. Furthermore, when the value of the first index is a positive integer m and the value n of the second MPM indicator is less than m, the value of the second index may be n.
When the value of the first index is 0, the value of the first MPM indicator may be 0. Further, when the value of the first index is 0 and the value of the second MPM indicator is n, the value of the second index may be n+1.

In other words, when the target block is partitioned by GPM, the first intra-prediction mode for the first partitioned region and the second intra-prediction mode for the second partitioned region may be considered to be different from each other. Based on this consideration, when the value of the second index is greater than the value of the first index, the value of the second MPM indicator to be signaled may be ‘the value of the second index−1’.

When the intra-prediction mode of a partitioned region, to which intra-prediction is applied, of the first partitioned region and the second partitioned region generated by GPM is not one of the intra-prediction modes present in the MPM list, the GPM information may include a non-MPM indicator.

For example, when the intra-prediction mode of the partitioned region to which intra-prediction is applied is not one of the intra-prediction modes present in the MPM list, the non-MPM indicator may be explicitly encoded/decoded.

The non-MPM indicator may indicate one of non-MPM intra-prediction modes. The non-MPM intra-prediction modes may be the (remaining) intra-prediction modes, which are not included in the MPM list, among (all) intra-prediction modes available for the target block or partitioned regions.

The non-MPM indicator may indicate an intra-prediction mode for the corresponding partitioned region among non-MPM intra-prediction modes.

The GPM information may include prediction usage information.

The prediction usage information may indicate whether to use the above-described method for predicting an intra-prediction mode applicable to the GPM partitioned regions. The intra-prediction mode applicable to the GPM partitioned regions may be predicted using 1) the intra-prediction mode of a neighboring block adjacent to the target block or 2) an intra-prediction mode derived from an adjacent region adjacent to the target block.

The prediction usage information may be included in the high-level syntax such as the parameter set and the header. The prediction usage information may be encoded/decoded in the high-level syntax such as the parameter set and the header.

Entropy encoding and entropy decoding may be performed on information indicating one of multiple candidates of the above-described prediction mode list, information indicating one of multiple elements in the data structure, information indicating one of multiple elements in a partitioning mode list, and information indicating one of multiple candidates in the MPM list.

Entropy encoding on the pieces of information may be performed by the encoding apparatus 1600, and entropy decoding on the pieces of entropy encoded information may be performed by the decoding apparatus 1700.

At least one of binarization, debinarization, an entropy encoding method, and an entropy decoding method, which will be described below, may be used for at least one of the syntax elements of the pieces of information.
Signed 0-th order Exp_Golomb binarization/debinarization method (abbreviated as se(v))
Signed k-th order Exp_Golomb binarization/debinarization method (abbreviated as sek(v))
0-th order Exp_Golomb binarization/debinarization method for an unsigned positive integer (abbreviated as ue(v))
k-th order Exp_Golomb binarization/debinarization method for an unsigned positive integer (abbreviated as uek(v))
Fixed-length binarization/debinarization method (abbreviated as f(n))
Truncated Rice binarization/debinarization method or truncated unary binarization/debinarization method (abbreviated as tu(v))
Truncated binary binarization/debinarization method (abbreviated as tb(v))
Context-adaptive arithmetic encoding/decoding method (abbreviated as ae(v))
Bit string in bytes (abbreviated as b(8))
Signed integer binarization/debinarization method (abbreviated as i(n))
Unsigned positive integer binarization/debinarization method (abbreviated as u(n)) (where ‘u(n)’ may denote a fixed-length binarization/debinarization method).
Unary binarization/debinarization method

### Method for Determining Inter-Prediction Mode or Intra-Prediction Mode Applicable to GPM

Each partitioned region of GPM may be encoded/decoded using inter-prediction or intra-prediction.

A motion vector candidate list for inter-prediction and an MPM list for intra-prediction may be constructed for each GPM partitioned region.

In embodiments, the motion vector candidate list may be replaced with a prediction mode list or a partitioning mode list. Description of the motion vector candidate list may also be applied to the prediction mode list or the partitioning mode list.

The size of the motion vector candidate list may be a positive integer M. For example, M may be 6.

The size of the MPM list may be a positive integer N. For example, N may be 3.

The GPM information may include prediction method information for each GPM partitioned region. For example, the GPM information may include first prediction method information for the first partitioned region, and may include second prediction method information for the second partitioned region.

The prediction method information for each partitioned region may indicate the type of prediction mode applied to the corresponding partitioned region. The type of prediction mode may be one of intra-prediction and inter-prediction.

The prediction method information for each partitioned region may indicate which one of intra-prediction and inter-prediction is to be applied to the corresponding partitioned region.

The prediction method information for each partitioned region may indicate whether intra-prediction is to be applied to the corresponding partitioned region. When intra-prediction is not to be applied to the partitioned region, inter-prediction may be applied to the corresponding partitioned region.

For example, when the value of the prediction method information for each partitioned region is a first predefined value (e.g., ‘0’), the partitioned region may be encoded/decoded using intra-prediction. Alternatively, the first predefined value may be ‘1’.

For example, when the value of the prediction method information for each partitioned region is a second predefined value (e.g., ‘1’), the partitioned region may be encoded/decoded using intra-prediction. Alternatively, the second predefined value may be ‘0’.

When intra-prediction is determined to be used for each partitioned region based on the prediction method information, information indicating an intra-prediction mode for the partitioned region may be signaled.

The GPM information may include information indicating an intra-prediction mode for each partitioned region.

The information indicating the intra-prediction mode for the partitioned region may include one or more of an MPM usage indicator, an MPM indicator, and a non-MPM indicator for the MPM list.

The MPM usage indicator may indicate whether the intra-prediction mode of the corresponding partitioned region is present in the MPM list.

For example, when the value of the MPM usage indicator is a first predefined value (e.g., ‘0’), the non-MPM indicator may be explicitly signaled.

The non-MPM indicator may indicate one of non-MPM intra-prediction modes. The non-MPM intra-prediction modes may be the (remaining) intra-prediction modes, which are not included in the MPM list, among (all) intra-prediction modes available for the target block or partitioned regions. The non-MPM indicator may indicate an intra-prediction mode for the corresponding partitioned region among non-MPM intra-prediction modes.

For example, when the value of the MPM usage indicator is a second predefined value (e.g., ‘1’), the non-MPM indicator may be explicitly signaled.

The MPM indicator may indicate the intra-prediction mode for the corresponding partitioned region among the intra-prediction modes in the MPM list. The MPM indicator may be an index for elements in the MPM list.

The GPM information may include a motion vector index for each partitioned region.

When inter-prediction is determined to be used for each partitioned region based on the prediction method information, a motion vector index may be signaled. The motion vector index may indicate one of motion vectors in the motion vector candidate list.

A motion vector indicated by the motion vector index, among the motion vectors in the motion vector candidate list, may be used for inter-prediction for the corresponding partitioned region.

The GPM information may include motion vector refinement information for each partitioned region.

When inter-prediction is determined to be used for the partitioned region based on the prediction method information, the motion vector refinement information may be signaled.

By means of the motion vector, a reference template and a search area may be determined.

The motion vector refinement information may be information may be information indicating whether to refine a prediction signal (or a prediction block) by applying template matching to the reference template indicated by the motion vector. The motion vector refinement information may be a flag.

The GPM information may include a motion vector difference for each partitioned region. The motion vector difference may be a value added to the motion vector for the partitioned region. The motion vector for the partitioned region may be derived by adding the motion vector indicated by the motion vector index to the motion vector difference.

The motion vector indicated by the motion vector index may be called an initial motion vector. In other words, the initial motion vector may be a motion vector for the partitioned region before the motion vector difference is added.

A motion vector generated by adding the initial motion vector to the motion vector difference may be called a corrected motion vector. In other words, the corrected motion vector may be a motion vector for the partitioned region after the motion vector difference is added.

The GPM information may include motion vector difference usage information for each partitioned region.

The motion vector difference usage information for each partitioned region may be information indicating whether a motion vector difference is to be additionally used for the corresponding partitioned region. The motion vector difference usage information may be a flag.

When the value of the motion vector difference usage information is a first predefined value (e.g., ‘0’), signaling of the motion vector difference may be skipped, and the motion vector difference may not be used. In this case, the motion vector for the partitioned region may be a motion vector indicated by the motion vector index.

When the value of the motion vector difference usage information is a second predefined value (e.g., ‘1’), the motion vector difference may be signaled, and may be used to derive a motion vector for the partitioned region.

Signaling of the prediction method information for each partitioned region generated by the above-described GPM may be skipped.

The GPM information may include prediction mode information.

The prediction mode information may indicate which one of inter-prediction and intra-prediction is to be used for the partitioned region, and may indicate a motion vector or the intra-prediction mode for the corresponding partitioned region.

The prediction mode information may indicate one of motion vectors in the motion vector candidate list and intra-prediction modes in the MPM list. The prediction mode information may be an index.

For example, P may indicate the value of the prediction mode information.

For example, when P is smaller than M, which is the size of the motion vector candidate list, inter-prediction may be used for the partitioned region, and encoding/decoding on the partitioned region may be performed using a motion vector indicated by P among the motion vectors in the motion vector candidate list. P may be an index for the motion vector candidate list.

For example, when P is equal to or greater than M, which is the size of the motion vector candidate list, intra-prediction may be used for the partitioned region, and encoding/decoding on the partitioned region may be performed using an intra-prediction mode indicated by P-M among the intra-prediction modes in the MPM list. P-M may be an index for the MPM list.

For example, when P is less than N, which is the size of the MPM list, intra-prediction may be used for the partitioned region, and encoding/decoding on the partitioned region may be performed using an intra-prediction mode indicated by P among intra-prediction modes in the MPM list. P may be an index for the MPM list.

For example, when P is equal to or greater than N, which is the size of the MPM list, inter-prediction may be used for the partitioned region, and encoding/decoding on the partitioned region may be performed using a motion vector indicated by P-N among the motion vectors in the motion vector candidate list. P-N may be an index for the motion vector candidate list.

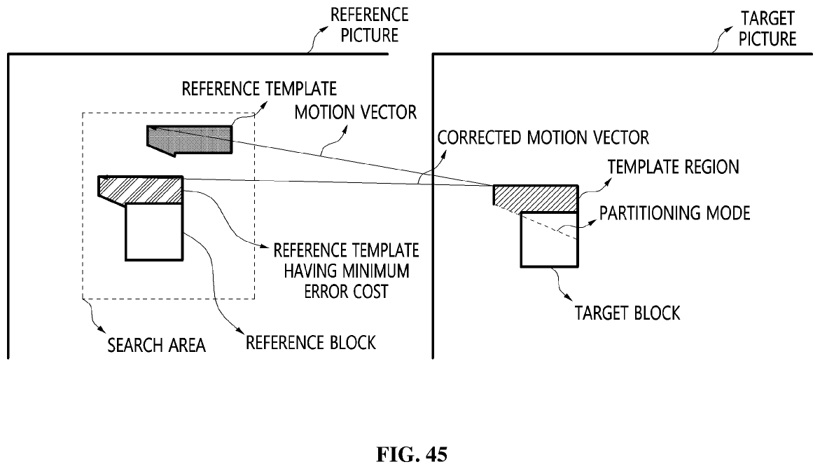

FIG. 45 illustrates a method for refining a prediction signal by applying template matching to a partitioned region in which inter-prediction is used according to an example.

Refinement of a prediction signal may refer to refinement of a motion vector that uses template matching. A corrected motion vector may be derived using template matching.

In embodiments, the template region may refer to the above-described first partial template region or second partial template region. The partitioned region may refer to a first partitioned region or a second partitioned region.

A reference template may be specified by applying the motion information of the corresponding partitioned region to the template region.

For example, the location of the reference template may be a location to which the template region is moved by the motion vector. A reference picture including the reference template may be a picture indicated by a reference picture index for the partitioned region.

The initial reference template may refer to a reference template specified by applying motion information of the partitioned region to the template region. A motion vector for specifying the initial reference template may be called an initial motion vector. In other words, the initial motion vector may be a motion vector before refinement is applied thereto.

When the initial reference template is determined, a search area may be defined. The search area may be an area including the initial reference template in the reference picture.

For example, the search area may be defined based on the region of the initial reference template.

For example, the initial reference template may be located at the center of the search area.

For example, the search area may have a specific size. The size of the search area may be N×M. N may be a positive integer. M may be a positive integer.

For example, N may be 2, 4, 8, or 16. M may be 2, 4, 8, or 16. N may be 2^{P}. P may be an integer of 1 or more. M may be 2^{Q}. Q may be an integer of 1 or more.

For example, the search area may be an area including the initial reference template among multiple regions in the reference picture.

A minimum cost reference template may be a candidate reference template having minimum error cost with the target template among candidate reference templates in the search area. In other words, error costs with the target template may be calculated with respect to the candidate reference templates in the search area, and the candidate reference template having the minimum error cost among the calculated error costs may be selected as the minimum cost reference template.

The corrected motion vector may indicate the minimum cost reference template. For example, the location of the minimum cost reference template may be a location to which the target template is moved by the corrected motion vector.

The candidate reference template may be determined by moving the initial reference template within the search area. The form of the candidate reference template may be identical to that of the initial reference template. The candidate reference template may not deviate from the search area.

The locations of the candidate reference templates may be different from each other. The candidate reference templates may be all reference templates having different locations, which can be derived from the search area.

When the minimum cost reference template is determined, the reference block for the target block may be determined. The relative location of the reference block to the minimum cost reference template may be identical to the relative location of the target block to the target template.

The reference block may be a block in a reference picture. The reference block may be a block corresponding to the current block based on the location of the target template and the location of the minimum cost reference template. The size of the target block and the size of the reference block may be equal to each other.

The reference block for the target block may be used as a prediction block for the target block.

The minimum cost reference template may be used as the reference template for the target block.

The corrected motion vector determined by using template matching may be stored and used as the motion vector of the target block or the partitioned region.

The corrected motion vector determined by using the initial motion vector and template matching may be stored and used as the motion vector of the target block or the partitioned region.

The corrected motion vector determined by applying the motion vector difference may be stored and used as the motion vector of the target block or the partitioned region.

The corrected motion vector determined by using the initial motion vector and the motion vector difference may be stored and used as the motion vector of the target block or the partitioned region.

The motion vector derived according to the above-described embodiment may be used as a candidate in a list or a part of the candidate in the list. The derived motion vector may be a corrected motion vector.

The motion vector derived according to the above-described embodiment may be used as a motion vector for a history-based merge candidate in a merge list.

The motion vector derived according to the above-described embodiment may be used as a motion vector for a merge candidate in the merge list.

The motion vector derived according to the above-described embodiment may be used as a predictive motion vector candidate in an Advanced Motion Vector Prediction (AMVP) candidate list in an AMVP mode. The predictive motion vector candidate may be a spatial predictive motion vector candidate.

The motion vector derived according to the above-described embodiment may be used for deblocking filtering.

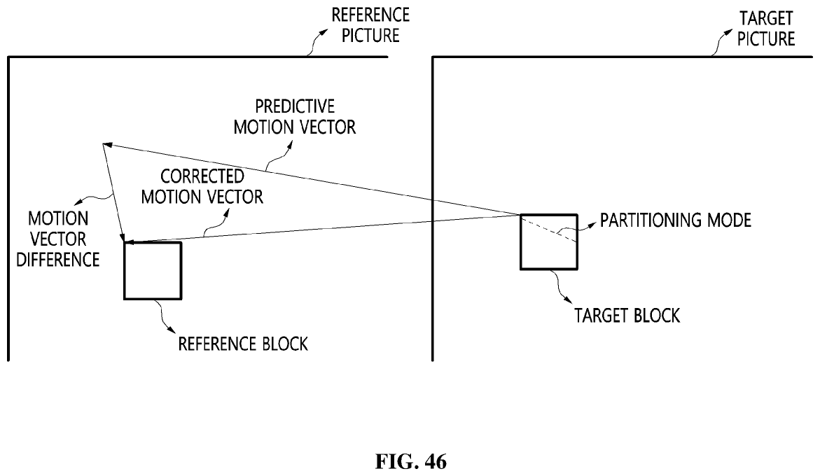

FIG. 46 illustrates a method for refining a prediction signal using a motion vector difference according to an example.

For a partitioned region for which inter-prediction is used, a motion vector difference may be applied to a motion vector for the partitioned region.

A predictive motion vector may refer to the motion vector for the partitioned region. The predictive motion vector may be a motion vector for the partitioned region before the motion vector difference is applied thereto.

The corrected motion vector may be the sum of the predictive motion vector and the motion vector difference. The corrected motion vector may be a motion vector for the partitioned region after the motion vector difference is applied thereto.

Partitioned regions in a target block may be determined by the partitioning mode of GPM. A (corrected) motion vector indicating a reference block corresponding to each partitioned region may be the sum of the predictive motion vector and the motion vector difference. In other words, a (corrected) motion vector indicating a reference block corresponding to the partitioned region may be determined by adding the predictive motion vector, determined using the motion vector candidate list, to the motion vector difference.

The motion vector difference may be represented by a direction and an offset. The direction may be the direction of the motion vector indicated by the motion vector difference. The offset may be the magnitude of the motion vector indicated by the motion vector difference.

The motion vector difference may indicate one of N directions. N may be a positive integer. N may be 8.

Direction values indicating directions may be predefined in a data structure such as a table, an array, and a list.

GPM information may include direction value information. The direction value information may indicate one of direction values defined in the data structure. The direction value information may be the index of the data structure.

For example, the direction values may be {0 degree, 45 degrees, 90 degrees, 135 degrees, 180 degrees, 225 degrees, 270 degrees, or 315 degrees}.

The motion vector difference may indicate one of M offsets. M may be a positive integer. M may be 9.

Offset values indicating offsets may be predefined in the data structure such as a table, an array, and a list.

The GPM information may include offset information. The offset information may indicate one of offset values defined in the data structure. The offset value information may be the index of the data structure.

For example, the offset values may be {¼-pel, ½-pel, 1-pel, 2-pel, 3-pel, 4-pel, 6-pel, 8-pel, or 16-pel}.

The motion vector difference may be a combination of a direction value and an offset value. The motion vector difference may be represented by the combination of the direction value and the offset value.

Alternatively, the motion vector difference may be at least one of the direction value and the offset value. The motion vector difference may be represented by at least one of the direction value and the offset value.

### Combined Prediction Mode Applicable to GPM

Each partitioned region of GPM may be encoded/decoded using combined prediction. The combined prediction may be prediction that uses both inter-prediction and intra-prediction.

When combined prediction is used for a partitioned region, a prediction block for at least one of multiple partitioned regions may be a weighted average of an intra-prediction block and an inter-prediction block. The intra-prediction block may be a prediction block generated through intra-prediction for the partitioned region. The inter-prediction block may be a prediction block generated through inter-prediction for the partitioned region.

A weight for the intra-prediction block may be N. N may be a positive integer.

The weight for the inter-prediction block may be M. M may be a positive integer.

For example, N and M may be determined based on whether blocks adjacent to the target block or the partitioned region are encoded/decoded using intra-prediction.

The blocks adjacent to the target block or the partitioned region may include an above block adjacent to the top of the target block or the partitioned region and a left block adjacent to the left of the target block or the partitioned region.

For example, when both an above block prediction method and a left block prediction method are intra-prediction methods, the weight of the intra-prediction block may be N, and the weight of the inter-prediction block may be 1. N may be an integer of 2 or more. For example, N may be 2 or 3.

For example, when one of the above block prediction method and the left block prediction method is an intra-prediction method and the other thereof is an inter-prediction method, the weight of the intra-prediction block may be 2, and the weight of the inter-prediction block may be 2.

For example, when both the above block prediction method and the left block prediction method are inter-prediction methods, the weight of the intra-prediction block may be 1, and the weight of the inter-prediction block may be M. M may be an integer of 2 or more. For example, M may be 2 or 3.

When combined prediction is used for the partitioned region, the prediction block for the partitioned region may be generated using the following Equation 4.

$${P}_{combine} = ( M \cdot {P}_{intra} + N \cdot {P}_{inter} + 2 ) ≫ 2 \qquad [ Equation 4 ]$$

P_{combine} may be a prediction block for combined prediction that uses a weighted average. In other words, P_{combine} may be a prediction block for the combined prediction.

Pᵢₙₜᵣₐ may be an intra-prediction block. N may be a weight for the intra-prediction block.

Pᵢₙₜₑᵣ may be an inter-prediction block. M may be a weight for the inter-prediction block.

To perform inter-prediction and intra-prediction for the combined prediction, at least one of inter-predictions and intra-predictions, described in the embodiments, may be used.

In an embodiment, an intra-prediction mode for intra-prediction of the combined prediction may be fixed at a specific intra-prediction mode. The specific intra-prediction mode may be a planar mode.

The GPM information may include combined prediction usage information for each partitioned region.

The combined prediction usage information for the partitioned region may indicate whether combined prediction is to be applied to the corresponding partitioned region.

The combined prediction usage information may be a flag.

Signaling of GPM information

The GPM information may include mode information.

The mode information may correspond to first partitioned region prediction mode information and second partitioned region prediction mode information.

The mode information may include at least one of pieces of information, which will be described below.
1) Mode information may include partitioning mode information.

The partitioning mode information may be a value explicitly indicating the partitioning mode of GPM.

The partitioning mode information may indicate one of multiple candidate partitioning modes of GSM. The partitioning mode information may be an index indicating one of multiple candidate partitioning modes of GSM.
2) The mode information may include pieces of prediction method information for the multiple partitioned regions generated by GSM.

The pieces of prediction method information may include first prediction method information for the first partitioned region and second prediction method information for the second partitioned region.

The prediction method information for the corresponding partitioned region may indicate one of intra-prediction and inter-prediction. The prediction method information for the partitioned region may indicate which one of intra-prediction and inter-prediction is used for the corresponding partitioned region. The prediction method information may be a flag.

For example, when the value of the prediction method information for each partitioned region is a first predefined value (or ‘0’), inter-prediction may be used for the corresponding partitioned region.

For example, when the value of the prediction method information for each partitioned region is a second predefined value (or ‘1’), intra-prediction may be used for the corresponding partitioned region.
3) The mode information may include pieces of combined prediction usage information for multiple partitioned regions generated by GSM.

The pieces of combined prediction usage information may include first combined prediction usage information for the first partitioned region and second combined prediction usage information for the second partitioned region.

The combined prediction usage information for each partitioned region may be information indicating whether combined prediction is used for the corresponding partitioned region. The combined prediction usage information may be a flag.

For example, when the value of the combined prediction usage information for each partitioned region is a first predefined value (or ‘0’), combined prediction may not be used for the corresponding partitioned region.

For example, when the value of the combined prediction usage information for each partitioned region is a second predefined value (or ‘1’), combined prediction may be used for the corresponding partitioned region.
4) The mode information may include intra-prediction information for each partitioned region.

When the prediction information for the partitioned region indicates intra-prediction, intra-prediction may be used for the partitioned region. When intra-prediction is used for the partitioned region, the GPM information may include intra-prediction information for the partitioned region.

The intra-prediction information may include an intra-prediction mode.

The intra-prediction mode for each partitioned region may include a planar mode, a DC mode, a directional mode, a Position Dependent intra Prediction Combination (PDPC), a Matrix-weighted Intra Prediction (MIP), Intra Block Copy (IBC), etc.

The intra-prediction mode for each partitioned region may include various prediction modes that can be derived from 1) a decoded region adjacent to the target block or 2) a decoded region within a specific region including the target block (e.g., a slice, a tile, a picture, etc.).

Also, the intra-prediction information may include the index of a Multiple Reference Line (MRL). The MRL may be multiple reference sample lines for the target block. The index of MRL may indicate reference sample lines that are used for intra-prediction for the target block or the partitioned region among the multiple reference sample lines.
5) The mode information may include inter-prediction information for each partitioned region.

The inter-prediction information may include information for determining an inter-prediction mode for each partitioned region. For example, the inter-prediction mode may include a merge mode, an AMVP mode, etc.

For example, the inter-prediction information may include merge mode usage information indicating whether the merge mode is used for each partitioned region.

For example, the inter-prediction information may include AMVP mode usage information indicating whether the AMVP mode is used for the partitioned region.

For example, the inter-prediction information may include a predictive motion vector index for the partitioned region.

For example, the inter-prediction information may include a motion vector difference for the partitioned region.

For example, the inter-prediction information may include a reference direction for the partitioned region.

For example, the inter-prediction information may include a reference picture index for the partitioned region.
6) Further, the mode information may include information about each partitioned region, described above in embodiments.

Multiple pieces of mode information may be configured.

The data structure may include multiple elements. For example, the data structure may be a buffer. The number of multiple elements may be N. N may be a positive integer. For example, N may be 6.

The multiple elements of the data structure may be multiple pieces of mode information. The multiple pieces of mode information may be stored as various elements of the data structure.

The GPM information may include multiple mode indices for multiple partitioned regions.

The GPM information may include a first mode index for a first partitioned region and a second mode index for a second partitioned region.

The mode index for each partitioned region may indicate mode information applied to the corresponding partitioned region among the pieces of mode information of the data structure. The mode information for the partitioned region may indicate a GPM method applied to the corresponding partitioned region.

For each of the multiple partitioned regions generated by GPM, prediction may be performed on the partitioned region based on a mode index indicating one of N elements of the data structure.

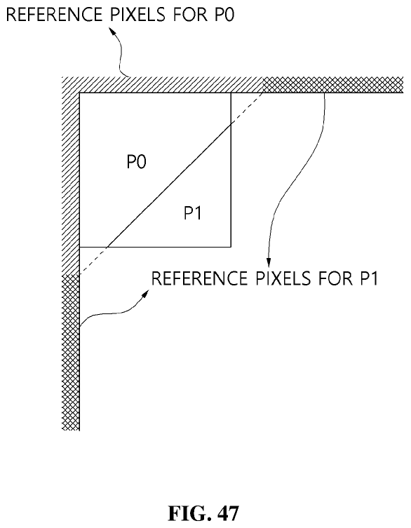

FIG. 47 illustrates reference pixels for partitioned regions according to an example.

In FIG. 47, P0 may indicate a first partitioned region. P1 may indicate a second partitioned region.

When intra-prediction is used for the first partitioned region and the second partitioned region, a reference region for the target block may be partitioned into a first reference region corresponding to the first partitioned region and a second reference region corresponding to the second partitioned region. The reference region for the target block may include one or more reference pixel lines.

The first reference region may be a region including first reference samples referenced by the first partitioned region.

The second reference region may be a region including second reference samples referenced by the second partitioned region.

Each reference region may be a region of reference samples. The reference samples may refer to samples that are referenced for intra-prediction. Alternatively, the reference region may indicate one or more reference sample lines.

The reference region for the target block may be partitioned into the first reference region and the second reference region based on intersection points between an extended line of a partition boundary and each reference pixel line.

The first reference region may be a region including first reference samples. The second reference region may be a region including second reference samples.

Among reference samples for the target block, a reference sample adjacent to the first reference region may be included in the first reference region. Among the reference samples for the target block, a reference sample adjacent to the second reference region may be included in the second reference region.

When at least one of the reference samples between the intersection points is included in the first reference region, the remaining reference samples may also be included in the first reference region. When at least one of the reference samples between the intersection points is included in the first reference region, reference samples which are not present between the intersection points may be included in the second reference region.

When at least one of the reference samples between the intersection points is included in the second reference region, the remaining reference samples may also be included in the second reference region. When at least one of the reference samples between the intersection points is included in the second reference region, reference samples which are not present between the intersection points may be included in the first reference region.

As in the case where the partition boundary is a vertical line or a horizontal line, there may be one intersection point between the extended line of the partition boundary and the reference pixel line. In this case, a reference sample that is not adjacent to the target block may be included in a reference region to which a reference sample adjacent thereto belongs.

A first intra-prediction mode applied to the first partitioned region may be limited by the angle of the partition boundary. The first intra-prediction mode applied to the first partitioned region may be limited to an intra-prediction mode which refers to the first reference samples for the first partitioned region.

A second intra-prediction mode applied to the second partitioned region may be limited by the angle of the partition boundary. The second intra-prediction mode applied to the second partitioned region may be limited to an intra-prediction mode which refers to the second reference samples for the second partitioned region.

As described above, a first prediction mode list for the first partitioned region may be generated, and a second prediction mode list for the second partitioned region may be generated. The first prediction mode list may be a first MPM list. The second prediction mode list may be a second MPM list.

MPMs in the first MPM list may be limited to intra-prediction modes which refer to only the reference samples for the first partitioned region. In other words, the first MPM list may be independently constructed using only intra-prediction modes which refer to only reference pixels in the first reference region that can be referenced by the first partitioned region. When a specific intra-prediction mode refers to a reference pixel that is not included in the first partitioned region, the specific intra-prediction mode may not be included in the first MPM list.

MPMs in the second MPM list may be limited to intra-prediction modes which refer to only the reference samples for the second partitioned region. In other words, the second MPM list may be independently constructed using only intra-prediction modes which refer to only reference pixels in the second reference region that can be referenced by the second partitioned region. When a specific intra-prediction mode refers to a reference pixel that is not included in the second partitioned region, the specific intra-prediction mode may not be included in the second MPM list.

In other words, the first MPM list and the second MPM list may be constructed independently of each other.

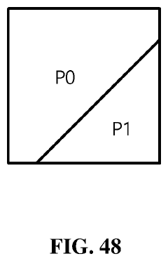

FIG. 48 illustrates a target block to which GPM using two intra-prediction modes is applied according to an example.

Encoding and decoding that use two intra-prediction modes may be performed on a first partitioned region and a second partitioned region to which geometric partitioning for intra-prediction is applied.

Here, the intra-prediction modes may include a planar mode, a DC mode, and directional intra-prediction modes. For example, intra-prediction that uses one of the planar mode, the DC mode, and the directional intra-prediction mode may be performed on the first partitioned region. For example, intra-prediction that uses another of the planar mode, the DC mode, and the directional intra-prediction mode may be performed on the second partitioned region.

When the first reference region for the first partitioned region and the second reference region for the second partitioned region are different from each other, the first intra-prediction mode applied to the first partitioned region and the second intra-prediction mode applied to the second partitioned region may be identical to each other. Alternatively, when the first reference region for the first partitioned region and the second reference region for the second partitioned region are different from each other, the first intra-prediction mode applied to the first partitioned region and the second intra-prediction mode applied to the second partitioned region may be different from each other.

The first intra-prediction mode applied to the first partitioned region may be selected from among all available intra-prediction modes. The second intra-prediction mode applied to the second partitioned region may be selected from among all available intra-prediction modes.

The first intra-prediction mode applied to the first partitioned region may be selected from among MPMs present in a first MPM list for the first partitioned region.

The second intra-prediction mode applied to the second partitioned region may be selected from among MPMs present in a second MPM list for the second partitioned region.

The first intra-prediction mode for the first partitioned region and/or the second intra-prediction mode for the second partitioned region may be determined based on a partitioning mode. For example, when the value of the partitioning mode is a specific value, a specific intra-prediction mode may be used for the first partitioned region and/or the second partitioned region.

An intra-prediction mode set including one or more intra-prediction modes may be determined based on the partitioning mode. The first intra-prediction mode for the first partitioned region and/or the second intra-prediction mode for the second partitioned region may be selected from among one or more intra-prediction modes present in the determined intra-prediction mode set.

For example, the intra-prediction mode set may include 1) an intra-prediction mode having a direction vertical to that of the angle indicated by the partitioning mode, 2) a planar mode, and 3) a DC mode. The intra-prediction mode set may further include other intra-prediction modes.

The angle indicated by the partitioning mode may denote the angle of a partitioning line which partitions the target block depending on the partitioning mode.

Alternatively, the angle indicated by the partitioning mode may refer to 0.

For example, the intra-prediction mode set may include 1) an intra-prediction mode having a direction horizontal to that of the angle indicated by the partitioning mode, 2) a planar mode, and 3) a DC mode. The intra-prediction mode set may further include other intra-prediction modes.

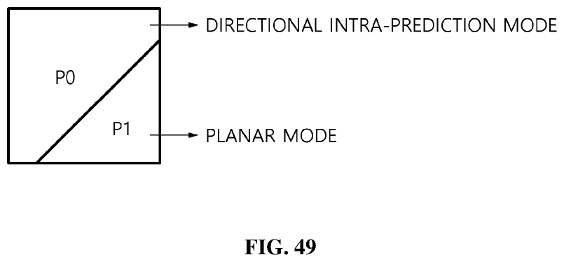

FIG. 49 illustrates a target block to which GPM using fixed intra-prediction modes is applied according to an example.

An intra-prediction mode for at least one of a first partitioned region and a second partitioned region may be fixed at a specific intra-prediction mode.

For example, the specific intra-prediction mode may be a planar mode or a DC mode.

For example, a directional intra-prediction mode may be used for the first partitioned region. The planar mode may be fixedly used for the second partitioned region.

For example, prediction using a directional intra-prediction mode may be performed on a partitioned region including the uppermost-leftmost pixel of the target block.

Prediction using a fixed intra-prediction mode (e.g., a planar mode or a DC mode) may be performed on the other partitioned region which does not include the uppermost-leftmost pixel of the target block.

For example, one intra-prediction mode may be selected from among all intra-prediction modes for the partitioned region including the uppermost-leftmost pixel of the target block.

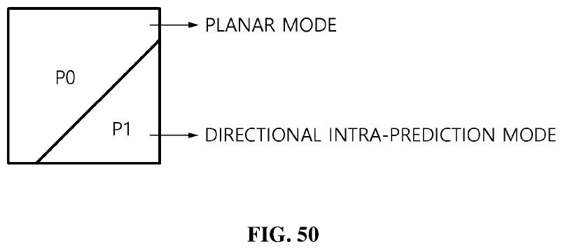

FIG. 50 illustrates a target block to which GPM using fixed intra-prediction modes is applied according to an example.

An intra-prediction mode for at least one of a first partitioned region and a second partitioned region may be fixed at a specific intra-prediction mode.

For example, the specific intra-prediction mode may be a planar mode or a DC mode.

For example, the planar mode may be fixedly used for the second partitioned region. A directional intra-prediction mode may be used for the second partitioned region.

For example, prediction using a fixed intra-prediction mode (e.g., a planar mode or a DC mode) may be performed on a partitioned region including the uppermost-leftmost pixel of the target block. Prediction using a directional intra-prediction mode may be performed on the other partitioned region which does not include the uppermost-leftmost pixel of the target block.

For example, one intra-prediction mode may be selected from among all intra-prediction modes for the other partitioned region which does not include the uppermost-leftmost pixel of the target block.

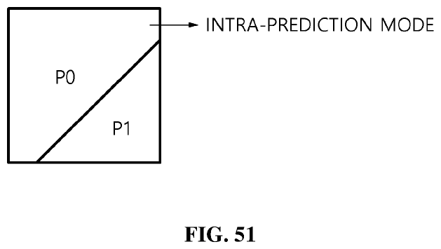

FIG. 51 illustrates a target block to which GPM using an intra-prediction mode and a non-intra-prediction mode is applied according to an example.

Intra-prediction using an existing intra-prediction mode may be applied to one of a first partitioned region and a second partitioned region. Here, the existing intra-prediction mode may be fixed at one intra-prediction mode such as a planar mode or a DC mode.

Non-intra-prediction may be applied to the other of the first partitioned region and the second partitioned region.

For example, non-intra-prediction may be prediction for determining a second prediction block for the second partitioned region using a difference value between the original signals. The original signals may refer to pixels in an original image.

The difference value between the original signals may be a value generated by Differential Pulse Code Modulation (DPCM).

A second partitioned region average value or a second partitioned region median value may be derived from the second partitioned region.

The second partitioned region average value may be the average value of samples in a region of the original image corresponding to the second partitioned region.

The second partitioned region median value may be the median value of samples in a region of the original image corresponding to the second partitioned region.

GPM information may include the second partitioned region average value or the second partitioned region median value. The second partitioned region average value or the second partitioned region median value may be signaled from the encoding apparatus 1600 to the decoding apparatus 1700 through a bitstream.

A first partitioned region average value or a first partitioned region median value may be derived from the first partitioned region.

The first partitioned region average value may be the average value of samples in a region of the original image corresponding to the first partitioned region.

The first partitioned region median value may be the median value of samples in a region of the original image corresponding to the first partitioned region.

The GPM information may include a partitioned region difference value.

The partitioned region difference value may be the difference between the second partitioned region average value and the first partitioned region average value.

The partitioned region difference value may be the difference between the second partitioned region median value and the first partitioned region median value.

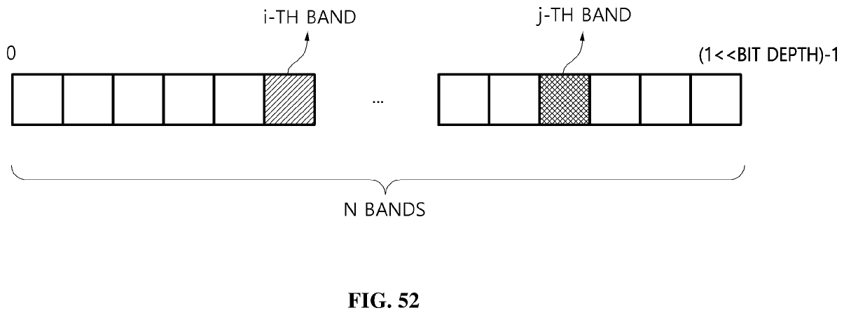

FIG. 52 illustrates N bands according to an example.

A representative value for a prediction signal for the second partitioned region to which non-intra-prediction is applied may be determined. The prediction signal may refer to a prediction value generated by prediction for the second partitioned region.

The range of values which the pixels in the target block can have may include N bands.

GPM information may include index difference information.

The index difference information may refer to the difference between a first band index and a second band index. In other words, the index difference information may refer to the difference between bands.

The first band index may refer to a band including the representative value of the first partitioned region among N bands.

The second band index may refer to a band including the representative value of the second partitioned region among N bands.

The index difference information may be signaled from the encoding apparatus 1600 to the decoding apparatus 1700 through a bitstream.

The representative value for the prediction signal of the second partitioned region may be determined using the representative value of the first partitioned region and the index difference information.

The sign of the difference between the first band index and the second band index may be determined based on the difference between the average value (or the median value) of samples in the first reference region for the first partitioned region and the average value (or the median value) of samples in the second reference region for the second partitioned region.

After signaling on the index difference information is performed, an accurate representative value for the prediction signal for the second partitioned region may be determined.

In order to determine the accurate representative value for the prediction signal for the second partitioned region, the median value of a band determined using the index difference information may be used for prediction for the second partitioned region.

In order to determine the accurate representative value for the prediction signal for the second partitioned region, a band offset from the minimum value of a band determined using the index difference information may be additionally used.

For example, the representative value for the prediction signal for the second partitioned region may be the sum of the minimum value of the band, determined using the index difference information, and the band offset.

The GPM information may include the band offset.

The band offset may be signaled from the encoding apparatus 1600 to the decoding apparatus 1700 through a bitstream.

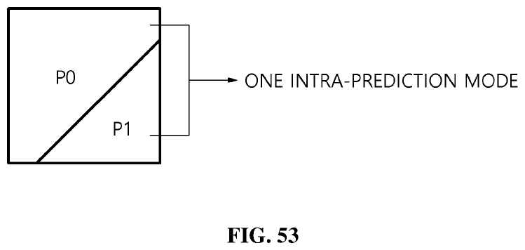

FIG. 53 illustrates a target block to which GPM using one intra-prediction mode is applied according to an example.

When GPM using one intra-picture prediction mode is applied to the target block, GPM information may include a difference value α. Here, a may be an integer.

The difference value a may be signaled from the encoding apparatus 1600 to the decoding apparatus 1700 through a bitstream.

Here, the one intra-picture prediction mode may be fixed at a planar mode or a DC mode. The one intra-picture prediction mode may be applied both to a first partitioned region and to a second partitioned region.

The target block may be partitioned into the first partitioned region and the second partitioned region depending on boundary information.

α may be the difference value between the average value of the pixel values of pixels in the first partitioned region and the average value of the pixel values of pixels in the second partitioned region.

α may be the difference value between the median value of the pixel values of the pixels in the first partitioned region and the median value of the pixel values of the pixels in the second partitioned region.

α may be the difference value between the pixel value of a pixel at a specific location in the first partitioned region and the pixel value of a pixel at the specific location in the second partitioned region.

α may be the difference between the index of a band for the first partitioned region and the index of a band for the second partitioned region.

Predictions using the same intra-prediction mode may be performed for the first partitioned region and the second partitioned region.

The pixel values of the pixels in the first partitioned region may be determined by prediction using the intra-prediction mode.

The prediction value of a pixel in the first partitioned region may be determined by prediction using the intra-prediction mode for the first partitioned region.

The prediction value of a pixel in the second partitioned region may be determined by prediction using the intra-prediction mode for the second partitioned region.

An offset may be added to the pixel in the second partitioned region generated by prediction. In other words, the pixel value of the pixel in the second partitioned region may be the sum of the pixel value of the pixel generated by prediction and the offset.

The offset may be derived from the pixel value of the pixel in the first partitioned region, the pixel value of the pixel in the second partitioned region, and the difference value α. Here, the location of the pixel in the first partitioned region and the location of the pixel in the second partitioned region may be identical to each other.

α may be the average value of the pixel values of pixels in the second partitioned region.

α may be the median value of the pixel values of pixels in the second partitioned region.

α may be the pixel value of a pixel at a specific location in the second partitioned region.

In an embodiment, the pixel values of all pixels in the second partitioned region may be set equal to a.

In an embodiment, predictions using the same intra-prediction mode may be performed for the first partitioned region and the second partitioned region. An offset may be added to the pixel in the second partitioned region generated by prediction. In other words, the pixel value of the pixel in the second partitioned region may be the sum of the pixel value of the pixel generated by prediction and the offset.

The offset may be derived from the pixel value of the pixel in the first partitioned region, the pixel value of the pixel in the second partitioned region, and the difference value α. Here, the location of the pixel in the first partitioned region and the location of the pixel in the second partitioned region may be identical to each other.

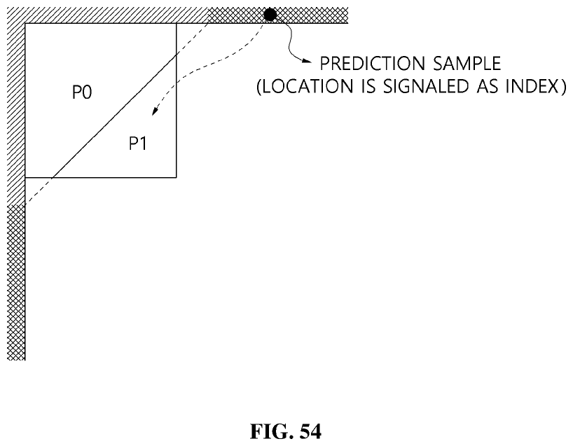

FIG. 54 illustrates a target block to which GPM using an index for a reference sample is applied according to an example.

Prediction using intra-prediction may be performed for a first partitioned region.

A prediction sample index indicating a prediction sample may be used for a second partitioned region.

The prediction sample may be a reference sample that is referenced for prediction for the second partitioned region among second reference samples in a second reference region.

The prediction sample may be a second reference sample having the most similar value to the sample values of the reference samples of an original image corresponding to the second reference region.

GPM information may include a prediction sample index.

A reference sample used for prediction for the second partitioned region may be indicated by the prediction sample index.

The slice, tile, or brick described in embodiments may be replaced with a slice, tile or brick.

A Coding Tree Unit (CTU), a Coding Unit (CU), a coding block, a Prediction Block (PU), a prediction block, a Transform Unit (TU) or a transform block, described in the embodiments, may be replaced with a CTU, a CU, a coding block, a PU, a prediction block, a TU or a transform block.

The embodiments may be performed using the same method by the encoding apparatus 1600 and by the decoding apparatus 1700. Also, the image may be encoded/decoded using at least one of the embodiments or at least one combination thereof.

The order of application of the embodiments may be different from each other by the encoding apparatus 1600 and the decoding apparatus 1700, and the order of application of the embodiments may be (at least partially) identical to each other by the encoding apparatus 1600 and the decoding apparatus 1700.

The embodiments may be performed for each of a luma signal and a chroma signal, and may be equally performed for the luma signal and the chroma signal.

The form of a block to which the embodiments are applied may have a square or non-square shape.

Whether at least one of the above-described embodiments is to be applied and/or performed may be determined based on a condition related to the size of a block. In other words, at least one of the above-described embodiments may be applied and/or performed when the condition related to the size of a block is satisfied. The condition includes a minimum block size and a maximum block size. The block may be one of blocks described above in connection with the embodiments and the units described above in connection with the embodiments. The block to which the minimum block size is applied and the block to which the maximum block size is applied may be different from each other.

For example, when the block size is equal to or greater than the minimum block size and/or less than or equal to the maximum block size, the above-described embodiments may be applied and/or performed. When the block size is greater than the minimum block size and/or less than or equal to the maximum block size, the above-described embodiments may be applied and/or performed.

For example, the above-described embodiments may be applied only to the case where the block size is a predefined block size. The predefined block size may be 2×2, 4×4, 8×8, 16×16, 32×32, 64×64, or 128×128. The predefined block size may be (2*SIZE_{X})×(2*SIZE_{Y}). SIZE_{X} may be one of integers of 1 or more. SIZE_{Y} may be one of integers of 1 or more.

For example, the above-described embodiments may be applied only to the case where the block size is equal to or greater than the minimum block size. The above-described embodiments may be applied only to the case where the block size is greater than the minimum block size. The minimum block size may be 2×2, 4×4, 8×8, 16×16, 32×32, 64×64, or 128×128. Alternatively, the minimum block size may be (2*SIZE_{MIN_X})×(2*SIZE_{MIN_Y}). SIZE_{MIN_X} may be one of integers of 1 or more. SIZE_{MIN_Y} may be one of integers of 1 or more.

For example, the above-described embodiments may be applied only to the case where the block size is less than or equal to the maximum block size. The above-described embodiments may be applied only to the case where the block size is less than the maximum block size. The maximum block size may be 2×2, 4×4, 8×8, 16×16, 32×32, 64×64, or 128×128. Alternatively, the maximum block size may be (2*SIZE_{MAX_X})×(2*SIZE_{MAX_Y}). SIZE_{MAX_X} may be one of integers of 1 or more. SIZE_{MAX_Y} may be one of integers of 1 or more.

For example, the above-described embodiments may be applied only to the case where the block size is equal to or greater than the minimum block size and is less than or equal to the maximum block size. The above-described embodiments may be applied only to the case where the block size is greater than the minimum block size and is less than or equal to the maximum block size. The above-described embodiments may be applied only to the case where the block size is equal to or greater than the minimum block size and is less than the maximum block size. The above-described embodiments may be applied only to the case where the block size is greater than the minimum block size and is less than the maximum block size.

In the above-described embodiments, the block size may be a horizontal size (width) or a vertical size (height) of a block. The block size may indicate both the horizontal size and the vertical size of the block. The block size may indicate the area of the block. Each of the area, minimum block size, and maximum block size may be one of integers equal to or greater than 1. In addition, the block size may be the result (or value) of a well-known equation using the horizontal size and the vertical size of the block, or the result (or value) of an equation in embodiments.

Further, in the embodiments, a first embodiment may be applied to a first size, and a second embodiment may be applied to a second size. That is, the embodiments may be compositely applied according to the size.

The embodiments may be applied depending on a temporal layer. In order to identify a temporal layer to which the embodiments are applicable, a separate identifier may be signaled, and the embodiments may be applied to the temporal layer specified by the corresponding identifier. Here, the identifier may be defined as the lowest (bottom) layer and/or the highest (top) layer to which the embodiments are applicable, and may be defined as being indicating a specific layer to which the embodiments are applied. Further, a fixed temporal layer to which the embodiments are applied may also be defined.

For example, the embodiments may be applied only to the case where the temporal layer of a target image is the lowermost layer. For example, the embodiments may be applied only to the case where the temporal layer identifier of a target image is equal to or greater than 1. For example, the embodiments may be applied only to the case where the temporal layer of a target image is the highest layer.

A slice type or a tile group type to which the embodiments to which the embodiments are applied may be defined, and the embodiments may be applied depending on the corresponding slice type or tile group type.

In the above-described embodiments, it may be construed that, during the application of specific processing to a specific target, assuming that specified conditions may be required and the specific processing is performed under a specific determination, a specific coding parameter may be replaced with an additional coding parameter when a description has been made such that whether the specified conditions are satisfied is determined based on the specific coding parameter, or such that the specific determination is made based on the specific coding parameter. In other words, it may be considered that a coding parameter that influences the specific condition or the specific determination is merely exemplary, and it may be understood that, in addition to the specific coding parameter, a combination of one or more additional coding parameters functions as the specific coding parameter.

In the above-described embodiments, although the methods have been described based on flowcharts as a series of steps or units, the present disclosure is not limited to the sequence of the steps and some steps may be performed in a sequence different from that of the described steps or simultaneously with other steps. Further, those skilled in the art will understand that the steps shown in the flowchart are not exclusive and may further include other steps, or that one or more steps in the flowchart may be deleted without departing from the scope of the disclosure.

The above-described embodiments include examples in various aspects. Although all possible combinations for indicating various aspects cannot be described, those skilled in the art will appreciate that other combinations are possible in addition to explicitly described combinations. Therefore, it should be understood that the present disclosure includes other replacements, changes, and modifications belonging to the scope of the accompanying claims.

The above-described embodiments according to the present disclosure may be implemented as a program that can be executed by various computer means and may be recorded on a computer-readable storage medium. The computer-readable storage medium may include program instructions, data files, and data structures, either solely or in combination. Program instructions recorded on the storage medium may have been specially designed and configured for the present disclosure, or may be known to or available to those who have ordinary knowledge in the field of computer software.

A computer-readable storage medium may include information used in the embodiments of the present disclosure. For example, the computer-readable storage medium may include a bitstream, and the bitstream may contain the information described above in the embodiments of the present disclosure.

A bitstream may include computer-executable code and/or program. The computer-executable code and/or program may include pieces of information described in the embodiments, and may include syntax elements described in the embodiments. In other words, the pieces of information and syntax elements described in the embodiments may be regarded as a computer-executable code in the bitstream, and may be regarded as at least a part of the computer-executable code and/or program represented by the bitstream. The computer-readable storage medium may include a non-transitory computer-readable medium.

Examples of the computer-readable storage medium include all types of hardware devices specially configured to record and execute program instructions, such as magnetic media, such as a hard disk, a floppy disk, and magnetic tape, optical media, such as compact disk (CD)-ROM and a digital versatile disk (DVD), magneto-optical media, such as a floptical disk, ROM, RAM, and flash memory. Examples of the program instructions include machine code, such as code created by a compiler, and high-level language code executable by a computer using an interpreter. The hardware devices may be configured to operate as one or more software modules in order to perform the operation of the present disclosure, and vice versa.

As described above, although the present disclosure has been described based on specific details such as detailed components and a limited number of embodiments and drawings, those are merely provided for easy understanding of the entire disclosure, the present disclosure is not limited to those embodiments, and those skilled in the art will practice various changes and modifications from the above description.

Accordingly, it should be noted that the spirit of the present embodiments is not limited to the above-described embodiments, and the accompanying claims and equivalents and modifications thereof fall within the scope of the present disclosure.

1-20. (canceled)

21. An image decoding method, comprising:
configuring Geometric Partitioning Mode (GPM) information for a target block; and
performing GPM prediction for the target block using the GPM information.

22. The image decoding method of claim 21, wherein:
a first block and a second block for the target block are determined, and
at least one of the first block and the second block is generated by intra prediction.

23. The image decoding method of claim 22, wherein:
an intra prediction mode of the intra prediction is selected from a plurality of intra prediction modes in an intra prediction mode list.

24. The image decoding method of claim 21, wherein:
a first block and a second block for the target block are determined, and
the first block is generated using a motion vector difference.

25. The image decoding method of claim 21, wherein:
a first block and a second block for the target block are determined, and
the first block is generated by an Intra Block Copy (IBC).

26. The image decoding method of claim 21, wherein:
a first block and a second block for the target block are determined, and
a refinement using a template matching is applied to the first block.

27. The image decoding method of claim 21, wherein:
a partitioning mode list of the GPM comprises a plurality of partitioning modes selected by an error cost.

28. An image encoding method, comprising:
configuring Geometric Partitioning Mode (GPM) information for a target block; and
performing GPM prediction for the target block using the GPM information.

29. The image encoding method of claim 28, wherein:
a first block and a second block for the target block are determined, and
at least one of the first block and the second block is generated by intra prediction.

30. The image encoding method of claim 29, wherein:
an intra prediction mode of the intra prediction is selected from a plurality of intra prediction modes in an intra prediction mode list.

31. The image encoding method of claim 28, wherein:
a first block and a second block for the target block are determined, and
a motion vector difference for the first block is generated.

32. The image encoding method of claim 28, wherein:
a first block and a second block for the target block are determined, and
the first block is generated by an Intra Block Copy (IBC).

33. The image encoding method of claim 28, wherein:
a first block and a second block for the target block are determined, and
a refinement using a template matching is applied to the first block.

34. The image encoding method of claim 28, wherein:
a partitioning mode list of the GPM comprises a plurality of partitioning modes selected by an error cost.

35. A computer-readable storage medium for storing a bitstream for image decoding generated by the image encoding method of claim 28.

36. A computer-readable storage medium for storing a bitstream for image decoding, wherein:
the bitstream includes Geometric Partitioning Mode (GPM) information, and
GPM prediction for the target block is performed using the GPM information.

37. The computer-readable storage medium of claim 36, wherein:
a first block and a second block for the target block are determined, and
at least one of the first block and the second block is generated by intra prediction.

38. The computer-readable storage medium of claim 37, wherein:
an intra prediction mode of the intra prediciton is selected from a plurality of intra prediction modes in an intra prediction mode list.

39. The computer-readable storage medium of claim 36, wherein:
a first block and a second block for the target block are determined, and
the first block is generated using a motion vector difference.

40. The computer-readable storage medium of claim 36, wherein:
a first block and a second block for the target block are determined, and
the first block is generated by an Intra Block Copy (IBC).
